(19) United States
(12) Patent Application Publication
(10) Pub. No.: US 2013/0152571 A1
(43) Pub. Date: Jun. 20, 2013

(54) VALVE ACTIVATION IN COMPRESSED-GAS ENERGY STORAGE AND RECOVERY SYSTEMS

(71) Applicants: Jeffery Modderno, Andover, MA (US); Samar Shah, Malden, MA (US); Randall Strauss, Colorado Springs, CO (US); Joel Berg, Bolton, MA (US); Troy O. McBride, Norwich, VT (US); Benjamin R. Bollinger, Topsfield, MA (US); David Perkins, Kensington, NH (US); Arne LaVen, Hampton, NH (US)

(72) Inventors: Jeffery Modderno, Andover, MA (US); Samar Shah, Malden, MA (US); Randall Strauss, Colorado Springs, CO (US); Joel Berg, Bolton, MA (US); Troy O. McBride, Norwich, VT (US); Benjamin R. Bollinger, Topsfield, MA (US); David Perkins, Kensington, NH (US); Arne LaVen, Hampton, NH (US)

(21) Appl. No.: 13/715,093

(22) Filed: Dec. 14, 2012

Related U.S. Application Data
(60) Provisional application No. 61/576,654, filed on Dec. 16, 2011.
(60) Provisional application No. 61/614,045, filed on Mar. 22, 2012.
(60) Provisional application No. 61/620,018, filed on Apr. 4, 2012.

(51) Int. Cl. F15B 1/02

(52) U.S. Cl. CPC F15B 1/02
USPC 60/413

(57) ABSTRACT

In various embodiments, valve efficiency and reliability are enhanced via use of hydraulic or magnetic valve actuation, valves configured for increased actuation speed, and/or valves controlled to reduce collision forces during actuation.

### RELATED APPLICATIONS

This application claims the benefit of and priority to U.S. Provisional Patent Application No. 61/576,654, filed Dec. 16, 2011, U.S. Provisional Patent Application No. 61/614,045, filed Mar. 22, 2012, and U.S. Provisional Patent Application No. 61/620,018, filed Apr. 4, 2012. The entire disclosure of each of these applications is hereby incorporated herein by reference.

### STATEMENT REGARDING FEDERALLY SPONSORED RESEARCH

This invention was made with government support under DE-OE0000231 awarded by the DOE. The government has certain rights in the invention.

### FIELD OF THE INVENTION

In various embodiments, the present invention relates to pneumatics, hydraulics, power generation, and energy storage, and more particularly, to systems and methods using pneumatic, pneumatic/hydraulic, and/or hydraulic cylinders for energy storage and recovery.

### BACKGROUND

Storing energy in the form of compressed gas has a long history and components tend to be well tested and reliable, and have long lifetimes. The general principle of compressed-gas or compressed-air energy storage (CAES) is that generated energy (e.g., electric energy) is used to compress gas (e.g., air), thus converting the original energy to pressure potential energy; this potential energy is later recovered in a useful form (e.g., converted back to electricity) via gas expansion coupled to an appropriate mechanism. Advantages of compressed-gas energy storage include low specific-energy costs, long lifetime, low maintenance, reasonable energy density, and good reliability.

If a body of gas is at the same temperature as its environment, and expansion occurs slowly relative to the rate of heat exchange between the gas and its environment, then the gas will remain at approximately constant temperature as it expands. This process is termed “isothermal” expansion. Isothermal expansion of a quantity of high-pressure gas stored at a given temperature recovers approximately three times more work than would “adiabatic expansion,” that is, expansion where no heat is exchanged between the gas and its environment—e.g., because the expansion happens rapidly or in an insulated chamber. Gas may also be compressed isothermally or adiabatically.

An ideally isothermal energy-storage cycle of compression, storage, and expansion would have 100% thermodynamic efficiency. An ideally adiabatic energy-storage cycle would also have 100% thermodynamic efficiency, but there are many practical disadvantages to the adiabatic approach. These include the production of higher temperature and pressure extremes within the system, heat loss during the storage period, and inability to exploit environmental (e.g., cogenerative) heat sources and sinks during expansion and compression, respectively. In an isothermal system, the cost of adding a heat-exchange system is traded against resolving the difficulties of the adiabatic approach. In either case, mechanical energy from expanding gas is typically converted to electrical energy before use.

An efficient and novel design for storing energy in the form of compressed gas utilizing near isothermal gas compression and expansion has been shown and described in U.S. Pat. No. 7,832,207, filed Apr. 9, 2009 (the '207 patent) and U.S. Pat. No. 7,874,155, filed Feb. 25, 2010 (the '155 patent), the disclosures of which are hereby incorporated herein by reference in their entireties. The '207 and '155 patents disclose systems and techniques for expanding gas isothermally in staged cylinders and intensifiers over a large pressure range in order to generate electrical energy when required. Mechanical energy from the expanding gas may be used to drive a hydraulic pump/motor subsystem that produces electricity. Systems and techniques for hydraulic-pneumatic pressure intensification that may be employed in systems and methods such as those disclosed in the '207 and '155 patents are shown and described in U.S. Pat. No. 8,037,678, filed Sep. 10, 2010 (the '678 patent), the disclosure of which is hereby incorporated herein by reference in its entirety.

In the systems disclosed in the '207 and '155 patents, reciprocal mechanical motion is produced during recovery of energy from storage by expansion of gas in the cylinders. This reciprocal motion may be converted to electricity by a variety of techniques, for example as disclosed in the '678 patent as well as in U.S. Pat. No. 8,117,842, filed Feb. 14, 2011 (the '842 patent), the disclosure of which is hereby incorporated herein by reference in its entirety. The ability of such systems to either store energy (i.e., use energy to compress gas into a storage reservoir) or produce energy (i.e., expand gas from a storage reservoir to release energy) will be apparent to any person reasonably familiar with the principles of electrical and pneumatic machines.

In order to reduce overall pressure ranges of operation, various CAES systems may utilize designs involving multiple interconnected cylinders. In such designs, trapped regions of “dead volume” may occur such that pockets of gas remain in cylinders before and after valve transitions. Such volumes may occur within the cylinders themselves and/or within conduits, valves, or other components within and interconnecting the cylinders. Bringing relatively high-pressure gas into communication (e.g., by the opening of a valve) with relatively low-pressure gas within a dead volume tends to lead to a diminishment of pressure of the higher-pressure gas without the performance of useful work, thereby disadvantageously reducing the amount of work recoverable from or stored within the higher-pressure gas. Air dead volume tends to reduce the amount of work available from a quantity of high-pressure gas brought into communication with the dead volume. This loss of potential energy may be termed a “coupling loss.” For example, during a compression stage a volume of gas that was compressed to a relatively high pressure may remain inside the compression cylinder, or conduits attached thereto, after the movable member of the cylinder (e.g., piston, hydraulic fluid, or bladder) reaches the end of its stroke. The volume of compressed air that is not pushed onto the next stage at the end of stroke constitutes “dead volume” (also termed, in compressors, “clearance volume”). If the volume of high-pressure gas within the cylinder is then brought into fluid communication (e.g., by the opening of a valve) with a section of intake piping, a portion of the high-pressure gas will tend to enter the piping and mix with the contents thereof, equalizing the pressure within the two volumes. This equalization of pressure entails a loss of exergy (i.e., energy available as work). In a preferred scenario, the gas in the dead volume is allowed to expand in a manner that performs useful work (e.g., by pushing on a piston), equalizing in pressure with the gas in the piping prior to valve opening. In another scenario, the gas in the dead volume is allowed to expand below the pressure of the gas within the intake piping, and pressure equalization takes place during valve transition (opening).

In another example of formation of dead space in a CAES system during an expansion procedure, if gas is to be introduced into a cylinder through a valve for the purpose of performing work by pushing against a piston within the cylinder, and a chamber or volume exists adjacent to the piston that is filled with low-pressure gas at the time the valve is opened, the high-pressure gas entering the chamber is immediately reduced in pressure during free expansion and mixing with the low-pressure gas and, therefore, performs less mechanical work upon the piston than would have been possible without the pressure reduction. The low-pressure volume in such an example constitutes air dead volume. Dead volume may also appear within the portion of a valve mechanism that communicates with the cylinder interior, or within a tube or line connecting a valve to the cylinder interior, or within other components that contain gas in various states of operation of the system. It will be clear to persons familiar with hydraulics and pneumatics that dead volume may also appear during compression procedures, and that energy losses due to pneumatically communicating dead volumes tend to be additive.

Moreover, in an expander-compressor system operated to expand or compress gas near-isothermally (i.e., at approximately constant temperature) within a cylinder, gas that escapes the cylinder to become dead volume (e.g., by displacing an incompressible fluid) in a hydraulic subsystem may, as pressures change within the system, expand and compress adiabatically (i.e., at non-constant temperature), with associated energy losses due to heat transfer between the gas and materials surrounding the dead volume. These thermal energy losses will tend to be additive with losses that are due to non-work-performing expansion of gas to lower pressures in dead volumes.

Therefore, in various compressor-expander systems, including isothermal compressor-expander systems, preventing the formation of dead volume will generally enable higher system efficiency. Attempts to minimize dead volume frequently involve reducing the sizes and lengths of conduits interconnecting cylinders and other components. However, such efforts may not eliminate all dead volume and tend to constrain the overall geometry and placement of individual system components. Therefore, there is a need for alternative or additional approaches to reducing dead volume and/or the deleterious effects of dead volume in pneumatic components in order to reduce coupling losses and improve efficiency during compression and/or expansion of gas.

Furthermore, the efficiency of compressed-gas energy-conversion systems may be limited by the valving systems that control flow of the gas (and/or other fluid) into and out of the cylinder and/or into, out of, or through other components. For example, conventional designs may entail valve arrangements that do not prevent contamination between actuation fluid and working fluid, that do not prevent damage from hydrolocking, that require excessive actuation energy, that require an excessive time to actuate (i.e., open and close), that have excessive pressure drops, that do not fail shut (e.g., that prevent the unwanted venting of high-pressure gas when power to valve actuation mechanisms fails), that contain dead space in piping, and that have other disadvantages. Designs that mitigate or eliminate such features will be tend to be advantageous. It will also be advantageous, in general, for valves to open and close rapidly, in order that as little fluid as possible may be passed through valves that are in partially open or closed states, as such passage entails throttling losses that decrease overall system efficiency.

Furthermore, the use of cam- or piston-actuated valves to control flow of the gas (and/or other fluid) into and out of the cylinder may also entail disadvantages that can be surmounted or mitigated by novel design. Conventional or prior-art reciprocating piston-type expanders typically use cam- or piston-actuated valves to control admission of fluid from a high-pressure source into the cylinder when the piston is near top dead center (i.e., the piston's closest point of approach to the end of the cylinder designated the “top”) and discharge of fluid from the cylinder when the piston is near bottom dead center (i.e., the piston's closest point of approach to the end of the cylinder opposite the top end and designated the “bottom”). Conventional reciprocating piston-type compressors typically use passive check-style valves to control admission of fluid into the cylinder during the intake (or suction) stroke and expulsion of fluid from the cylinder during the discharge stroke. These conventional valving techniques for reciprocating piston-type expanders and compressors may not be optimal for use in compressed-air energy storage systems; for example, cam- or piston-actuated valves, with their fixed timing, may not be optimal for variable-speed, constant-power expansion of gas from a source (e.g., gas-storage reservoir) the pressure of which is declining. Typically, more desirable are intake and outlet valves that may operate passively in compression mode, i.e., based solely on cylinder pressure, and that may also be actively or semi-actively controlled during expansion mode (e.g., the timing of the valve's operation may be set by an operator or control system). It may also be desirable that the intake and outlet valves check closed in certain operating conditions and check open in other operating conditions. For example, the intake valve in its passive or unpowered state should prevent high-pressure air from flowing from the high-pressure store into the cylinder when the pressure within the cylinder is lower than the pressure within the high-pressure store, but should allow air from the cylinder to flow into the high-pressure store when the pressure within the cylinder is higher than the pressure within the high-pressure store. Similarly, the outlet valve in its passive or unpowered state should prevent high-pressure air from venting from the cylinder to an environmental vent or other secondary volume when the pressure within the cylinder is higher than the pressure in the secondary volume, but should allow air from the secondary volume to flow into the cylinder when the pressure within the cylinder is lower than the pressure within the secondary volume. Therefore, opportunities exist to improve the overall efficiency of energy storage-and-recovery systems via further enhancements to valve design and valve-actuation efficiency.

### SUMMARY

Embodiments of the invention reduce the impact of dead volume in pneumatic cylinders and/or pneumatic chambers of pneumatic/hydraulic cylinders during compression and/or expansion in CAES systems; increase the efficiency with which fluid (i.e., gas, liquid, or a mixture of gas and liquid) may be admitted to or exhausted from a pneumatic or pneumatic-hydraulic cylinder that is part of an energy-conversion system; and improve the performance of an energy-conversion system by employing one or more valves that may be integrated into the head of a cylinder and that typically (i) use differential pressure to open, (ii) use electromagnetic force to hold open, and (iii) check closed.

In various embodiments, the impact of dead volume is reduced by time-coordinated matching of gas pressures within system components that would, absent such matching, suffer coupling losses and potential equipment damage. Herein, a space within any component of a CAES system is termed a “dead volume” or “dead space” if its volume cannot, in some or all states of operation, be reduced to zero due to mechanical constraints (e.g., imperfect fit of a piston to the interior face of a cylinder head when the piston is at top dead center, forming an ineradicable, residual chamber volume) and if in some states of system operation the space contains gas at a pressure that can be brought into fluid communication with gas at a significantly different pressure (e.g., through a valve transition).

In cylinders, the time-coordinated matching of pressures may be accomplished using actuated valves that are selectively closed and opened in a manner that yields approximately matched pressures within system components about to be brought into fluid communication with each other. To reduce loss of exergy due to non-work-performing expansion of gas when components containing gas at relatively high pressure (e.g., 3,000 psi) are brought into fluid communication with components containing gas at relatively low pressure (e.g., 300 psi or atmospheric pressure), the gas in one or more potential dead spaces is pre-compressed to a pressure approximately equal to that of the higher-pressure gas before the higher- and lower-pressure gas volumes are brought into fluid communication with each other. In other embodiments, the gas in one or more potential dead spaces is pre-expanded to a pressure approximately equal to that of the lower-pressure gas before the higher- and lower-pressure volumes are brought into fluid communication with each other. Such pre-compression and pre-expansion produce specific target pressures (e.g., 3,000 psi) at specific times or in specific states of system operation (e.g., when a cylinder piston reaches top-dead-center position and is poised to begin an expansion stroke). Both target pressure and timing of pressure matching may be altered adaptively during the course of system operation based on measurements of pressures within various parts of the CAES system and/or other aspects of system state. An actuated valve may be operated (i.e., opened or closed) at specific times in order to reduce the effect of dead space, e.g., a valve may be opened only when a pre-compression condition is met. The timing of actuated valve operation may, furthermore, be conditioned on feedback in order to provide increased system energy efficiency and/or other advantages. Herein, an “actuated” valve is a valve whose opening or closing occurs at a time that may be altered, either arbitrarily or within limits, by a system operator or control mechanism, as distinct from a passive “check”-type valve whose opening and closing are determined by differential pressures or a “cam-driven” valve whose times of opening or closing are dictated mechanically. Actuated valves may improve performance by opening at times different than would be entailed by operation of check valves by differential pressures. Variable-timing cam-driven valves may be considered actuated valves and are within the scope of this invention.

In certain embodiments of the invention, the CAES system may include or consist essentially of a cylinder assembly (or plurality of cylinder assemblies, e.g., multiple stages) that features a movable internal member (e.g., piston) or other boundary mechanism such as hydraulic fluid or a bladder. The internal boundary mechanism of the cylinder divides the interior of the cylinder into two chambers that may contain distinct bodies of fluid, and these may be at different pressures in various states of operation of the system. The system may further include a first control valve in communication with a high-pressure storage reservoir and the cylinder assembly, a second control valve in communication with the cylinder assembly and a vent to atmosphere, a heat-transfer subsystem in fluid communication with the cylinder assembly, an electric motor/generator in mechanical communication with a drive mechanism (e.g., crankshaft, hydraulic pump, linear generator mover) configured to drive the movable member disposed within the cylinder assembly, and a control system configured to operate the first and second control valves based on various information characterizing various aspects of the cylinder assembly and/or other components of the system (e.g., pressure, temperature, piston position, piston velocity).

One aspect of the invention relates to a method for reducing coupling losses and improving system performance during an expansion stage of a CAES system. In various embodiments, gas within a first chamber of a cylinder is pressurized to approximately some relatively high pressure (e.g., 3,000 psi) at or near the beginning of an expansion stroke of the cylinder. In this state of operation, the piston of the cylinder is at or near its top dead center position and the first chamber constitutes dead volume. A first control valve is then operated to place a volume of high-pressure gas (e.g., air at 3,000 psi) from an external source (e.g., a pressurized gas storage reservoir) in fluid communication with the first chamber. Because the gas within the first chamber is at approximately the same pressure as the high-pressure source placed in communication with the first chamber by the opening of the first control valve, gas from the high-pressure source does not tend to expand into the first chamber suddenly and without performing useful work. Coupling losses during the connection of the source to the cylinder are thus reduced or eliminated. In short, system performance may be improved by forestalling events of rapid pressure equalization of connecting spaces.

During a subsequent cylinder expansion stroke (also herein termed a “downward stroke”), useful work is recovered from high-pressure gas during both (1) admission of high-pressure gas to the first cylinder chamber while the boundary mechanism moves downward so as to allow the first cylinder chamber to enlarge, a phase of operation herein termed a “direct-drive phase” or “direct drive,” and (2) a subsequent expansion phase (i.e., after the first control valve is closed) during which the boundary mechanism continues to move downward and a fixed mass of high-pressure gas expands in the enlarging first chamber). As shown and described in the '207 and '155 patents and U.S. patent application Ser. No. 13/473,128, filed May 16, 2012 (the '128 application), the entire disclosure of which is incorporated by reference herein, gas expansion may be maintained as substantially isothermal by introducing a certain volume of liquid (e.g., a quantity of foam or spray) at an appropriate temperature into the cylinder prior to and/or during the expansion.

At or near the end of the expansion stroke, when the gas reaches a lower pressure (e.g., 300 psi), a second control valve is operated to begin to exhaust the gas (e.g., to a vent and/or to a mid-pressure vessel and second cylinder assembly) as an upward stroke of the movable member within the piston occurs. During the first portion of the second half of the cylinder stroke (e.g., the upward stroke), the gas is exhausted through the second control valve (e.g., into a mid-pressure vessel and second cylinder assembly) by translating the movable member (e.g., piston) or other boundary mechanism to reduce the volume of the first chamber in the cylinder assembly. During a second portion of the second half of the cylinder stroke (e.g., the upward stroke), prior to the movable member reaching the end of stroke (e.g., top of stroke) inside the cylinder, the second control valve is closed and a “pre-compression stroke” is performed to compress the remaining volume of air (dead volume) and/or liquid inside the cylinder.

The time of closure of the second control valve, relative to the sequence of states of operation just described, is not arbitrary. Premature closure of the second valve will typically tend to trap an excessive quantity of gas in the first chamber, resulting in overpressurization of the gas in the first chamber when the volume of the first chamber attains a minimum (i.e., at top dead center of stroke). When this occurs, opening of the first valve at the start of the next expansion cycle will result in energy loss through non-work-performing expansion of the gas within the first chamber into the high-pressure storage reservoir and other components (e.g., piping) in fluid communication therewith.

On the other hand, tardy closure of the second valve will tend to trap an inadequate quantity of gas in the first chamber, resulting in underpressurization of the gas in the first chamber when the volume of the first chamber attains a minimum (i.e., at top dead center of stroke). When this occurs, opening of the first valve at the start of the next expansion cycle will generally result in energy loss through non-work-performing expansion of gas from the high-pressure storage reservoir and other components (e.g., piping) in fluid communication therewith into the first chamber.

Therefore, in certain embodiments of the invention the optimal time of actuation of the second control valve is based at least in part on sensed conditions in one or more portions of the CAES system, e.g., pressure in the first chamber, pressure in the high-pressure storage reservoir, piston position, piston velocity, etc. The principles on which the time of actuation of the second control valve is determined will be made clear hereinbelow.

When liquid is introduced into the first chamber to enable approximately isothermal expansion, a quantity of liquid will generally accumulate in the first chamber (e.g., on top of the piston or other movable member) during an expansion stroke. In an ideal case, i.e., if all of the gas compressed in the first chamber is passed to the storage reservoir or to a higher-pressure cylinder stage by the time the volume of the first chamber is at a minimum, the remaining volume of the first chamber (i.e., the volume between the movable member and the interior face of the upper end-cap of the cylinder) will be occupied entirely by liquid; all gas will have been expelled and there will be no gas-filled dead volume in the first chamber at the commencement of a new expansion stroke. However, in practice, the first chamber volume at the commencement of a new expansion stroke will tend to contain both liquid and gas remaining from the previous expansion stroke. The gas fraction of this volume may constitute dead volume at the start of the new stroke. During the pre-compression stroke, therefore, as already described hereinabove, the effective coupling loss due to this dead volume is minimized by compressing the remaining air to a pressure substantially equal to the pressure of the air in the storage reservoir (or the pressure of the gas to be introduced into the cylinder for expansion, if such gas is not arriving directly from the storage reservoir). Thus, when additional high-pressure gas is admitted to the cylinder for expansion, no or minimal pressure difference exists between the two sides of the first control valve. This allows the first control valve to be operated with a lower actuation energy, further improving system efficiency.

Most or even substantially all of the work done upon the air in the first chamber during a pre-compression stroke is typically recovered as the air re-expands during the subsequent expansion stroke. Furthermore, if the pressure of the air in the dead volume is approximately equal to the pressure of the air in the storage vessel or the next higher-pressure stage, then there will be substantially no coupling loss when the first valve to the storage reservoir or next-higher-pressure stage is opened. The higher pressure within the dead volume entails less gas flow from the storage reservoir or next-higher-pressure stage to the cylinder when the valve is opened during an expansion stage, thereby reducing coupling loss and improving efficiency. Moreover, the longevity of some system components may be increased because transient mechanical stresses caused by high-pressure air rushing suddenly into dead volume are minimized or eliminated.

Employing measurements of pressures within various components (e.g., lines and chambers) allows the timing of actuated-valve closings and openings (i.e., valve transition events) to be optimized for specific system conditions. For example, CAES systems constructed according to similar designs may differ in pipe lengths and other details affecting potential dead space. In such a case, with actuated valves, valve transition events may be tuned to optimize efficiency of an individual system by minimizing dead-space coupling losses. For example, if an overpressure is detected in a pre-pressurized cylinder chamber, closure of the valve that permits gas to exit the chamber during a return stroke may be retarded to reduce the amount of pre-pressurized gas. A CAES system in which valve transition event tuning is performed by a computerized system controller may be considered, in this respect, a self-tuning system. For another example, as the pressure within a gas storage reservoir declines as the gas within the reservoir cools or is exhausted (or increases as the gas within the reservoir warms or is augmented), valve transition event timing may be tuned in a manner that adaptively, continuously maximizes the energy efficiency of the CAES system. Thus, a CAES system in accordance with various embodiments of the invention may adaptively self-tune its valve transition events so as to minimize dead-space coupling losses in response both to idiosyncrasies of system construction and to changing conditions of operation.

Furthermore, to minimize the impacts of dead space, the timing of valve actuations may be chosen in light of the non-ideal features of actual valves. Non-instantaneous valve transitions tend to entail tradeoffs between system capacity (amount of air compressed or expanded per stroke) and system efficiency (partly determined by energy losses due to dead space). The impact of non-ideal valve actuation on CAES system operation is considered for certain embodiments of the invention hereinbelow.

Every compression or expansion of a quantity of gas, where such a compression or expansion is herein termed “a gas process,” is generally one of three types: (1) adiabatic, during which the gas exchanges no heat with its environment and, consequently, rises or falls in temperature, (2) isothermal, during which the gas exchanges heat with its environment in such a way as to remain at constant temperature, and (3) polytropic, during which the gas exchanges heat with its environment but its temperature does not remain constant. Perfectly adiabatic gas processes are not practical because some heat is always exchanged between any body of gas and its environment (ideal insulators and reflectors do not exist); perfectly isothermal gas processes are not practical because for heat to flow between a quantity of gas and a portion of its environment (e.g., a body of liquid), a nonzero temperature difference must exist between the gas and its environment—e.g., the gas must be allowed to heat during compression in order that heat may be conducted to the liquid. Hence real-world gas processes are typically polytropic, though they may approximate adiabatic or isothermal processes.

The Ideal Gas Law states that for a given quantity of gas having mass m, pressure p, volume V, and temperature T, pV=mRT, where R is the gas constant (R=287 J/K·kg for air). For an isothermal process, T is a constant throughout the process, so pV=C, where C is some constant.

For a polytropic process, as will be clear to persons familiar with the science of thermodynamics, pVⁿ=C throughout the process, where n, termed the polytropic index, is some constant generally between 1.0 and 1.6. For n=1, pVⁿ=pV^{l}=pV=C, i.e., the process is isothermal. In general, a process for which n is close to 1 (e.g., 1.05) may be deemed approximately isothermal.

For an adiabatic process, pV^{γ}=C, where γ, termed the adiabatic coefficient, is equal to the ratio of the gas's heat capacity at constant pressure C_{P} to its heat capacity at constant volume, C_{V}, i.e., γ=C_{P}/C_{V}. In practice, γ is dependent on pressure. For air, the adiabatic coefficient γ is typically between 1.4 and 1.6.

Herein, we define a “substantially isothermal” gas process as one having n≦1.1. The gas processes conducted within cylinders described herein are preferably substantially isothermal with n≦1.05. Herein, wherever a gas process taking place within a cylinder assembly or storage reservoir is described as “isothermal,” this word is synonymous with the term “substantially isothermal.”

The amount of work done in compression or expansion of a given quantity of gas varies substantially with polytropic index n. For compressions, the lowest amount of work done is for an isothermal process and the highest for an adiabatic process, and vice versa for expansions. Hence, for gas processes such as typically occur in the compressed-gas energy storage systems described herein, the end temperatures attained by adiabatic, isothermal, and substantially isothermal gas processes are sufficiently different to have practical impact on the operability and efficiency of such systems. Similarly, the thermal efficiencies of adiabatic, isothermal, and substantially isothermal gas processes are sufficiently different to have practical impact on the overall efficiency of such energy storage systems. For example, for compression of a quantity of gas from initial temperature of 20° C. and initial pressure of 0 psig (atmospheric) to a final pressure of 180 psig, the final temperature T of the gas will be exactly 20° C. for an isothermal process, approximately 295° C. for an adiabatic process, approximately 95° C. for a polytropic compression having polytropic index n=1.1 (10% increase in n over isothermal case of n=1), and approximately 60° C. for a polytropic compression having polytropic index n=1.05 (5% increase in n over isothermal case of n=1). In another example, for compression of 1.6 kg of air from an initial temperature of 20° C. and initial pressure of 0 psig (atmospheric) to a final pressure of approximately 180 psig, including compressing the gas into a storage reservoir at 180 psig, isothermal compression requires approximately 355 kilojoules of work, adiabatic compression requires approximately 520 kilojoules of work, and a polytropic compression having polytropic index n=1.045 requires approximately 375 kilojoules of work; that is, the polytropic compression requires approximately 5% more work than the isothermal process, and the adiabatic process requires approximately 46% more work than the isothermal process.

It is possible to estimate the polytropic index n of gas processes occurring in cylinder assemblies such as are described herein by empirically fitting n to the equation pVⁿ=C, where pressure p and volume V of gas during a compression or expansion, e.g., within a cylinder, may both be measured as functions of time from piston position, known device dimensions, and pressure-transducer measurements. Moreover, by the Ideal Gas Law, temperature within the cylinder may be estimated from p and V, as an alternative to direct measurement by a transducer (e.g., thermocouple, resistance thermal detector, thermistor) located within the cylinder and in contact with its fluid contents. In many cases, an indirect measurement of temperature via volume and pressure may be more rapid and more representative of the entire volume than a slower point measurement from a temperature transducer. Thus, temperature measurements and monitoring described herein may be performed directly via one or more transducers, or indirectly as described above, and a “temperature sensor” may be one of such one or more transducers and/or one or more sensors for the indirect measurement of temperature, e.g., volume, pressure, and/or piston-position sensors.

In various embodiments of the present invention, one or more valves (e.g., poppet-type valves) are integrated into the head of the cylinder. By increasing the rapidity and efficiency of valve action, embodiments of the invention increase the overall power density and efficiency of the energy-conversion system. Other advantages accruing therefrom are not described but are contemplated and within the scope of the invention.

In various embodiments of energy-conversion systems described in the '207 patent, the '155 patent, and U.S. Pat. No. 7,802,426, filed Jun. 9, 2009 (the '426 patent, the entire disclosure of which is incorporated by reference herein), gas is admitted into a chamber of a cylinder at a range of pressures. After being expanded or compressed within the chamber, the gas is exhausted from the chamber. The source of the gas admitted into the chamber and the destination of the gas exhausted from the chamber may be different. For example, gas may be admitted to the chamber from a high-pressure reservoir (or “store”) and exhausted from the chamber to a vent or to a chamber within another cylinder. A separate valve is typically required to regulate gas flow from each source or to each destination. It is desirable for valves regulating gas flow to and from a cylinder to operate (i.e., open and close) rapidly and with low expenditure of energy. Rapid valve operation enables the energy-conversion system to perform briefer operational cycles (e.g., (1) admission of fluid to a cylinder chamber, (2) expansion or compression of fluid within the cylinder chamber, and (3) egress of expanded or compressed fluid from the cylinder chamber), which tends to increase the power rating and power density of the energy-conversion system. Low-energy (efficient) valve operation increases the overall efficiency of the energy-conversion system. Moreover, rapid valve operation reduces throttling losses due to restricted flow through the valve opening during intervals when the valve is only partly open. It is also desirable for valves regulating gas flow to and from a cylinder to have high flow coefficient Cᵥ, a dimensionless number used to characterize valve performance (high Cᵥ is achieved when there is low pressure drop through the valve for high flow).

Embodiments of the present invention advantageously incorporate valve and valve-actuation arrangements that improves the efficiency of the energy storage and recovery when compared to poppet-valve arrangements constructed in accordance with the prior art. Arrangements to more-rapidly achieve sufficiently open and sufficiently closed valve states in accordance with various embodiments of the invention (where the terms “sufficiently open” and “sufficiently closed” shall be defined clearly below), such as are described herein, may allow for more rapid valve opening and closure, thus increasing overall system power rating and density. Arrangements to store energy recovered from valve-disc deceleration (i.e., at end of opening or closing valve strokes) and to use the stored energy in valve-disc acceleration (i.e., at the beginning of opening or closing valve strokes) in accordance with various embodiments of the invention, such as are described herein, may allow for reduction of average energies required to actuate valves, thus increasing overall system efficiency.

Gas undergoing expansion tends to cool, while gas undergoing compression tends to heat. To maximize efficiency (i.e., the fraction of elastic potential energy in the compressed gas that is converted to work, or vice versa), gas expansion and compression should be as near isothermal (i.e., constant-temperature) as possible. Several techniques of approximating isothermal expansion and compression may be employed in accordance with embodiments of the invention.

First, as described in the '426 patent, gas undergoing either compression or expansion may be directed, continuously or in installments, through a heat-exchange subsystem external to the cylinder. The heat-exchange subsystem either rejects heat to the environment (to cool gas undergoing compression) or absorbs heat from the environment (to warm gas undergoing expansion). An isothermal process may be approximated via judicious selection of this heat-exchange rate.

Additionally, as described in the '155 patent, droplets of a liquid (e.g., water) may be sprayed into a chamber of the cylinder in which gas is presently undergoing compression (or expansion) in order to transfer heat to or from the gas. As the liquid droplets exchange heat with the gas around them, the temperature of the gas is raised or lowered; the temperature of the droplets is also raised or lowered. The liquid is evacuated from the cylinder through a suitable mechanism. The heat-exchange spray droplets may be introduced through a spray head (in, e.g., a vertical cylinder), through a spray rod arranged coaxially with the cylinder piston (in, e.g., a horizontal cylinder), or by any other mechanism that permits formation of a liquid spray (or a foam, as described further below) within the cylinder. Droplets (and/or foam) may be used to either warm gas undergoing expansion or to cool gas undergoing compression. Again, an isothermal process may be approximated via judicious selection of this heat-exchange rate. When such liquid heat exchange is utilized, the contents of the chamber may include or consist essentially of a mixture of liquid and gas (e.g., a foam). Any valve used to admit gas to and/or exhaust gas from the chamber preferably accommodates flow of a liquid-gas mixture. Such two-phase flow may exceed a particular quality factor (e.g., >10% volume of liquid compared to the volume of gas, and in some cases >25% volume of liquid).

Various embodiments of the invention relate to a modified cylinder assembly. The piston within the cylinder divides the interior of the cylinder into two tubular chambers. Each tubular chamber is bounded at one end by the piston and at the other end by an end cap. In various embodiments of the invention, two or more hydraulically, electrically, or mechanically operated two-port poppet valves pass through one of the heads of the cylinder. Each valve comprises a body, actuating mechanism, stem, ring, disc (valve member), two ports, and seat. Each valve contains a chamber, herein termed the “flow chamber,” through which fluid may flow.

In each valve, two ports (openings) allow communication between the interior of the valve chamber and the exterior of the valve. One port is typically open at all times and may be connected to a pipe; this port is herein termed the “outside port.” The other port communicates with the interior of the cylinder and is gated by the disc; this port is herein termed the “gated port.”

One end of the stem, herein termed the “distal end,” is connected to an actuating mechanism that causes the stem to move along its axis; the other end of the stem, herein termed the “proximal end,” is connected to the disc, which is a body of material wider than the stem. The distal end of the stem is farther from the gated port than the proximal end. When the valve is closed, the stem has reached its limit of motion in the proximal direction and the peripheral edge or surface of the disc is in contact with the seat, i.e., a tapered surface or flange surrounding the gated port.

The two or more valves are typically of at least two types. In one type of valve, the disc is outside the flow chamber. When the valve is open, the stem is at its limit of motion in the proximal direction (i.e., toward the gated port) and the disc is outside the flow chamber and out of contact with the seat, allowing fluid to flow between the flow chamber and the cylinder chamber through the gated port. When the valve is closed, the stem is at its limit of motion in the distal direction (i.e., away from the gated port) and the disc is in contact with the seat. A valve of this type is herein termed a “low-side valve.”

In another type of valve, the disc is inside the flow chamber. When the valve is open, the stem is at its limit of motion in the distal direction (i.e., away from cylinder chamber) and the disc is positioned inside the flow chamber and out of contact with the seat, allowing fluid to flow between the flow chamber and the cylinder chamber through the gated port. When the valve is closed, the stem is at its limit of motion in the proximal direction (i.e., toward the gated port) and the disc is in contact with the seat. A valve of this type is herein termed a “high-side valve.”

Although descriptions herein are typically phrased, for brevity and clarity, to refer to systems having a single intake (high-side) valve and singular outlet (low-side) valve, systems that have multiple intake and outlet valves, whether these multiple valves operate independently or synchronously, are also contemplated and within the scope of the invention.

When the cylinder is operated as an expander, gas stored high pressure (e.g., approximately 3,000 psi) in a reservoir is admitted to the cylinder assembly through piping and a high-side valve. In an initial state, the fluid gas or gas-liquid mixture within the cylinder chamber is at equal or lower pressure than the gas in the high-pressure reservoir. The high-side valve is open and the low-side valve is closed. High-pressure gas enters the flow chamber of the high-side valve through the high-side valve's outside port. The high-side valve is open, so the disc is not in contact with the seat and both the outside port and the gated port are open. Gas from the high-pressure store flows through the inlet valve into the cylinder.

In this initial state, the low-side valve is in a closed position. That is, the gated port is occluded by the disc, which is in contact with the seat. Herein, the side of a valve disc connected to the stem is termed the “inner side” of the disc and the opposing side of the disc is termed the “outer side” of the disc. When a high-side or low-side valve is closed, fluid inside the flow chamber of the valve exerts hydraulic force on the inner side of the disc and the fluid contents of the cylinder chamber exert hydraulic force on the outer side of the disc. Force is thus exerted on the disc by fluid on both sides of the disc. Force may also be exerted on the disc by the stem through an actuation mechanism. If the stem and the fluid within the flow chamber of a closed low-side valve exert a greater total force on the disc than the fluid within the cylinder chamber, the disc remains in contact with the seat and the gated port remains closed. If the stem and the fluid within the flow chamber of a low-side valve exert a smaller combined force on the disc than the fluid within the cylinder chamber, the disc moves in the distal direction (i.e., away from the seat) and the gated port opens.

In the initial state described above, the cylinder chamber fills with high-pressure gas. The outside port of the low-side valve communicates through piping with a body of gas at lower pressure, e.g., the atmosphere or the contents of another cylinder. The force exerted by the fluid within the flow chamber is smaller than the total force on the disc from the fluid within the cylinder chamber and any stem forces exerted by the actuation mechanism. The gated port therefore remains occluded by the disc, i.e., the low-side valve remains closed. No force need be supplied by the activation mechanism of the low-side valve for the valve to remain closed in this state or any other state in which the contents of the cylinder chamber exerts more force on the disc than do the contents of the flow chamber. The low-side valve may thus fail shut.

In a subsequent operating state, the gaseous component of the fluid within the cylinder chamber has expanded to a pressure (e.g., approximately 300 psi) below that of the high-pressure store. It will be evident to any person reasonably familiar with the art of pneumatic and hydraulic machinery that the high-side valve will fail shut in this operating state, i.e., no force need be supplied by the activation mechanism of the high-side valve in order for the high-side valve to remain closed. In this operating state, sufficient force applied to the stem of the low-side valve by the activation mechanism of the low-side valve will open the low-side valve, allowing fluid within the cylinder chamber to be exhausted through the low-side valve.

In other modes of operation of the embodiment, not explicitly described, gas may be admitted through the low-side valve, compressed within the cylinder chamber, and forced through the high-side valve to the high-pressure store. In compression mode, the valves may be operated in a check-valve mode, wherein no external actuation force is required.

Reference is now made to an idealized valve in which, when the valve is closed, the perimeter of a disc (not necessarily circular) makes contact at every point with the perimeter of an opening (i.e., gated port) of similar shape and size. In this case, no flow through the valve is possible. When the valve is open, the area of the opening through which fluid may flow is A_{GP}, the area of the gated port, which is typically slightly smaller but approximately equal to A_{D}, the area of the disc. The rate of fluid flow that would occur through the open gated port of area A_{GP} for a given pressure difference across the gated port in a case where the flow encounters no obstacle on either side of the gated ported is F_{max,p} (maximum flow for a given differential pressure). The presence of the valve disc in the vicinity of the gated port tends to reduce the effective area available for fluid flow. Assuming disc displacement perpendicular to the plane of the gated port (i.e., typical poppet-style disc motion), the area available for fluid flow through the valve is the area of an imaginary surface connecting the perimeter of the disc to the perimeter of the gated port. Herein, this available area is termed the “curtain area,” A_{curtain}, after the analogical resemblance of the imaginary surface to a curtain dropped from the perimeter of the disc to the perimeter of the gated port. For example, for a circular disc of radius R displaced perpendicularly by distance h from a gated port, A_{GP}=πR² and A_{curtain}=2πRh by elementary geometry. For h<R/2, we have A_{curtain}<A_{GP}. That is, when the disc is closer to the gated port than half its own radius, the area A_{curtain} available for flow through the valve is less than the area of the gated port, A_{GP}. At h=R/2, we have A_{curtain}=A_{GP}, and for h>R/2, we have A_{curtain}>A_{GP}.

It will be apparent to persons reasonably familiar with the science of fluid dynamics that the rate of flow through the valve will tend to be less for a given pressure drop through the valve, given the presence of the disc at any finite distance, than it would be in the absence of the disc. Equivalently, a given rate of flow through the valve, given the presence of the disc at some finite distance, will tend to entail a higher pressure drop (and thus energy loss) than the same rate of flow would entail in the absence of the disc. In short, the disc tends to impede flow through the gated port to some extent no matter how far it is from the seat.

For a given pressure drop across the valve, flow through the valve is a function F(h) of disc displacement h. In particular, F(h)=0 when h=0 (i.e., valve is closed) and F(h)→F_{max,p} as h→∞. That is, F(h) approaches its maximum possible value F_{max,p} asymptotically as the disc is moved to an ever-greater distance from the seat. Thus, even where h≧R/2, and the available flow area A_{curtain} is equal to or greater than the gated port area A_{GP}, flow F(h) for a given pressure drop is less than the theoretical maximum flow F_{max,p}.

However, most (e.g., approximately 90%) of the potential gain in flow with increasing h is realized by displacing the disc to h=R/2, that is, making the curtain area A_{curtain} equal to the gated port area A_{GP}. Poppet-type valves are therefore typically deemed fully open when they are “sufficiently open,” i.e., when an opening valve stroke has moved the disc to a distance h=R/2 away from the gated port, or to a distance of similar magnitude. Poppet valves are typically designed to move the disc to approximately h=R/2, or to a displacement of similar magnitude, as a final, fully open position. Herein, we term the flow through the valve for a given differential pressure when h equals R/2, or a value of similar magnitude, the sufficiently open flow, F_{SO,p}.

A valve is closed when the disc is in contact with the seat and the valve opening is thus 100% occluded. Sufficient closure may be defined as a state wherein flow for a given differential pressure is, e.g., less than 1% of the sufficiently open flow, F_{SO,p}.

Values of sufficiently open displacement h_{SO} approximately equal to R/2 are discussed herein as typical, but other values of h_{SO} are also envisaged. Realistic values of h_{SO} will typically be of similar magnitude to R/2.

When a disc and stem are moved so as to open or close a valve, the stem and disc are first accelerated from rest, and then, at the end of the stroke, decelerated until they are again at rest. The deceleration may occur suddenly: for example, during valve closure, sudden deceleration occurs if the disc is allowed to impact the seat at its maximum closure velocity, without prior deceleration. However, undecelerated impact entails the action of short-lived, high-magnitude forces on the seat, disc, stem, and possibly other valve and system components. These sudden, strong forces may cause component wear, noise, disc bounce, and other undesirable effects. Sudden deceleration of the disc during valve opening does not entail collision of the disc with the seat (because the disc is moving away from the seat during opening), but typically does entail similar impact forces elsewhere in the valve mechanism.

Therefore, it is typical to provide arrangements for decelerating the stem and disc before end of valve stroke, during both opening and closing. Such pre-deceleration, entails the action of longer-lived, lower-magnitude forces on valve components than does the acceptance of deceleration by impact. However, such pre-deceleration, by reducing the average velocity of the valve during the opening or closing stroke, slows valve actuation and increases throttling losses during prolonged, partially-opened valve states.

In embodiments of the invention, provision is made for rapid opening and closing of both low-side and high-side valves in a manner that preserves the primary advantage of pre-deceleration (i.e., avoidance or mitigation of impact forces) while shortening valve actuation time in comparison to a valve arranged in accordance with the prior art. Embodiments of the invention also include provisions for storing a portion of the energy transferred from the disc and stem, and possibly other components, during deceleration, whether during opening or closing, and restoring a portion of the stored energy to the disc and other moving components during acceleration.

Embodiments of the present invention are typically utilized in energy storage and generation systems utilizing compressed gas. In a compressed-gas energy storage system, gas is stored at high pressure (e.g., approximately 3,000 psi). This gas may be expanded into a cylinder having a first compartment (or “chamber”) and a second compartment separated by a piston slidably disposed within the cylinder (or by another boundary mechanism). A shaft may be coupled to the piston and extend through the first compartment and/or the second compartment of the cylinder and beyond an end cap of the cylinder, and a transmission mechanism may be coupled to the shaft for converting a reciprocal motion of the shaft into a rotary motion, as described in the '678 and '842 patents. Moreover, a motor/generator may be coupled to the transmission mechanism. Alternatively or additionally, the shaft of the cylinders may be coupled to one or more linear generators, as described in the '842 patent.

As also described in the '842 patent, the range of forces produced by expanding a given quantity of gas in a given time may be reduced through the addition of multiple, series-connected cylinder stages. That is, as gas from a high-pressure reservoir is expanded in one chamber of a first, high-pressure cylinder, gas from the other chamber of the first cylinder is directed to the expansion chamber of a second, lower-pressure cylinder. Gas from the lower-pressure chamber of this second cylinder may either be vented to the environment or directed to the expansion chamber of a third cylinder operating at still lower pressure; the third cylinder may be similarly connected to a fourth cylinder; and so on.

The principle may be extended to more than two cylinders to suit particular applications. For example, a narrower output force range for a given range of reservoir pressures is achieved by having a first, high-pressure cylinder operating between, for example, approximately 3,000 psig and approximately 300 psig and a second, larger-volume, lower-pressure cylinder operating between, for example, approximately 300 psig and approximately 30 psig. When two expansion cylinders are used, the range of pressure within either cylinder (and thus the range of force produced by either cylinder) is reduced as the square root relative to the range of pressure (or force) experienced with a single expansion cylinder, e.g., from approximately 100:1 to approximately 10:1 (as set forth in the '853 application). Furthermore, as set forth in the '678 patent, N appropriately sized cylinders can reduce an original operating pressure range R to R^{1/N}. Any group of N cylinders staged in this manner, where N≧2, is herein termed a cylinder group.

In one aspect, embodiments of the invention feature an energy storage and recovery system that includes a cylinder assembly for compression of gas to store energy and/or expansion of gas to recover energy therewithin, the cylinder assembly having an interior compartment and an end cap disposed at one end. Integrated within the end cap are (i) a first valve for admitting fluid into the interior compartment of the cylinder assembly prior to expansion and exhausting fluid from the interior compartment of the cylinder assembly after compression and (ii) a second valve for exhausting fluid from the interior compartment of the cylinder assembly after expansion and admitting fluid into the interior compartment of the cylinder assembly prior to compression. Each of the first and second valves controls fluid communication with the interior compartment via a separate fluid path, and each comprises a gated port and an outside port. The system also includes a first actuation mechanism for actuating the first valve and a second actuation mechanism for actuating the second valve, as well as a control system for controlling the first and second actuation mechanisms based at least in part on the pressure inside the interior compartment of the cylinder assembly, the position of the gated port of the first valve, and/or the position of the gated port of the second valve.

Various embodiments of the invention incorporate one or more of the following in any of a variety of combinations:

(1) The actuation mechanisms of the first valve and/or second valve include arrangements for moving the valve disc to a full-open distance h_{FO} from the valve seat. (Herein, disc displacement is given as the distance from the proximal surface of the disc to the inner perimeter of the seat.) The full-open distance h_{FO} is substantially greater than the sufficiently-open distance h_{SO}. Herein, h_{FO} is “substantially greater” than h_{SO} if the difference of the two distances, h_{FO}−h_{SO}, suffices, during an opening valve stroke, for the actuation mechanism to decelerate the stem and disc from their maximum opening-stroke velocity V_{MO} to an acceptably low final opening velocity V_{OV} (e.g., zero).

During an opening stroke, the disc and stem are accelerated from rest by the actuation mechanism (and/or by pressurized fluids exerting hydraulic force on the disc) to the maximum opening velocity V_{MO}. The disc and stem may attain V_{MO} at or before reaching the sufficiently-open distance h_{SO}. When or after the disc reaches h_{SO}, the actuation mechanism begins to decelerate the disc and stem. By the time the disc reaches the final-open distance h_{FO}, the actuation mechanism has decelerated the disc and stem to the acceptable final-opening velocity V_{OV} (e.g., zero).

(2) The valve seat includes a contact ring of a suitable material (e.g., polyether ether ketone [PEEK]) connected to a shock-absorbing mechanism. The contact ring is the portion of the valve seat that touches the disc when the valve is closed. The shock-absorbing mechanism may comprise, for example, an annular wave spring mounted beneath the contact ring. Other types of shock-absorbing mechanism, such as air springs and polymer elastic materials, are contemplated and within the scope of the invention. The shock-absorbing mechanism allows motion of the ring from an initial position at h=0 to a substantially depressed position at h=−h_{SD}. Herein, negative distances denote proximal displacement from h=0. The distance −h_{SD} is “substantial” if it suffices, during a closing valve stroke, for the shock-absorbing mechanism to decelerate the stem and disc from their maximum closing-stroke velocity V_{MC} to an acceptably low final closing velocity V_{CV} (e.g., zero).

During a closing stroke of the valve, the seat and stem are accelerated from rest by the actuation mechanism to the maximum closing velocity V_{MC}. The disc and stem may attain V_{MC} at or before the disc reaches the contact ring (h=0); when the disc reaches the contact ring, it is moving at V_{MC}. From the moment of first disc-and-ring contact forward, a deceleration mechanism (e.g., wave spring) connected to the ring presents resistance to the motion of the disc, decelerating the disc. By the time the disc reaches its substantially-depressed displacement h_{SD}, the deceleration mechanism has decelerated the disc to the acceptable final-closing velocity V_{CV}. Thereafter, in some embodiments, the deceleration mechanism restores the disc and contact ring to the neutral position h=0.

(3) Provision is made for a portion of the kinetic energy removed from the disc and stem during deceleration, whether during opening or closing, to be stored, and for a portion of this stored energy to be imparted, in the form of kinetic energy, to the disc and stem during acceleration. Herein, such an arrangement is termed “regenerative valving.” For example, the energy may be stored as pressure potential energy of a fluid.

Various embodiments of the invention employ one or more valves (e.g., poppet-type valves) that may be integrated into the head of the cylinder. These valves provide quick valve action, high flow coefficient (i.e., low pressure drop through the valve for high flow), and other advantages, some of which are described below. By increasing the efficiency of valve action, embodiments of the invention increase the overall efficiency of the energy-conversion system.

In various embodiments that incorporate hydraulically activated two-port poppet valves that pass through one of the heads of the cylinder, the hydraulic activation mechanism of each poppet valve includes a hydraulic cylinder. The piston within the activation cylinder divides the interior of the activation cylinder into two tubular, fluid-filled chambers. Each tubular chamber is bounded at one end by the proximal surface of the piston and at the other end by an end cap. A stem is attached to the piston and passes through the proximal end-cap of the activation cylinder. The stem is aligned with and attached to a second stem passing through the distal end-cap of a poppet valve that gates fluid flow into and/or out of the modified cylinder assembly. The second stem is attached to the disc of the poppet valve. The piston and stem of the activation cylinder move in unison with the disc and stem of the poppet valve. The two chambers of the hydraulic activation cylinder are herein designated the proximal chamber (the chamber closer to the modified cylinder assembly) and the distal chamber (the chamber farther from the modified cylinder assembly).

When fluid pressure in the distal chamber of the activation cylinder exceeds the fluid pressure in the proximal chamber of the activation cylinder, the piston and stem of the activation cylinder, hence also the piston and stem of the poppet valve, which move in unison therewith, tend to accelerate toward the cylinder assembly. When the fluid pressure in the proximal chamber of the activation cylinder exceeds the fluid pressure in the distal chamber of the activation cylinder, the piston and stem of the activation cylinder, hence also the piston and stem of the poppet valve, tend to accelerate away from the cylinder assembly. Herein, the terms “accelerate” and “decelerate” are employed interchangeably: typically, “deceleration” denotes acceleration such that an object's velocity decreases in magnitude.

When the piston of the activation cylinder is at or near the proximal limit of its range of motion, the poppet disc is seated (i.e., the poppet valve is closed and no fluid enters or leaves the modified cylinder assembly through the poppet valve). When the piston of the activation cylinder is at or near the distal limit of its range of motion, the poppet disc is at a distance from the seat such that the poppet valve is fully open and fluid enters or leaves the modified cylinder assembly while undergoing a minimal pressure drop. When the piston of the activation cylinder is at any intermediate position, at (or near) neither its proximal nor distal limit of motion, the activation cylinder is generally in a transient opening or closing state. In particular, when the piston of the activation cylinder is near (but not at) its proximal limit of motion, the poppet valve is only partially open, i.e., the disc of the poppet valve is relatively near to the seat and, as regards this poppet valve, fluid enters or leaves the modified cylinder assembly only through the relatively constricted opening between the disc and the seat. Fluid flow through such an opening entails turbulence and throttling losses (i.e., losses of useful energy). Losses thus entailed are herein termed “disc-proximity losses.” The period during valve opening or closure during which disc proximity losses are non-negligible is herein termed the “disc-proximity period,” and the range of proximal-distal disc positions in which disc proximity losses are non-negligible is herein termed the “disc-proximity zone.” The length of the disc-proximity zone is herein termed Dₚᵣₒₓ. In general, in order to maximize overall energy-storage system efficiency, the disc-proximity period is minimized during poppet valve opening and closure.

To minimize disc-proximity losses, the poppet valve disc is moved as quickly as possible from its fully open position into contact with the seat (when the poppet valve is being closed) and as quickly as possible away from the seat to its fully open position (when the poppet valve is being opened). One approach to minimizing disc-proximity losses during valve closure is to accelerate the piston of the activation cylinder, and thus the disc of the poppet valve, to some relatively high velocity in the proximal direction. The acceleration occurs mostly or entirely before the disc of the poppet reaches the disc-proximity zone (i.e., gets within Dₚᵣₒₓ of the seat). The disc of the poppet valve thus moves at high velocity through the disc-proximity zone until contact is made with the seat. Alternatively, the piston of the activation cylinder, and thus the disc of the poppet valve, may be accelerated in the proximal direction right up until the disc strikes the seat. In general, however, high-velocity impact between the disc and seat, whether the disc is still accelerating or not at the moment of impact, are disadvantageous, since they create shock waves and component wear and mandate heavier, more robust components (e.g., stems), which are subject to more force to undergo any given acceleration than do lighter, less robust components. In general, low disc-to-seat impact velocities are desirable.

In light of the foregoing considerations it is advantageous, during poppet-valve closure, to first (a) produce high-velocity motion of the piston of the activation cylinder, and thus of the disc of the poppet valve, and then (b) to rapidly decelerate these components as the disc approaches the seat, so that disc-to-seat impact velocity is acceptably low. In general, the shortest disc-proximity period, with minimal disc-proximity losses, will be achieved during poppet-valve closure if (a) the highest possible velocity Vₘₐₓ is imparted to the activation cylinder piston and poppet disc before the disc enters the disc-proximity zone, and (b) the activation cylinder piston and poppet disc are decelerated with the highest possible acceleration just prior to disc-to-seat impact, starting at Vₘₐₓ and ending with some acceptably low disc-to-seat impact velocity V_{end}. Herein, vectors of velocity and acceleration are referred to by their scalar magnitudes, with direction of action made clear by context or explicit statement.

As noted above, the activation cylinder piston will tend to accelerate in the distal direction—e.g., during poppet-valve closure, will slow down (decelerate)—when the hydraulic force acting on the proximal face of the piston is greater than the hydraulic force acting on the distal face of the piston. (Any other distal-directed force acting on the activation cylinder piston—e.g., an electromagnetic force, or a mechanical force applied to the stem of the activation cylinder piston by some mechanism—will also tend to accelerate the activation cylinder piston in the distal direction.) During deceleration of the activation cylinder piston, one therefore wishes in general to produce the maximum possible pressure within the proximal chamber of the activation cylinder. The maximum possible pressure in the proximal chamber of the activation cylinder during piston deceleration is in general determined by the hydraulic pressure rating Pₘₐₓ of the activation cylinder.

In various embodiments where no electromagnetic or other forces act on the piston in addition to the hydraulic forces within the activation cylinder, shortest-duration deceleration of the activation cylinder piston during poppet-valve closure occurs ideally as follows. (1) The activation cylinder piston and all system components moving in unison therewith, including the poppet disc, are accelerated to some proximally-directed maximum velocity Vₘₐₓ. Vₘₐₓ is achieved by the time the disc of the poppet valve reaches the beginning of the disc proximity zone: i.e., the disc is moving at Vₘₐₓ by the time the disc is a distance Dₚᵣₒₓ from the seat. (2) When the disc and other components reach distance Dₚᵣₒₓ from the seat, moving at Vₘₐₓ, the fluid pressure in the distal chamber of the activation cylinder drops suddenly to zero or some negative value and pressure in the proximal chamber jumps from zero or some negative value to Pₘₐₓ. Pressure in the proximal chamber remains constant at Pₘₐₓ during deceleration as fluid is expelled from the proximal chamber. A distally-directed net hydraulic force F_{decel} thus acts upon the activation cylinder piston and on the components moving in unison therewith. As the activation cylinder piston moves through distance Dₚᵣₒₓ, the constant force F_{decel} decelerates the activation cylinder piston to an acceptable disc-to-seat impact velocity, V_{end}. This deceleration takes place at constant acceleration A. By Newton's Second Law, F_{decel}=M_{T}A, where M_{T} is the total mass of the activation cylinder piston and all components moving in unison therewith. (3) During disc-to-seat impact, all hydraulic forces acting on the activation cylinder piston are zero or negligible, and impact forces dominate the deceleration to rest of the disc and components moving in unison therewith, including the activation cylinder piston. Some rebound motion of the disc and other components may occur subsequent to impact; such motions may be damped by friction and by hydraulic and/or other contrivances.

Maximum deceleration for a minimum time interval will, in general, minimize disc-proximity losses during closing of the poppet valve because the time interval during which such losses occur will be minimized. Maximum deceleration, in embodiments where deceleration of the poppet valve is primarily due to force exerted on the activation piston by fluid within the proximal chamber of an activation cylinder, will occur if and only if maximum-allowable pressure Pₘₐₓ is maintained in the proximal chamber of the activation cylinder throughout deceleration. In general, however, allowing the decelerating piston (whose effective mass will be equal to that of all components moving in unison therewith) to expel fluid from the proximal chamber via a path having fixed flow resistance (e.g., one or more fixed orifices connected to fixed exterior piping and other components) will not produce a constant pressure Pₘₐₓ in the proximal chamber of the activation cylinder. Rather, the pressure P(t) in the proximal chamber will decrease as the piston decelerates. Here the notation P(t) signifies that the pressure P is a function of time.

To produce a constant or approximately constant pressure Pₘₐₓ in the proximal chamber of the activation cylinder throughout deceleration of the piston from initial velocity Vₘₐₓ to final velocity V_{end}, fluid being expelled from the chamber by the decelerating piston is directed through a channel having a time-variable (modulated) flow resistance R_{flow}(t). Such modulation is specifically timed and controlled in order to produce a constant or approximately constant pressure Pₘₐₓ (or any other specific time-dependent pressure profile) in the proximal chamber of the activation cylinder. Variability in the flow resistance R_{flow}(t) may be created by several means: for example, pressure drop through a valve in the flow path external to the activation cylinder may be actively modulated during deceleration by narrowing or widening the interior diameter of the valve.

In some embodiments of the present invention, the orifice through which fluid exits the proximal chamber is modulated during deceleration of the piston in order to produce an approximately constant pressure Pₘₐₓ (or some desired time-dependent pressure profile) in the proximal chamber. Orifice modulation during deceleration may be achieved by means of a shutter, dilating iris, or other contrivance within the valve assembly. Orifice modulation during valve closure may be achieved most simply by shaping and placing an orifice or orifices in the side-wall of the proximal chamber in such a manner that the activation cylinder piston itself progressively curtains off or occludes the orifice or orifices as it decelerates. Such progressive occlusion will modulate the flow resistance encountered by the fluid exiting the proximal chamber during deceleration. Herein, orifices shaped and placed to be progressively occluded by a moving piston are termed “occludable orifices,” as distinct from “fixed orifices” (e.g., in the end-cap of the activation cylinder), whose opening area does not change during piston motion. Occludable orifices may be combined with fixed orifices in a given cylinder assembly. Appropriate sizing, shaping, and placing of occludable and fixed orifices may be used to tune the flow resistance encountered by fluid being forced from the proximal chamber throughout piston deceleration, and thus to tune the pressure P(t) within the proximal chamber throughout piston deceleration. Within the material limits of a given assembly, tuning of pressure P(t) within the proximal chamber is arbitrary (i.e., may take on any desired functional shape). One possible tuning, already described, is to arrange for a constant pressure P(t)=Pₘₐₓ within the proximal chamber throughout deceleration.

The precise shaping and arrangement of multiple occludable orifices in an activation cylinder, and their possible combination with one or more fixed orifices, in order to produce any P(t) within the proximal chamber of the activation cylinder throughout deceleration, thus minimizing deceleration time and disc proximity losses, is in general non-unique (i.e., more than one arrangement of orifices may produce any specific P(t)). The relationship between orifice number, size, placement, and shape and P(t) is in practice dependent in a complex and non-obvious manner on cylinder geometry, properties of the hydraulic fluid, and other factors. All such shapings and arrangements of orifices, and all combinations of such orifice shapings and arrangements with other methods of modulating flow resistance during valve closure (e.g., modulation of external flow resistances) in order to tune or tailor the pressure within the proximal chamber, the distal chamber, or both, are contemplated and within the scope of the invention.

As will be clear to persons familiar with hydraulic pistons and valves, the methods and techniques described above for producing tuned stroke deceleration of the activation cylinder piston during closure of a poppet valve may also be applied to tuning deceleration during the opening stroke of an activation cylinder, or of any other hydraulic cylinder in which a piston is decelerated by end of stroke. The application to opening strokes of the methods and techniques described above for tuning stroke deceleration is not discussed further herein.

In various embodiments, it may be neither practical nor necessary to produce constant P(t) in the proximal chamber of the activation cylinder during deceleration of the piston. Rather, it may suffice to limit the peak value of P(t) during deceleration to some highest acceptable value Pₘₐₓ while decelerating the piston more rapidly than would be possible (without exceeding Pₘₐₓ) in the absence of an appropriately shaped occludable orifice or other contrivances for adjusting the relationship between fluid outflow from the proximal chamber and the velocity of the decelerating piston. That is, a flattening or smoothing of the P(t) curve by the methods and techniques described will in general be advantageous even if ideal deceleration of the piston (constant Pₘₐₓ during deceleration) is not achieved.

Various embodiments of the invention, as already noted hereinabove, employ one or more valves that may be integrated into the head of a cylinder and that typically (i) use differential pressure to open, (ii) use electromagnetic force to hold open, and (iii) check closed. Each valve may exert an electromagnetic force upon its sealing member (also herein termed its “valve member”) at any time during opening, holding open, closing, or holding closed; the force thus exerted may act in either a closing direction or opening direction, and its magnitude may be controlled dynamically by a time-varying current or currents activating one or more electromagnets. Such valves, herein termed “electromagnetic valves” or simply “valves” (where context makes such usage unambiguous), provide quick valve action, low valve-actuation energy, high flow coefficient (i.e., low pressure drop through the valve for high flow), protection against loss of pressurized fluid with failure of valve-actuation power, fine control over valve actuation force as a function of time, and other advantages, some of which are described below. By increasing the efficiency of valve action, embodiments of the invention increase the overall efficiency of the energy-conversion system. Other advantages accruing from embodiments of the invention are not described but are contemplated and within the scope of the invention.

Electromagnetic valves having two ports, a single disc-shaped valve member, and a single seat are described herein, but electromagnetic valves that have multiple ports and multiple valve members and seats, and that also or alternatively have valve members and seats in the general form of rings, plates, and other geometric shapes, are all contemplated and within the scope of the invention. The number of ports and the shape and number of the valve members and rings in a given electromagnetic valve, as well as the number of valves employed in a given cylinder assembly, may all be varied without departing from the scope of the invention.

In some embodiments of the invention, in each electromagnetic valve, two ports (openings) allow communication between the interior of the flow chamber and the exterior of the valve. One port is typically open at all times and may be connected to a pipe; this port is herein termed the “outside port.” The other port communicates with the interior of the cylinder and is gated by the valve member; this port is herein termed the “gated port.”

In some embodiments of the invention, an electromagnetic actuation mechanism including an electromagnet may (for example, depending on the direct of the current in its windings), exert either an attractive or repulsive force on a permanent magnet in the valve member. The motion of the valve member may be constrained by mechanical guides (e.g., the walls of the flow chamber) to be either directly toward or away from the actuation mechanism. When the valve is closed, the peripheral edge or surface of the valve member is generally in contact with the seat, i.e., a tapered surface or flange surrounding the gated port. The valve member and seat are preferably shaped in a complementary manner such that when the valve member is in contact with the seat, the gated ported is entirely blocked. When the valve is open, the valve member is not in contact with the seat, and fluid may flow through the gap between the valve member and the seat and through the gated port.

In various embodiments of the invention, the valves are of at least two types. In one type of valve, the valve member is inside the flow chamber. A permanent magnet may be attached to, be within, or be a portion of the valve member. A magnetic field produced by the actuation mechanism exerts an attractive or repulsive force on the permanent magnet, tending to open or close the valve. When the valve is open, the valve member is out of contact with the seat, allowing fluid to flow between the flow chamber and the cylinder chamber through the gated port. When the valve is open, the distance between the facing poles of the magnets of the actuation mechanism and valve member is reduced or minimized. When the valve is closed, the flow chamber is in contact with the seat. The valve member and seat are preferably shaped in a complementary manner such that when the valve member is in contact with the seat, the gated port is entirely blocked. A valve of this type is herein termed a “high-side valve.”

In another type of valve according to various embodiments of the invention, the valve member is outside the flow chamber, and a stem may extend from the valve member through the flow chamber to the actuation mechanism. A permanent magnet may be attached to, be within, or be a portion of the stem. A magnetic field produced by the actuation mechanism exerts an attractive or repulsive force on the permanent magnet, tending to open or close the valve. The valve member and seat are preferably shaped in a complementary manner such that when the valve member is in contact with the seat, the gated port is entirely blocked. When the valve is open, the valve member is out of contact with the seat, allowing fluid to flow between the flow chamber and the cylinder chamber through the gated port. When the valve is open, the valve member is close to or in contact with the seat, and the distance between the facing poles of the magnets of the actuation mechanism and valve member is reduced or minimized. A valve of this type is herein termed a “low-side valve.”

In various embodiments of the invention, components of the actuation mechanism (e.g., conducting wires that may create a magnetic field) may be embedded within the body of the valve, surrounding the seat; springs may be attached to the valve member or positioned so that in some states of operation the valve member comes in contact with the springs; hydraulic or other types of mechanisms may exert force upon the valve member in various states of operation, additional to any electromagnetic forces that may be exerted on the valve member; the valve member may include an electromagnet rather than a permanent magnet; the actuation mechanism may include a permanent magnetic rather than an electromagnet; two or more electromagnets may be employed, rather than one electromagnet and one permanent magnet; the valve member of a low-side valve may not be connected to a stem; the valve member of a high-side valve may be connected to a stem; and other elements of valve structure may differ from those explicitly described herein, without departing from the scope of the invention.

When the cylinder is operated as an expander, gas stored high pressure (e.g., approximately 3,000 psi) in a reservoir is admitted to the cylinder assembly through piping and a high-side valve. In an initial state, the fluid gas or gas-liquid mixture within the cylinder chamber is at equal or lower pressure than the gas in the high-pressure reservoir. The high-side valve is open and the low-side valve is closed. High-pressure gas enters the flow chamber of the high-side valve through the high-side valve's outside port. The high-side valve is open, so the valve member is not in contact with the seat and both the outside port and the gated port are open. Gas from the high-pressure store flows through the inlet valve into the cylinder.

In this initial state, the low-side valve is in a closed position. That is, the gated port is occluded by the valve member, which is in contact with the seat. Herein, the side of a valve member connected to the stem is termed the “inner side” of the valve member and the opposing side of the valve member is termed the “outer side” of the valve member. When a high-side or low-side valve is closed, fluid inside the flow chamber of the valve exerts hydraulic force on the inner side of the valve member and the fluid contents of the cylinder chamber exert hydraulic force on the outer side of the valve member. Force is thus exerted on the valve member by fluid on both sides of the valve member. Force may also be exerted on the valve member by the stem through the actuation mechanism. If the stem and the fluid within the flow chamber of a closed low-side valve exert a greater total force on the valve member than the fluid within the cylinder chamber, the valve member remains in contact with the seat and the gated port remains closed. If the stem and the fluid within the flow chamber of a low-side valve exert a smaller combined force on the valve member than the fluid within the cylinder chamber, the valve member moves in the distal direction (i.e., away from the seat) and the gated port opens.

In the initial state described above, the cylinder chamber fills with high-pressure (e.g., 3,000 psi) gas. The outside port of the low-side valve communicates through piping with a body of gas at lower pressure, e.g., the atmosphere or the contents of another cylinder. The force exerted by the fluid within the flow chamber is smaller than the total force on the valve member from the fluid within the cylinder chamber and any forces exerted on the valve member by the actuation mechanism. The gated port therefore remains occluded by the valve member, i.e., the low-side valve remains closed. No closing force need be supplied by the activation mechanism of the low-side valve for the valve to remain closed in this state or any other state in which the contents of the cylinder chamber exert more force on the valve member than do the contents of the flow chamber. The low-side valve may thus fail shut or “check closed.” The low-side valve may also be actuated closed or, when closed, provided with a closing bias (substantially constant closing force). Similarly, no closing force need be supplied by the activation mechanism of the high-side valve for the valve to remain closed in any state in which the contents of the flow chamber exert more force on the valve member than do the contents of the cylinder chamber. The high-side valve, like the low-side valve, may thus fail shut or “check closed.” The high-side valve may also be actuated closed or, when closed, provided with a closing bias.

In a subsequent operating state, the gaseous component of the fluid within the cylinder chamber has expanded to a pressure (e.g., 300 psi) below that of the high-pressure store. It will be evident to any person reasonably familiar with the art of pneumatic and hydraulic machinery that the high-side valve will fail shut in this operating state, i.e., no force need be supplied by the activation mechanism of the high-side valve in order for the high-side valve to remain closed. In this operating state, sufficient force applied to the valve member of the low-side valve by the activation mechanism of the low-side valve will open the low-side valve, allowing fluid within the cylinder chamber to be exhausted through the low-side valve.

In other modes of operation of the embodiment, not explicitly described, gas may be admitted through the low-side valve, compressed within the cylinder chamber, and forced through the high-side valve to the high-pressure store. In compression mode, the valves may be operated in a check-valve mode in which no external actuation force is required.

Methods of reducing coupling losses and improving system performance during an expansion stage of a compressed-gas energy storage system by pre-compressing any fluid remaining within the cylinder chamber before admitting additional high-pressure gas from a source outside the cylinder are disclosed in U.S. patent application Ser. No. 13/650,999, filed Oct. 12, 2012 (the '999 application), the disclosure of which is hereby incorporated by reference in its entirely. Embodiments of the present invention may be combined with the methods disclosed in the '999 application, realizing advantages of both the present invention and the methods disclosed in the '999 application.

Use of differential pressure (i.e., differences in pressure, in various states of operation, between fluids in the cylinder chamber and in inlet and outlet pipes communicating with the cylinder chamber through high-side and low-side valves) to open the high-side and low-side valves, with use of electromagnetic force for holding open, accelerating, or otherwise influencing the opening or closing of such valves, is generally advantageous compared to conventional systems. The electromagnetic force between two magnetic poles, whether attractive or repulsive, is proportional to 1/x², where x is the distance (gap) between the poles. Therefore, in embodiments of the present invention where the distance between the magnets (e.g., the electromagnet of the actuation mechanism and the permanent magnet of the valve member) decreases during opening of either a high-side or low-side electromagnetic valve, an increasing attractive force between the magnets (i.e., increasing electromagnetic opening force on the valve member) may be obtained during opening by maintaining a constant or increasing current in the windings of the electromagnet; or, a constant opening force may be obtained by appropriately decreasing the current in the windings; or, a decreasing opening force may be obtained by more rapidly decreasing the current in the windings; or, zero or minimal opening force may be obtained by setting the current in the windings to zero (or to a constant DC value). The force between the magnets may be varied arbitrarily, or even reversed in direction, during closing by appropriate variation of the current in the windings.

In a state of operation where the opening motion of the valve member is favored by forces arising from differential pressure in the flow chamber and cylinder chamber, the energy that must be expended by the actuation mechanism to achieve a given opening speed is minimal, and the valve will tend to open even if the current in the windings is zero (i.e., if zero energy is expended by the actuation mechanism). However, non-zero opening force may accelerate the opening of the valve, advantageously speeding the commencement of flow between the flow chamber and the cylinder chamber. Moreover, by appropriate time-variation of the current in the windings of the actuation mechanism, the velocity of the valve member may be controlled precisely throughout opening of the valve, potentially realizing further advantages. For example, reversal of the current in the windings of the electromagnet at the end of the valve-opening process (i.e., as the gap between the two poles becomes relatively small) may decelerate the valve member as it approaches the actuation mechanism, reducing collision forces and so extending the life of the electromagnetic valve.

It is typically desirable to exert a holding force on the valve member of an open valve in order to keep the valve member in full-open position and thus assure that the flow chamber remains minimally obstructed while fluid is flowing through the valve. Because the force between the magnetic poles for a given winding current is proportional to 1/x², and effective x is at a minimum when the magnets are at a minimal distance from each other (e.g., in contact), a holding force may be exerted on the valve member of an open valve using a minimal winding current and thus minimal energy. In some embodiments, the magnetic attraction between the ferromagnetic core of the actuation mechanism and the permanent magnet of the valve member may provide sufficient holding-open force even if zero current flows through the windings of the actuation mechanism. A valve may be opened entirely by differential pressure, then held open by electromagnetic force. A valve may also be opened by a combination of differential pressure and electromagnetic force acting on the valve member, or solely by electromagnetic force, and once open may be held open by electromagnetic force.

Advantages may be realized by embodiments of the invention not only during opening and holding-open of the electromagnetic valve, as described above, but during closure. For example, at the initiation of closure of a fully open valve, the distance x between the poles of the electromagnet and the permanent magnet is minimal, so a relatively large repulsive force between the two magnets may be produced by a relatively small current (small actuation energy). In this manner, the movement of the valve member to a closed position may be initially accelerated with relatively small expenditure of energy. The directional sense of the current flowing in the windings of the actuation mechanism during valve closure will generally be the reverse of the current flowing in the windings during valve opening. By appropriate time-variation of the current in the windings of the actuation mechanism, the velocity of the valve member may be controlled precisely throughout closing of the valve, potentially realizing further advantages. For example, reversal of the current in the windings of the electromagnet at the end of the valve-closing process (i.e., as the gap between the two poles becomes relatively large) may decelerate the valve member as it approaches the seat, reducing collision forces and so extending the life of the electromagnetic valve. A holding force may be exerted by the actuation mechanism on a closed valve member. However, in typical operation, forces placed on the valve member by differential pressure will render the generation of an electromagnetic closure-holding force unnecessary.

All of the approaches described above for converting potential energy in a compressed gas into mechanical and electrical energy may, if appropriately designed, be operated in reverse to store electrical energy as potential energy in a compressed gas. Since the accuracy of this statement will be apparent to any person reasonably familiar with the principles of electrical machines, power electronics, pneumatics, and the principles of thermodynamics, the operation of these mechanisms to both store energy and recover it from storage are not necessarily described for each embodiment. Such operation is, however, contemplated and within the scope of the invention and may be straightforwardly realized without undue experimentation.

The systems described herein, and/or other embodiments employing foam-based heat exchange, liquid-spray heat exchange, and/or external gas heat exchange, may draw or deliver thermal energy via their heat-exchange mechanisms to external systems (not shown) for purposes of cogeneration, as described in U.S. Pat. No. 7,958,731, filed Jan. 20, 2010 (the '731 patent), the entire disclosure of which is incorporated by reference herein.

The compressed-air energy storage and recovery systems described herein are preferably “open-air” systems, i.e., systems that take in air from the ambient atmosphere for compression and vent air back to the ambient atmosphere after expansion, rather than systems that compress and expand a captured volume of gas in a sealed container (i.e., “closed-air” systems). The systems described herein generally feature one or more cylinder assemblies for the storage and recovery of energy via compression and expansion of gas. The systems also include (i) a reservoir for storage of compressed gas after compression and supply of compressed gas for expansion thereof, and (ii) a vent for exhausting expanded gas to atmosphere after expansion and supply of gas for compression. The storage reservoir may include or consist essentially of, e.g., one or more one or more pressure vessels (i.e., containers for compressed gas that may have rigid exteriors or may be inflatable, that may be formed of various suitable materials such as metal or plastic, and that may or may not fall within ASME regulations for pressure vessels), pipes (i.e., rigid containers for compressed gas that may also function as and/or be rated as fluid conduits, have lengths well in excess (e.g., >100×) of their diameters, and do not fall within ASME regulations for pressure vessels), or caverns (i.e., naturally occurring or artificially created cavities that are typically located underground). Open-air systems typically provide superior energy density relative to closed-air systems.

Furthermore, the systems described herein may be advantageously utilized to harness and recover sources of renewable energy, e.g., wind and solar energy. For example, energy stored during compression of the gas may originate from an intermittent renewable energy source of, e.g., wind or solar energy, and energy may be recovered via expansion of the gas when the intermittent renewable energy source is nonfunctional (i.e., either not producing harnessable energy or producing energy at lower-than-nominal levels). As such, the systems described herein may be connected to, e.g., solar panels or wind turbines, in order to store the renewable energy generated by such systems.

In an aspect, embodiments of the invention feature a method for storing energy in and/or recovering energy with an energy-storage system comprising (i) a cylinder assembly having a valve for controlling fluid flow into and out of the cylinder assembly through a gated port, the valve comprising a valve member for occluding the gated port, and (ii) an actuation system for actuating the valve, the actuation system comprising (a) an actuation cylinder and (b) a piston disposed within and dividing the actuation cylinder into first and second chambers. Within the cylinder assembly, gas is compressed to store energy and/or gas is expanded to recover energy. Prior to, during, and/or after the compression and/or expansion, fluid is admitted into and/or fluid is exhausted from the cylinder assembly at least in part by actuating the valve from a closed state to an open state by admitting fluid into the first chamber of the actuation cylinder to increase fluid pressure therein, thereby moving the piston toward the second chamber. During the actuation, fluid exits the second chamber of the actuation cylinder at a first rate to maximize speed of the piston motion, and thereafter, fluid exits the second chamber at a second rate slower than the first rate to decelerate the piston before the piston reaches an end surface of the actuation cylinder.

Embodiments of the invention may include one or more of the following in any of a variety of combinations. The second rate of fluid flow may decrease as the piston moves toward the end surface of the actuation cylinder. During the actuation, the piston may occlude at least a portion of an orifice in the second chamber as the piston moves toward an end surface of the actuation cylinder, thereby slowing the flow of fluid from the second chamber from the first rate to the second rate. When the piston is disposed proximate the end surface (e.g., at one limit of the piston's travel within the actuation cylinder), the orifice may be completely occluded by the piston. A lateral dimension of at least a portion of the orifice may vary as a function of distance from the end surface of the actuation cylinder. A lateral dimension of a first portion of the orifice may not vary as a function of distance from the end surface of the actuation cylinder, and a lateral dimension of a second portion of the orifice may vary as a function of distance from the end surface of the actuation cylinder. A lateral boundary of at least a portion of the orifice may have a shape defined by a function y(x)=C(Vₘₐₓ²−2Ax)^{1/2}, where C is a constant, Vₘₐₓ is a velocity of the piston in the actuation cylinder when the orifice is not occluded, and A is a magnitude of deceleration of the piston in the actuation cylinder when the orifice is partially occluded. Fluid may be admitted into the first chamber through both (i) an occludable orifice configured to be at least partially occluded by the piston during movement of the piston within the actuation cylinder, and (ii) a fixed orifice configured to not be occluded by the piston during movement of the piston within the actuation cylinder. During at least a portion of the actuation, fluid may exit the second chamber through both (i) an occludable orifice configured to be at least partially occluded by the piston during movement of the piston within the actuation cylinder, and (ii) a fixed orifice configured to not be occluded by the piston during movement of the piston within the actuation cylinder.

In another aspect, embodiments of the invention feature a method for at least one of storing energy in or recovering energy with an energy-storage system comprising (i) a cylinder assembly having a valve for controlling fluid flow into and out of the cylinder assembly through a gated port, the valve comprising a valve member for occluding the gated port, and (ii) an actuation system for actuating the valve, the actuation system comprising (a) an actuation cylinder, (b) a piston disposed within and dividing the actuation cylinder into first and second chambers, and (c) an occludable orifice configured to be at least partially occluded by the piston during movement of the piston within the actuation cylinder. Within the cylinder assembly, gas is compressed to store energy and/or gas is expanded to recover energy. Prior to, during, and/or after the compression and/or expansion, fluid is admitted into and/or fluid is exhausted from the cylinder assembly at least in part by actuating the valve from a closed state to an open state by admitting fluid into the first chamber of the actuation cylinder to increase fluid pressure therein, thereby moving the piston toward the second chamber. During the actuation, (i) fluid flows out of the second chamber through the occludable orifice unoccluded by the piston, thereby maximizing speed of the piston motion, and (ii) thereafter, the piston occludes at least a portion of the occludable orifice, whereby fluid flow from the second chamber is decreased to decelerate the piston before the piston reaches an end surface of the actuation cylinder.

Embodiments of the invention may include one or more of the following in any of a variety of combinations. The occludable orifice may be completely occluded by the piston by the end of the actuation (e.g., at one limit of the piston's travel within the actuation cylinder). A lateral dimension of at least a portion of the occludable orifice may vary as a function of distance from an end surface of the actuation cylinder. A lateral dimension of a first portion of the occludable orifice may not vary as a function of distance from an end surface of the actuation cylinder, and a lateral dimension of a second portion of the occludable orifice may vary as a function of distance from the end surface of the actuation cylinder. A lateral boundary of at least a portion of the occludable orifice may have a shape defined by a function y(x)=C(Vₘₐₓ²−2Ax)^{1/2}, where C is a constant, Vₘₐₓ is a velocity of the piston in the actuation cylinder when the occludable orifice is not occluded, and A is a magnitude of deceleration of the piston in the actuation cylinder when the occludable orifice is partially occluded. Fluid may be admitted into the first chamber through both (i) a second occludable orifice configured to be at least partially occluded by the piston during movement of the piston within the actuation cylinder, and (ii) a fixed orifice configured to not be occluded by the piston during movement of the piston within the actuation cylinder. During at least a portion of the actuation, fluid may exit the second chamber through both (i) the occludable orifice, and (ii) a fixed orifice configured to not be occluded by the piston during movement of the piston within the actuation cylinder.

In yet another aspect, embodiments of the invention feature an energy storage and recovery system that includes or consists essentially of a cylinder assembly (i) for, therewithin, compression of gas to store energy and/or expansion of gas to recover energy and (ii) having an interior compartment, a valve for admitting fluid into the interior compartment and/or exhausting fluid from the interior compartment through a gated port, and an actuation mechanism for actuating the valve. The valve includes a valve member for occluding the gated port. The actuation mechanism includes or consists essentially of (i) an actuation cylinder having a lateral surface and two opposing end surfaces, (ii) a piston disposed within and dividing the actuation cylinder into two chambers, the valve being configured for actuation by a difference in fluid pressure between the two chambers, and (iii) an occludable orifice defined by the lateral surface and configured to be at least partially occluded by the piston during movement of the piston within the actuation cylinder.

Embodiments of the invention may include one or more of the following in any of a variety of combinations. The occludable orifice may be configured to be completely occluded by the piston when the piston is disposed proximate the end surface defining the fixed orifice (e.g., at one limit of the piston's travel within the actuation cylinder). A portion of the occludable orifice may be configured to not be occluded by the piston when the piston is disposed proximate an end surface of the actuation cylinder (e.g., at one limit of the piston's travel within the actuation cylinder). A lateral dimension of at least a portion of the occludable orifice may vary as a function of distance from one of the end surfaces of the actuation cylinder. A lateral dimension of a first portion of the occludable orifice may not vary as a function of distance from one of the end surfaces of the actuation cylinder, and a lateral dimension of a second portion of the occludable orifice may vary as a function of distance from one of the end surfaces of the actuation cylinder. A lateral boundary of at least a portion of the occludable orifice may have a shape defined by a function y(x)=C(Vₘₐₓ²−2Ax)^{1/2}, where C is a constant, Vₘₐₓ is a velocity of the piston in the actuation cylinder when the occludable orifice is not occluded, and A is a magnitude of deceleration of the piston in the actuation cylinder when the occludable orifice is partially occluded. The actuation mechanism may include a fixed orifice defined by one of the end surfaces of the actuation cylinder. The system may include a high-pressure fluid source selectively connectable to both the occludable orifice and the fixed orifice. The system may include, disposed within a connection between the high-pressure fluid source and the fixed orifice, a check valve configured to enable substantially unrestricted flow of fluid to the fixed orifice when the occludable orifice is at least partially occluded by the piston. The system may include a low-pressure fluid reservoir selectively connectable to both the occludable orifice and the fixed orifice. A valve may connect the occludable orifice and the fixed orifice to (i) the high-pressure fluid source, (ii) the low-pressure fluid reservoir, or (iii) a chamber of the actuation cylinder opposite a chamber of the actuation cylinder in which the occludable orifice and fixed orifice are defined. A stem may be mechanically connected to the valve member and the piston. The occludable orifice and fixed orifice may be defined in one of the chambers of the actuation cylinder, and in the other chamber of the actuation cylinder, an end surface may define a second fixed orifice, and the lateral surface of the actuation cylinder may define a second occludable orifice configured to be at least partially occluded by the piston during movement of the piston within the actuation cylinder.

The cylinder assembly may be configured to compress gas from an initial pressure to a final pressure, and the system may include a control system. The control system may be configured to (i) pre-expand gas in the cylinder assembly to approximately the initial pressure, (ii) following the pre-expansion, admit gas at the initial pressure into the cylinder assembly, the pre-expansion reducing coupling loss during the admission of gas, (iii) compress the gas in the cylinder assembly to the final pressure, (iv) complete a compression cycle by exhausting only a portion of the compressed gas out of the cylinder assembly, and (v) repeat the foregoing steps at least once, thereby performing at least one additional compression cycle. The gas admission and/or the gas exhaustion may occur through the gated port of the valve.

The cylinder assembly may be configured to expand gas from an initial pressure to a final pressure, and the system may include a control system. The control system may be configured to (i) pre-compress gas in the cylinder assembly to approximately the initial pressure, (ii) following the pre-compression, admit compressed gas at the initial pressure into the cylinder assembly, the pre-compression reducing coupling loss during the admission of compressed gas, (iii) expand the gas in the cylinder assembly to the final pressure, (iv) complete an expansion cycle by exhausting only a portion of the expanded gas out of the cylinder assembly, and (v) repeat the foregoing steps at least once, thereby performing at least one additional expansion cycle. The gas admission and/or the gas exhaustion may occur through the gated port of the valve.

The system may include a high-side component, selectively fluidly connected to the cylinder assembly, for (i) supplying gas to the cylinder assembly for expansion therein and/or (ii) accepting gas from the cylinder assembly after compression therein, a low-side component, selectively fluidly connected to the cylinder assembly, for (i) supplying gas to the cylinder assembly for compression therein and/or (ii) accepting gas from the cylinder assembly after expansion therein, and a control system for operating the cylinder assembly to perform (i) a pre-compression of gas therewithin prior to admission therein of gas for expansion, thereby reducing coupling loss between the cylinder assembly and the high-side component, and/or (ii) a pre-expansion of gas therewithin prior to admission therein of gas for compression, thereby reducing coupling loss between the cylinder assembly and the low-side component. The system may include a sensor for sensing a temperature, a pressure, and/or a position of a boundary mechanism within the cylinder assembly to generate control information. The control system may be responsive to the control information. The control system may be configured to operate the cylinder assembly, during (i) pre-compression of gas therewithin and/or (ii) expansion of gas therewithin, based at least in part on control information generated during (i) a previous gas expansion within the cylinder assembly and/or (ii) a previous pre-compression of gas within the cylinder assembly. The control system may be configured to operate the cylinder assembly, during (i) pre-expansion of gas therewithin and/or (ii) compression of gas therewithin, based at least in part on control information generated during (i) a previous gas compression within the cylinder assembly and/or (ii) a previous pre-expansion of gas within the cylinder assembly. The high-side component may include or consist essentially of a compressed-gas storage reservoir or a second cylinder assembly for at least one of compressing gas or expanding gas within a pressure range higher than a pressure range of operation of the cylinder assembly. The system may include a second cylinder assembly for compressing gas and/or expanding gas within a pressure range higher than a pressure range of operation of the cylinder assembly, and the high-side component may include or consist essentially of a mid-pressure vessel for containing gas at a pressure within both of or between pressure ranges of operation of the cylinder assembly and the second cylinder assembly. The low-side component may include or consist essentially of a vent to atmosphere or a second cylinder assembly for compressing gas and/or expanding gas within a pressure range lower than a pressure range of operation of the cylinder assembly. The system may include a second cylinder assembly for compressing gas and/or expanding gas within a pressure range lower than a pressure range of operation of the cylinder assembly, and the low-side component may include or consist essentially of a mid-pressure vessel for containing gas at a pressure within both of or between pressure ranges of operation of the cylinder assembly and the second cylinder assembly.

In a further aspect, embodiments of the invention feature an energy storage and recovery system including or consisting essentially of a cylinder assembly (i) for, therewithin, at least one of compression of gas to store energy or expansion of gas to recover energy and (ii) having an interior compartment, a valve for admitting fluid into the interior compartment and/or exhausting fluid from the interior compartment through a gated port, and an actuation mechanism for actuating the valve. The valve includes a valve member for occluding the gated port. The actuation mechanism includes or consists essentially of (i) an actuation cylinder having a lateral surface and first and second opposing end surfaces, (ii) a piston disposed within and dividing the actuation cylinder into first and second chambers, a difference in fluid pressure between the two chambers actuating the valve, (iii) within the first chamber, a first occludable orifice defined by the lateral surface and configured to be at least partially occluded by the piston during movement of the piston within the actuation cylinder, (iv) within the first chamber, a first fixed orifice configured to not be occluded by the piston during movement of the piston within the actuation cylinder, (v) within the second chamber, a second occludable orifice defined by the lateral surface and configured to be at least partially occluded by the piston during movement of the piston within the actuation cylinder, and (vi) within the second chamber, a second fixed orifice configured to not be occluded by the piston during movement of the piston within the actuation cylinder.

Embodiments of the invention may include one or more of the following in any of a variety of combinations. The first fixed orifice may be defined by the first end surface of the actuation cylinder and/or the second fixed orifice may be defined by the second end surface of the actuation cylinder. The first occludable orifice may be configured to be completely occluded by the piston when the piston is disposed proximate the first end surface. The second occludable orifice may be configured to be completely occluded by the piston when the piston is disposed proximate the second end surface. A lateral dimension of at least a portion of the first occludable orifice may vary as a function of distance from the first end surface. A lateral dimension of a first portion of the first occludable orifice may not vary as a function of distance from the first end surface, and a lateral dimension of a second portion of the first occludable orifice may vary as a function of distance from the first end surface. A lateral boundary of at least a portion of the first occludable orifice may have a shape defined by a function y(x)=C(Vₘₐₓ²−2Ax)^{1/2}, where C is a constant, Vₘₐₓ is a velocity of the piston in the actuation cylinder when the first occludable orifice is not occluded, and A is a magnitude of deceleration of the piston in the actuation cylinder when the first occludable orifice is partially occluded. The system may include a high-pressure fluid source selectively connectable to (i) both the first occludable orifice and the first fixed orifice or (ii) both the second occludable orifice and the second fixed orifice. The system may include, disposed within a connection between the high-pressure fluid source and the first fixed orifice, a first check valve configured to enable substantially unrestricted flow of fluid to the first fixed orifice when the first occludable orifice is at least partially occluded by the piston. The system may include, disposed within a connection between the high-pressure fluid source and the second fixed orifice, a second check valve configured to enable substantially unrestricted flow of fluid to the second fixed orifice when the second occludable orifice is at least partially occluded by the piston. The system may include a low-pressure fluid reservoir selectively connectable to (i) both the first occludable orifice and the first fixed orifice or (ii) both the second occludable orifice and the second fixed orifice. The system may include a valve having different settings for connecting (i) the first occludable orifice and the first fixed orifice to the high-pressure fluid source, and the second occludable orifice and the second fixed orifice to the low-pressure fluid reservoir, (ii) the first occludable orifice and the first fixed orifice to the low-pressure fluid reservoir, and the second occludable orifice and the second fixed orifice to the high-pressure fluid source, or (iii) the first occludable orifice and the first fixed orifice to the second occludable orifice and the second fixed orifice. A stem may be mechanically connected to the valve member and the piston.

The cylinder assembly may be configured to compress gas from an initial pressure to a final pressure, and the system may include a control system. The control system may be configured to (i) pre-expand gas in the cylinder assembly to approximately the initial pressure, (ii) following the pre-expansion, admit gas at the initial pressure into the cylinder assembly, the pre-expansion reducing coupling loss during the admission of gas, (iii) compress the gas in the cylinder assembly to the final pressure, (iv) complete a compression cycle by exhausting only a portion of the compressed gas out of the cylinder assembly, and (v) repeat the foregoing steps at least once, thereby performing at least one additional compression cycle. The gas admission and/or the gas exhaustion may occur through the gated port of the valve.

The cylinder assembly may be configured to expand gas from an initial pressure to a final pressure, and the system may include a control system. The control system may be configured to (i) pre-compress gas in the cylinder assembly to approximately the initial pressure, (ii) following the pre-compression, admit compressed gas at the initial pressure into the cylinder assembly, the pre-compression reducing coupling loss during the admission of compressed gas, (iii) expand the gas in the cylinder assembly to the final pressure, (iv) complete an expansion cycle by exhausting only a portion of the expanded gas out of the cylinder assembly, and (v) repeat the foregoing steps at least once, thereby performing at least one additional expansion cycle. The gas admission and/or the gas exhaustion may occur through the gated port of the valve.

The system may include a high-side component, selectively fluidly connected to the cylinder assembly, for (i) supplying gas to the cylinder assembly for expansion therein and/or (ii) accepting gas from the cylinder assembly after compression therein, a low-side component, selectively fluidly connected to the cylinder assembly, for (i) supplying gas to the cylinder assembly for compression therein and/or (ii) accepting gas from the cylinder assembly after expansion therein, and a control system for operating the cylinder assembly to perform (i) a pre-compression of gas therewithin prior to admission therein of gas for expansion, thereby reducing coupling loss between the cylinder assembly and the high-side component, and/or (ii) a pre-expansion of gas therewithin prior to admission therein of gas for compression, thereby reducing coupling loss between the cylinder assembly and the low-side component. The system may include a sensor for sensing a temperature, a pressure, and/or a position of a boundary mechanism within the cylinder assembly to generate control information. The control system may be responsive to the control information. The control system may be configured to operate the cylinder assembly, during (i) pre-compression of gas therewithin and/or (ii) expansion of gas therewithin, based at least in part on control information generated during (i) a previous gas expansion within the cylinder assembly and/or (ii) a previous pre-compression of gas within the cylinder assembly. The control system may be configured to operate the cylinder assembly, during (i) pre-expansion of gas therewithin and/or (ii) compression of gas therewithin, based at least in part on control information generated during (i) a previous gas compression within the cylinder assembly and/or (ii) a previous pre-expansion of gas within the cylinder assembly. The high-side component may include or consist essentially of a compressed-gas storage reservoir or a second cylinder assembly for at least one of compressing gas or expanding gas within a pressure range higher than a pressure range of operation of the cylinder assembly. The system may include a second cylinder assembly for compressing gas and/or expanding gas within a pressure range higher than a pressure range of operation of the cylinder assembly, and the high-side component may include or consist essentially of a mid-pressure vessel for containing gas at a pressure within both of or between pressure ranges of operation of the cylinder assembly and the second cylinder assembly. The low-side component may include or consist essentially of a vent to atmosphere or a second cylinder assembly for compressing gas and/or expanding gas within a pressure range lower than a pressure range of operation of the cylinder assembly. The system may include a second cylinder assembly for compressing gas and/or expanding gas within a pressure range lower than a pressure range of operation of the cylinder assembly, and the low-side component may include or consist essentially of a mid-pressure vessel for containing gas at a pressure within both of or between pressure ranges of operation of the cylinder assembly and the second cylinder assembly.

In one aspect, embodiments of the invention feature a method for storing energy in and/or recovering energy with an energy-storage system comprising a cylinder assembly having a valve for controlling fluid flow into and out of the cylinder assembly through a gated port. The valve includes a valve member for occluding the gated port and having a width W greater than or substantially equal to a width of the gated port. Within the cylinder assembly, gas is compressed to store energy and/or gas is expanded to recover energy. Prior to, during, and/or after the compression and/or expansion, fluid is admitted into and/or fluid is exhausted from the cylinder assembly at least in part by actuating the valve from a closed state to an open state. The actuation includes or consists essentially of (A) accelerating the valve member from a closed position such that the valve member attains a maximum velocity at a distance away from the gated port less than or substantially equal to a substantially-open position, wherein (i) a curtain area available for flow through the gated port at the substantially-open position is approximately equal to an area of the gated port, and (ii) the valve member continues to move past the substantially-open position to a full-open position farther away from the gated port than the substantially-open position, and/or (B) moving the valve member to the substantially-open position and, thereafter, (i) moving the valve member to the full-open position, and (ii) during at least a portion of the movement of the valve member from the substantially-open position to the full-open position, decelerating the valve member such that a velocity of the valve member is approximately zero when the valve member reaches the full-open position.

Embodiments of the invention may include one or more of the following in any of a variety of combinations. The surface of the valve member facing the gated port may be circular with a diameter equal to W. In the substantially-open position, the valve member may be a distance W/4 away from the gated port. Accelerating the valve member from the closed position may include recovering at least a portion of energy stored during a prior closure of the valve. When the valve member is decelerated, at least a portion of the kinetic energy of the valve member may be stored during the deceleration. The energy may be stored as potential energy (e.g., spring potential energy and/or hydraulic-pressure potential energy). Accelerating the valve member from the closed position may include moving the valve member a finite distance from a fully-closed position to a sufficiently-closed position at which the valve member remains in contact with at least a portion of a seat disposed at the gated port. At least a portion of the seat may move in concert with the valve member as the valve member moves from the fully-closed position to the sufficiently-closed position. For a particular differential pressure, flow through the gated port when the valve member is in the sufficiently-closed position may be less than 1% of flow through the gated port when the valve member is in the sufficiently-open position.

In another aspect, embodiments of the invention feature a method for storing energy in and/or recovering energy with an energy-storage system comprising a cylinder assembly having a valve for controlling fluid flow into and out of the cylinder assembly through a gated port. The valve includes a valve member for occluding the gated port and having a width W greater than or substantially equal to a width of the gated port. Within the cylinder assembly, gas is compressed to store energy and/or gas is expanded to recover energy. Prior to, during, and/or after the compression and/or expansion, the gated port is occluded by actuating the valve from an open state to a closed state. The actuation includes or consists essentially of (A) accelerating the valve member from a full-open position such that the valve member attains a maximum velocity at a distance away from the gated port less than or substantially equal to a substantially-open position, wherein (i) a curtain area available for flow through the gated port at the substantially-open position is approximately equal to an area of the gated port, and (ii) the valve member continues to move past the substantially-open position to a substantially-closed position at which the valve member contacts at least a portion of a seat disposed at the gated port, and/or (B) moving the valve member to the substantially-closed position and, thereafter, (i) moving the valve member to a fully-closed position beyond the substantially-closed position, and (ii) during at least a portion of the movement of the valve member from the substantially-closed position and the fully-closed position, decelerating the valve member to a velocity of approximately zero when the valve member reaches the fully-closed position, the valve member remaining in contact with the at least a portion of the seat in the substantially-closed position.

Embodiments of the invention may include one or more of the following in any of a variety of combinations. The surface of the valve member facing the gated port may be circular with a diameter equal to W. In the substantially-open position, the valve member may be a distance W/4 away from the gated port. Accelerating the valve member from the full-open position may include recovering at least a portion of energy stored during a prior opening of the valve. When the valve member is decelerated, at least a portion of the kinetic energy of the valve member may be stored during the deceleration. The energy may be stored as potential energy (e.g., spring potential energy and/or hydraulic-pressure potential energy). The at least a portion of the seat may move in concert with the valve member as the valve member moves from the sufficiently-closed position to the fully-closed position. For a particular differential pressure, flow through the gated port when the valve member is in the sufficiently-closed position may be less than 1% of flow through the gated port when the valve member is in the sufficiently-open position. After the valve member reaches the fully-closed position, the valve member may be restored from the fully-closed position to the sufficiently-closed position while maintaining contact between the valve member and the at least a portion of the seat.

In yet another aspect, embodiments of the invention feature an energy storage and recovery system including or consisting essentially of a cylinder assembly (i) for, therewithin, at least one of compression of gas to store energy or expansion of gas to recover energy and (ii) having an interior compartment, a valve, and an actuation mechanism for actuating the valve. The valve admits fluid into the interior compartment and/or exhausts fluid from the interior compartment through a gated port, and the valve includes a valve member for occluding the gated port and having a width W greater than or substantially equal to a width of the gated port. The gated port includes a seat having a contact portion and, connected thereto, a shock-absorbing mechanism for (i) accelerating the valve member away from the seat, (ii) decelerating the valve member upon contact with the contact portion, and/or (iii) storing kinetic energy of the valve member as potential energy.

Embodiments of the invention may include one or more of the following in any of a variety of combinations. The shock-absorbing mechanism may include or consist essentially of a wave spring, a coil spring, an air spring, and/or an elastic material (e.g., an elastomer). The profile of the contact portion may be complementary to the profile of the valve member such that, upon contact between the valve member and the contact ring, the gated port is substantially occluded. The contact portion may be beveled. The contact portion may include or consist essentially of polyether ether ketone. The gated port may be disposed within an end cap of the cylinder assembly. The actuation mechanism may be hydraulic, electrical, mechanical, and/or magnetic. The contact portion may be movable to induce or relieve pressure on the shock-absorbing material. A gasket may be disposed around the contact portion and may prevent fluid flow between the contact portion and the interior compartment of the cylinder assembly at least when the gated port is occluded by the valve member. The contact portion may include or consist essentially of an annular contact ring. The valve may be a high-side valve or a low-side valve. The valve member may be shaped as a truncated cone.

The actuation mechanism may include or consist essentially of a hydraulic cylinder containing a piston dividing an interior of the hydraulic cylinder into two chambers, a stem mechanically linking the valve member and the piston, a circulation mechanism for supplying fluid to at least one of the chambers, and a control mechanism for controlling fluid flow to, from, and between the two chambers. The difference in fluid pressure between the two chambers exerts pressure on the piston to actuate the valve. The actuation mechanism may include, selectively fluidly connected to each of the two chambers and to the circulation mechanism, a high-pressure accumulator for storing fluid at a pressure approximately equal to or greater than a pressure supplied by the circulation mechanism. The control mechanism may be configured to admit, during actuation of the valve, fluid from both the circulation mechanism and the high-pressure accumulator into one of the two chambers. The actuation mechanism may include, selectively fluidly connected to each of the two chambers and to the circulation mechanism, a low-pressure accumulator for storing fluid at a pressure approximately equal to or less than a pressure supplied by the circulation mechanism. A fluid reservoir, different from the low-pressure accumulator, may be fluidly connected to the circulation mechanism. The control mechanism may be configured to admit, during actuation of the valve, fluid from one of the two chambers to both the low-pressure accumulator and the fluid reservoir. The system may include a connection between the low-pressure accumulator and the fluid reservoir. The connection may include a pressure-relief valve configured to allow fluid flow from the low-pressure accumulator to the fluid reservoir when a pressure of the low-pressure accumulator exceeds a threshold pressure. The control mechanism may include or consist essentially of a three-way directional control valve having different settings that (i) fluidly connect the circulation mechanism with a first one of the two chambers, (ii) fluidly connect the circulation mechanism with a second one of the two chambers different from the first one, and (iii) fluidly connect the two chambers together. The system may include a control system configured to, in order to actuate the valve, (i) set the three-way directional control valve to one of the settings fluidly connecting the circulation mechanism with either the first or second chamber, thereby causing the piston in the hydraulic cylinder to move along a stroke length defined by a length of the hydraulic cylinder, and (ii) before the piston in the hydraulic cylinder moves along an entirety of the stroke length, set the three-way directional control valve to the setting fluidly connecting the first and second chambers together.

In a further aspect, embodiments of the invention feature an energy storage and recovery system including or consisting essentially of a cylinder assembly (i) for, therewithin, at least one of compression of gas to store energy or expansion of gas to recover energy and (ii) having an interior compartment, a valve, and a hydraulic actuation mechanism for actuating the valve. The valve admits fluid into the interior compartment and/or exhausts fluid from the interior compartment through a gated port, and includes a valve member for occluding the gated port and having a width W greater than or substantially equal to a width of the gated port. The hydraulic actuation mechanism includes a control mechanism for controlling fluid flow to, from, and between two chambers of a hydraulic cylinder, where the difference in fluid pressure between the two chambers actuates the valve.

Embodiments of the invention may include one or more of the following in any of a variety of combinations. The hydraulic cylinder may contain a piston dividing the interior of the hydraulic cylinder into two chambers. The actuation mechanism may include (i) a stem mechanically linking the valve member and the piston, and (ii) a circulation mechanism for supplying fluid to at least one of the chambers of the hydraulic cylinder. The actuation mechanism may include, selectively fluidly connected to each of the two chambers and to the circulation mechanism, a high-pressure accumulator for storing fluid at a pressure approximately equal to or greater than a pressure supplied by the circulation mechanism. The control mechanism may be configured to admit, during actuation of the valve, fluid from both the circulation mechanism and the high-pressure accumulator into one of the two chambers. The actuation mechanism may include, selectively fluidly connected to each of the two chambers and to the circulation mechanism, a low-pressure accumulator for storing fluid at a pressure approximately equal to or less than a pressure supplied by the circulation mechanism. The system may include a fluid reservoir, different from the low-pressure accumulator, fluidly connected to the circulation mechanism. The control mechanism may be configured to admit, during actuation of the valve, fluid from one of the two chambers to both the low-pressure accumulator and the fluid reservoir. The system may include a connection between the low-pressure accumulator and the fluid reservoir. The connection may include a pressure-relief valve configured to allow fluid flow from the low-pressure accumulator to the fluid reservoir when a pressure of the low-pressure accumulator exceeds a threshold pressure. The control mechanism may include or consist essentially of a three-way directional control valve having settings (i) fluidly connecting the circulation mechanism with a first one of the two chambers, (ii) fluidly connecting the circulation mechanism with a second one of the two chambers different from the first one, or (iii) fluidly connecting the two chambers together. The system may include a control system configured to, in order to actuate the valve, (i) set the three-way directional control valve to one of the settings fluidly connecting the circulation mechanism with either the first or second chamber, thereby causing the piston in the hydraulic cylinder to move along a stroke length defined by a length of the hydraulic cylinder, and (ii) before the piston in the hydraulic cylinder moves along an entirety of the stroke length, set the three-way directional control valve to the setting fluidly connecting the first and second chambers together.

In an aspect, embodiments of the invention feature an energy storage and recovery system including or consisting essentially of a cylinder assembly (i) for, therewithin, at least one of compression of gas to store energy or expansion of gas to recover energy and (ii) having an interior compartment, a valve for admitting fluid into the interior compartment and/or exhausting fluid from the interior compartment, and an actuation mechanism for actuating the valve with a magnetic actuation force (i.e., magnetically).

Embodiments of the invention may include one or more of the following in any of a variety of combinations. The valve may include or consist essentially of a gated port and a valve member for selectively controlling at least one of fluid flow into the interior compartment or fluid flow out of the interior compartment. The valve member may be disposed between the gated port and at least a portion of the interior compartment of the cylinder assembly. The gated port may be disposed between the valve member and the interior compartment of the cylinder assembly. The gated port may include a seat having a shape complimentary to a shape of the valve member, thereby enabling the closure of the gated port when the valve member is in contact with the seat. The valve member may include or consist essentially of a permanent magnet and/or an electromagnet. A stem may extend through the actuation mechanism and connect to the valve member. A permanent magnet and/or an electromagnet may be proximate the actuation mechanism and connected to the stem. The actuation mechanism may include or consist essentially of a permanent magnet and/or an electromagnet. The system may include a control system for controlling the magnetic actuation force in response to a position of a valve member of the valve and/or a difference between a pressure inside the interior compartment and a pressure inside the valve. The valve may be configured to check closed, thereby preventing fluid flow into or out of the interior compartment, in the absence of the magnetic actuation force. The system may include a mechanical or pneumatic spring for biasing the valve toward closing, cushioning opening forces, and/or providing at least a portion of a closing actuation force. The valve may be configured to control fluid flow between the interior compartment and (i) a compressed-gas storage reservoir or (ii) a second cylinder assembly for the expansion and/or compression of gas at a pressure range higher than that for which the cylinder assembly is configured. The valve may be configured to control fluid flow between the interior compartment and (i) a vent to atmosphere or (ii) a second cylinder assembly for the expansion and/or compression of gas at a pressure range lower than that for which the cylinder assembly is configured. The actuation mechanism and at least a portion of the valve may be integrated within an end cap of the cylinder assembly.

In another aspect, embodiments of the invention feature a method for energy storage and recovery. Within a cylinder assembly, gas is compressed to store energy and/or gas is expanded to recover energy. At least one of prior to, during, or after the compression and/or expansion, fluid is admitted into and/or fluid is exhausted from the cylinder assembly at least in part by actuating a valve with a magnetic actuation force (i.e., magnetically).

Embodiments of the invention may include one or more of the following in any of a variety of combinations. The admission and/or exhaustion of fluid may be initiated, maintained, and/or concluded by a hydraulic force resulting from a difference in pressure inside and outside of the cylinder assembly. Actuating the valve may include or consist essentially of applying the magnetic actuation force to act in concert with the hydraulic force. The hydraulic force may at least partially open the valve, and the magnetic actuation force may maintain the valve in an open position. The hydraulic force may at least partially close the valve, and the magnetic actuation force may maintain the valve in a closed position. Actuating the valve may include or consist essentially of applying the magnetic actuation force to act in opposition to the hydraulic force. The magnetic actuation force may reduce collision force between the actuation mechanism applying the magnetic actuation force and a valve member of the valve. Actuating the valve may include or consist essentially of applying a magnetic actuation force that varies over time during the actuation of the valve. The method may include, with a mechanical force, biasing the valve toward closing, cushioning opening forces, and/or providing at least a portion of a closing actuation force.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. Note that as used herein, the terms “pipe,” “piping” and the like shall refer to one or more conduits that are rated to carry gas or liquid between two points. Thus, the singular term should be taken to include a plurality of parallel conduits where appropriate. Herein, the terms “liquid” and “water” interchangeably connote any mostly or substantially incompressible liquid, the terms “gas” and “air” are used interchangeably, and the term “fluid” may refer to a liquid, a gas, or a mixture of liquid and gas (e.g., a foam) unless otherwise indicated. As used herein unless otherwise indicated, the terms “approximately” and “substantially” mean±10%, and, in some embodiments, ±5%. A “valve” is any mechanism or component for controlling fluid communication between fluid paths or reservoirs, or for selectively permitting control or venting. The term “cylinder” refers to a chamber, of uniform but not necessarily circular cross-section, which may contain a slidably disposed piston or other mechanism that separates the fluid on one side of the chamber from that on the other, preventing fluid movement from one side of the chamber to the other while allowing the transfer of force/pressure from one side of the chamber to the next or to a mechanism outside the chamber. At least one of the two ends of a chamber may be closed by end caps, also herein termed “heads.” As utilized herein, an “end cap” is not necessarily a component distinct or separable from the remaining portion of the cylinder, but may refer to an end portion of the cylinder itself. Rods, valves, and other devices may pass through the end caps. A “cylinder assembly” may be a simple cylinder or include multiple cylinders, and may or may not have additional associated components (such as mechanical linkages among the cylinders). The shaft of a cylinder may be coupled hydraulically or mechanically to a mechanical load (e.g., a hydraulic motor/pump or a crankshaft) that is in turn coupled to an electrical load (e.g., rotary or linear electric motor/generator attached to power electronics and/or directly to the grid or other loads), as described in the '678 and '842 patents. As used herein, “thermal conditioning” of a heat-exchange fluid does not include any modification of the temperature of the heat-exchange fluid resulting from interaction with gas with which the heat-exchange fluid is exchanging thermal energy; rather, such thermal conditioning generally refers to the modification of the temperature of the heat-exchange fluid by other means (e.g., an external heat exchanger). The terms “heat-exchange” and “heat-transfer” are generally utilized interchangeably herein. Unless otherwise indicated, motor/pumps described herein are not required to be configured to function both as a motor and a pump if they are utilized during system operation only as a motor or a pump but not both. Gas expansions described herein may be performed in the absence of combustion (as opposed to the operation of an internal-combustion cylinder, for example).

### BRIEF DESCRIPTION OF THE DRAWINGS

In the drawings, like reference characters generally refer to the same parts throughout the different views. Cylinders, rods, and other components are depicted in cross section in a manner that will be intelligible to all persons familiar with the art of pneumatic and hydraulic cylinders. Also, the drawings are not necessarily to scale, emphasis instead generally being placed upon illustrating the principles of the invention. In the following description, various embodiments of the present invention are described with reference to the following drawings, in which:

FIG. 1 is a schematic drawing of a compressed-gas energy storage system in accordance with various embodiments of the invention;

FIG. 2 is a schematic drawing of various components of a compressed-gas energy storage system in accordance with various embodiments of the invention;

FIG. 3 is a schematic drawing of the major components of a compressed air energy storage and recovery system in accordance with various embodiments of the invention;

FIG. 4 is a schematic drawing of various components of a multi-cylinder compressed-gas energy storage system in accordance with various embodiments of the invention;

FIG. 5 is a schematic drawing of a cylinder assembly with apparatus for the generation of foam external to the cylinder in accordance with various embodiments of the invention;

FIG. 6 is a schematic drawing of a cylinder assembly with apparatus for the generation of foam external to the cylinder and provision for bypassing the foam-generating apparatus in accordance with various embodiments of the invention;

FIG. 7 is a schematic drawing of a cylinder assembly with apparatus for the generation of foam in a vessel external to the cylinder in accordance with various embodiments of the invention;

FIG. 8 is a schematic drawing of a cylinder assembly with apparatus for the generation of foam internal to the cylinder in accordance with various embodiments of the invention;

FIG. 9 is a schematic drawing of a compressed-air energy storage system employing multiple pairs of high- and low-pressure cylinders in accordance with various embodiments of the invention;

FIG. 10 is an illustrative plot of pressure as a function of time for four different expansion scenarios in accordance with various embodiments of the invention;

FIG. 11 is a graphical display of experimental test data in accordance with various embodiments of the invention;

FIG. 12 is an illustrative plot of the ideal pressure-volume cycle in a cylinder operated as either a compressor or expander;

FIG. 13 is an illustrative plot of cylinder chamber pressure as a function of cylinder chamber volume for three different expansion scenarios in an illustrative CAES system in accordance with various embodiments of the invention;

FIGS. 14A-14C are illustrative plots of cylinder chamber pressure as a function of cylinder chamber volume for different expansion scenarios in an illustrative CAES system in accordance with various embodiments of the invention;

FIG. 15 is an illustrative plot of cylinder chamber pressure as a function of cylinder chamber volume for three different compression scenarios in an illustrative CAES system in accordance with various embodiments of the invention;

FIG. 16 is an illustrative plot of cylinder chamber pressure as a function of cylinder chamber volume for three different compression scenarios in an illustrative CAES system in accordance with various embodiments of the invention;

FIG. 17A is a schematic drawing of the major components of a low-side poppet valve in accordance with various embodiments of the invention;

FIG. 17B is a schematic drawing of the valve of FIG. 17A in a different state of operation;

FIG. 18A is a schematic drawing of the major components of a high-side poppet valve in accordance with various embodiments of the invention;

FIG. 18B is a schematic drawing of the valve of FIG. 18A in a different state of operation;

FIG. 19A is a schematic drawing of a cylinder assembly with a high-side valve and a low-side valve integrated into the head of the cylinder in accordance with various embodiments of the invention;

FIG. 19B is a schematic drawing of the assembly of FIG. 19A in a different state of operation;

FIG. 20 is a schematic drawing of various components of a hydraulic activation cylinder and a poppet valve in accordance with various embodiments of the invention;

FIG. 21 is a schematic drawing of a system incorporating a high-side valve having a member that is decelerated during closure by a time-varying hydraulic resistance in accordance with various embodiments of the invention;

FIG. 22 is a schematic drawing of a system incorporating a low-side valve having a member that is decelerated during closure by a time-varying hydraulic resistance in accordance with various embodiments of the invention;

FIG. 23A is a schematic drawing of an activation cylinder with contrivances for governing fluid flow into and out of the cylinder in accordance with various embodiments of the invention;

FIGS. 23B-23D are schematic drawings of the system of FIG. 23A in different states of operation;

FIG. 24A is a schematic drawing of various components of an activation cylinder having both a fixed orifice and occludable orifices in accordance with various embodiments of the invention;

FIGS. 24B-24E are schematic drawings of the system of FIG. 24A in different states of operation;

FIG. 24F is a schematic drawing of various components of an activation cylinder having an occludable orifice in accordance with various embodiments of the invention;

FIG. 25 is a cross-section of an occludable orifice in accordance with various embodiments of the invention;

FIG. 26A is a schematic drawing of a system incorporating a high-side valve and an activation cylinder with occludable orifices in accordance with various embodiments of the invention;

FIG. 26B is an expanded view of the activation cylinder of FIG. 26A;

FIG. 27 is a plot of the position of the spool of a hydraulic actuation cylinder in accordance with various embodiments of the invention;

FIG. 28 is a plot of the velocity of the spool of a hydraulic actuation cylinder in accordance with various embodiments of the invention;

FIG. 29 is a plot of the fluid pressure within one chamber of a hydraulic actuation cylinder in accordance with various embodiments of the invention;

FIG. 30A is a schematic drawing of the major components of a high-side poppet valve in accordance with various embodiments of the invention;

FIG. 30B is a depiction of an illustrative wave spring, such as might be employed in the valve of FIG. 30A;

FIGS. 30C and 30D are schematic drawings of the valve of FIG. 30A in different states of operation;

FIG. 31A is an illustrative diagram of the position over time of the disc of a conventional valve;

FIG. 31B is an illustrative diagram of the position over time of the disc of the valve of FIG. 30A, in accordance with embodiments of the invention;

FIGS. 32A-32C are schematic drawings of the valve of FIG. 30A in different states of operation;

FIG. 33A is a schematic drawing of the major components of the actuation mechanism of a high-side poppet valve in accordance with various embodiments of the invention;

FIGS. 33B and 33C are schematic drawings of the mechanism of FIG. 33A in different states of operation;

FIG. 34A is a schematic drawing of an electromagnetic valve in accordance with various embodiments of the invention;

FIG. 34B is a schematic drawing of the valve of FIG. 34A in a different state of operation;

FIG. 35A is a schematic drawing of an electromagnetic valve in accordance with various embodiments of the invention; and

FIG. 35B is a schematic drawing of the valve of FIG. 35A in a different state of operation.

### DETAILED DESCRIPTION

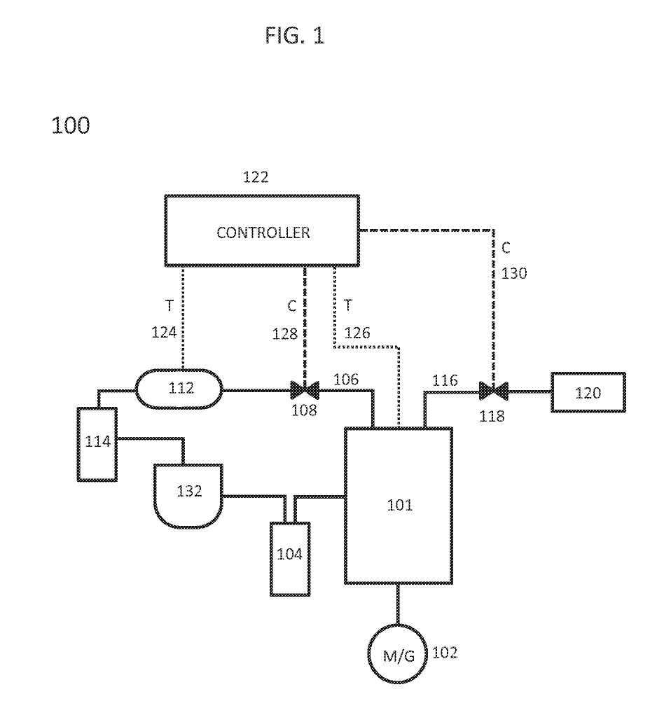

FIG. 1 depicts an illustrative system 100 that may be part of a larger system, not otherwise depicted, for the storage and release of energy. Subsequent figures will clarify the application of embodiments of the invention to such a system. The system 100 depicted in FIG. 1 features an assembly 101 for compressing and expanding gas. Expansion/compression assembly 101 may include or consist essentially of either one or more individual devices for expanding or compressing gas (e.g., turbines or cylinder assemblies that each may house a movable boundary mechanism) or a staged series of such devices, as well as ancillary devices (e.g., valves) not depicted explicitly in FIG. 1.

An electric motor/generator 102 (e.g., a rotary or linear electric machine) is in physical communication (e.g., via hydraulic pump, piston shaft, or mechanical crankshaft) with the expansion/compression assembly 101. The motor/generator 102 may be electrically connected to a source and/or sink of electric energy not explicitly depicted in FIG. 1 (e.g., an electrical distribution grid or a source of renewable energy such as one or more wind turbines or solar cells).

The expansion/compression assembly 101 may be in fluid communication with a heat-transfer subsystem 104 that alters the temperature and/or pressure of a fluid (i.e., gas, liquid, or gas-liquid mixture such as a foam) extracted from expansion/compression assembly 101 and, after alteration of the fluid's temperature and/or pressure, returns at least a portion of it to expansion/compression assembly 101. Heat-transfer subsystem 104 may include pumps, valves, and other devices (not depicted explicitly in FIG. 1) ancillary to its heat-transfer function and to the transfer of fluid to and from expansion/compression assembly 101. Operated appropriately, the heat-transfer subsystem 104 enables substantially isothermal compression and/or expansion of gas inside expansion/compression assembly 101.

Connected to the expansion/compression assembly 101 is a pipe 106 with a control valve 108 that controls a flow of fluid (e.g., gas) between assembly 101 and a storage reservoir 112 (e.g., one or more pressure vessels, pipes, and/or caverns). The storage reservoir 112 may be in fluid communication with a heat-transfer subsystem 114 that alters the temperature and/or pressure of fluid removed from storage reservoir 112 and, after alteration of the fluid's temperature and/or pressure, returns it to storage reservoir 112. A second pipe 116 with a control valve 118 may be in fluid communication with the expansion/compression assembly 101 and with a vent 120 that communicates with a body of gas at relatively low pressure (e.g., the ambient atmosphere).

A control system 122 receives information inputs from any of expansion/compression assembly 101, storage reservoir 112, and other components of system 100 and sources external to system 100. These information inputs may include or consist essentially of pressure, temperature, and/or other telemetered measurements of properties of components of system 101. Such information inputs, here generically denoted by the letter “T,” are transmitted to control system 122 either wirelessly or through wires. Such transmission is denoted in FIG. 1 by dotted lines 124, 126.

The control system 122 may selectively control valves 108 and 118 to enable substantially isothermal compression and/or expansion of a gas in assembly 101. Control signals, here generically denoted by the letter “C,” are transmitted to valves 108 and 118 either wirelessly or through wires. Such transmission is denoted in FIG. 1 by dashed lines 128, 130. The control system 122 may also control the operation of the heat-transfer assemblies 104, 114 and of other components not explicitly depicted in FIG. 1. The transmission of control and telemetry signals for these purposes is not explicitly depicted in FIG. 1.

The control system 122 may be any acceptable control device with a human-machine interface. For example, the control system 122 may include a computer (for example a PC-type) that executes a stored control application in the form of a computer-readable software medium. More generally, control system 122 may be realized as software, hardware, or some combination thereof. For example, control system 122 may be implemented on one or more computers, such as a PC having a CPU board containing one or more processors such as the Pentium, Core, Atom, or Celeron family of processors manufactured by Intel Corporation of Santa Clara, Calif., the 680x0 and POWER PC family of processors manufactured by Motorola Corporation of Schaumburg, Ill., and/or the ATHLON line of processors manufactured by Advanced Micro Devices, Inc., of Sunnyvale, Calif. The processor may also include a main memory unit for storing programs and/or data relating to the methods described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), programmable logic devices (PLD), or read-only memory devices (ROM). In some embodiments, the programs may be provided using external RAM and/or ROM such as optical disks, magnetic disks, or other storage devices.

For embodiments in which the functions of controller 122 are provided by software, the program may be written in any one of a number of high-level languages such as FORTRAN, PASCAL, JAVA, C, C++, C#, LISP, PERL, BASIC or any suitable programming language. Additionally, the software can be implemented in an assembly language and/or machine language directed to the microprocessor resident on a target device.

As described above, the control system 122 may receive telemetry from sensors monitoring various aspects of the operation of system 100, and may provide signals to control valve actuators, valves, motors, and other electromechanical/electronic devices. Control system 122 may communicate with such sensors and/or other components of system 100 (and other embodiments described herein) via wired or wireless communication. An appropriate interface may be used to convert data from sensors into a form readable by the control system 122 (such as RS-232 or network-based interconnects). Likewise, the interface converts the computer's control signals into a form usable by valves and other actuators to perform an operation. The provision of such interfaces, as well as suitable control programming, is clear to those of ordinary skill in the art and may be provided without undue experimentation.

System 100 may be operated so as to compress gas admitted through the vent 120 and store the gas thus compressed in reservoir 112. For example, in an initial state of operation, valve 108 is closed and valve 118 is open, admitting a quantity of gas into expansion/compression assembly 101. When a desired quantity of gas has been admitted into assembly 101, valve 118 may be closed. The motor/generator 102, employing energy supplied by a source not explicitly depicted in FIG. 1 (e.g., the electrical grid), then provides mechanical power to expansion/compression assembly 101, enabling the gas within assembly 101 to be compressed.

During compression of the gas within assembly 101, fluid (i.e., gas, liquid, or a gas-liquid mixture) may be circulated between assembly 101 and heat-exchange assembly 104. Heat-exchange assembly 104 may be operated in such a manner as to enable substantially isothermal compression of the gas within assembly 101. During or after compression of the gas within assembly 101, valve 108 may be opened to enable high-pressure fluid (e.g., compressed gas or a mixture of liquid and compressed gas) to flow to reservoir 112. Heat-exchange assembly 114 may be operated at any time in such a manner as alter the temperature and/or pressure of the fluid within reservoir 112.

That system 100 may also be operated so as to expand compressed gas from reservoir 112 in expansion/compression assembly 101 in such a manner as to deliver energy to the motor/generator 102 will be apparent to all persons familiar with the operation of pneumatic, hydraulic, and electric machines.

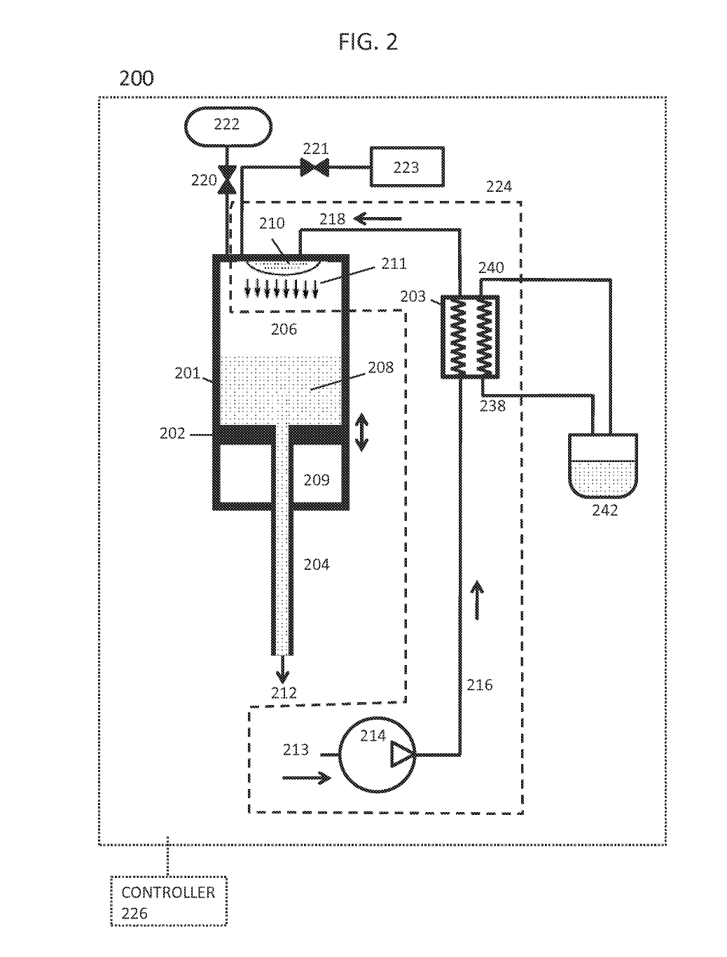

FIG. 2 depicts an illustrative system 200 that features a cylinder assembly 201 (i.e., an embodiment of assembly 101 in FIG. 1) in communication with a reservoir 222 (112 in FIG. 1) and a vent to atmosphere 223 (120 in FIG. 1). In the illustrative system 200 shown in FIG. 2, the cylinder assembly 201 contains a piston 202 slidably disposed therein. In some embodiments the piston 202 is replaced by a different boundary mechanism dividing cylinder assembly 201 into multiple chambers, or piston 202 is absent entirely, and cylinder assembly 201 is a “liquid piston.” The cylinder assembly 201 may be divided into, e.g., two pneumatic chambers or one pneumatic chamber and one hydraulic chamber. The piston 202 is connected to a rod 204, which may contain a center-drilled fluid passageway with fluid outlet 212 extending from the piston 202. The rod 204 is also attached to, e.g., a mechanical load (e.g., a crankshaft or a hydraulic system) that is not depicted. The cylinder assembly 201 is in liquid communication with a heat-transfer subsystem 224 that includes or consists essentially of a circulation pump 214 and a spray mechanism 210 to enable substantially isothermal compression/expansion of gas. Heat-transfer fluid circulated by pump 214 may be passed through a heat exchanger 203 (e.g., tube-in-shell- or parallel-plate-type heat exchanger). Spray mechanism 210 may include or consist essentially of one or more spray heads (e.g., disposed at one end of cylinder assembly 201) and/or spray rods (e.g., extending along at least a portion of the central axis of cylinder assembly 201). In other embodiments, the spray mechanism 210 is omitted and a foam, rather than a spray of droplets, is created to facilitate heat exchange between liquid and gas during compression and expansion of gas within the cylinder assembly 201, as described in the '128 application. Foam may be generated by foaming gas with heat-exchange liquid in a mechanism (not shown, described in more detail below) external to the cylinder assembly 201 and then injecting the resulting foam into the cylinder assembly 201. Alternatively or additionally, foam may be generated inside the cylinder assembly 201 by the injection of heat-exchange liquid into cylinder assembly 201 through a foam-generating mechanism (e.g., spray head, rotating blade, one or more nozzles), partly or entirely filling the pneumatic chamber of cylinder assembly 201. In some embodiments, droplets and foams may be introduced into cylinder assembly 201 simultaneously and/or sequentially. Various embodiments may feature mechanisms (not shown in FIG. 2) for controlling the characteristics of foam (e.g., bubble size) and for breaking down, separating, and/or regenerating foam.

System 200 further includes a first control valve 220 (108 in FIG. 1) in communication with a storage reservoir 222 and cylinder assembly 201, and a second control valve 221 (118 in FIG. 1) in communication with a vent 223 and cylinder assembly 201. A control system 226 (122 in FIG. 1) may control operation of, e.g., valves 222 and 221 based on various system inputs (e.g., pressure, temperature, piston position, and/or fluid state) from cylinder assembly 201 and/or storage reservoir 222. Heat-transfer fluid (liquid or circulated by pump 214 enters through pipe 213. Pipe 213 may be (a) connected to a low-pressure fluid source (e.g., fluid reservoir (not shown) at the pressure to which vent 223 is connected or thermal well 242); (b) connected to a high-pressure source (e.g., fluid reservoir (not shown) at the pressure of reservoir 222); (c) selectively connected (using valve arrangement not shown) to low pressure during a compression process and to high pressure during an expansion process; (d) connected to changing-pressure fluid 208 in the cylinder 201 via connection 212; or (e) some combination of these options.

In an initial state, the cylinder assembly 201 may contain a gas 206 (e.g., air introduced to the cylinder assembly 201 via valve 221 and vent 223) and a heat-transfer fluid 208 (which may include or consist essentially of, e.g., water or another suitable liquid). When the gas 206 enters the cylinder assembly 201, piston 202 is operated to compress the gas 206 to an elevated pressure (e.g., approximately 3,000 psi). Heat-transfer fluid (not necessarily the identical body of heat-transfer fluid 208) flows from pipe 213 to the pump 214. The pump 214 may raise the pressure of the heat-exchange fluid to a pressure (e.g., up to approximately 3,015 psig) somewhat higher than the pressure within the cylinder assembly 201, as described in the '409 application. Alternatively or in conjunction, embodiments of the invention add heat (i.e., thermal energy) to, or remove heat from, the high-pressure gas in the cylinder assembly 201 by passing only relatively low-pressure fluids through a heat exchanger or fluid reservoir, as detailed in U.S. patent application Ser. No. 13/211,440, filed Aug. 17, 2011 (the '440 application), the entire disclosure of which is incorporated by reference herein.

Heat-transfer fluid is then sent through a pipe 216, where it may be passed through a heat exchanger 203 (where its temperature is altered) and then through a pipe 218 to the spray mechanism 210. The heat-transfer fluid thus circulated may include or consist essentially of liquid or foam. Spray mechanism 210 may be disposed within the cylinder assembly 201, as shown; located in the storage reservoir 222 or vent 223; or located in piping or manifolding around the cylinder assembly, such as pipe 218 or the pipes connecting the cylinder assembly to storage reservoir 222 or vent 223. The spray mechanism 210 may be operated in the vent 223 or connecting pipes during compression, and a separate spray mechanism may be operated in the storage reservoir 222 or connecting pipes during expansion. Heat-transfer spray 211 from spray mechanism 210 (and/or any additional spray mechanisms), and/or foam from mechanisms internal or external to the cylinder assembly 101, enable substantially isothermal compression of gas 206 within cylinder assembly 201.

In some embodiments, the heat exchanger 203 is configured to condition heat-transfer fluid at low pressure (e.g., a pressure lower than the maximum pressure of a compression or expansion stroke in cylinder assembly 201), and heat-transfer fluid is thermally conditioned between strokes or only during portions of strokes, as detailed in the '440 application. Embodiments of the invention are configured for circulation of heat-transfer fluid without the use of hoses that flex during operation through the use of, e.g., tubes or straws configured for non-flexure and/or pumps (e.g., submersible bore pumps, axial flow pumps, or other in-line style pumps) internal to the cylinder assembly (e.g., at least partially disposed within the piston rod thereof), as described in U.S. patent application Ser. No. 13/234,239, filed Sep. 16, 2011 (the '239 application), the entire disclosure of which is incorporated by reference herein.

At or near the end of the compression stroke, control system 226 opens valve 220 to admit the compressed gas 206 to the storage reservoir 222. Operation of valves 220 and 221 may be controlled by various inputs to control system 226, such as piston position in cylinder assembly 201, pressure in storage reservoir 222, pressure in cylinder assembly 201, and/or temperature in cylinder assembly 201.

As mentioned above, the control system 226 may enforce substantially isothermal operation, i.e., expansion and/or compression of gas in cylinder assembly 201, via control over, e.g., the introduction of gas into and the exhausting of gas out of cylinder assembly 201, the rates of compression and/or expansion, and/or the operation of the heat-exchange subsystem in response to sensed conditions. For example, control system 226 may be responsive to one or more sensors disposed in or on cylinder assembly 201 for measuring the temperature of the gas and/or the heat-exchange fluid within cylinder assembly 201, responding to deviations in temperature by issuing control signals that operate one or more of the system components noted above to compensate, in real time, for the sensed temperature deviations. For example, in response to a temperature increase within cylinder assembly 201, control system 226 may issue commands to increase the flow rate of spray 211 of heat-exchange fluid 208.

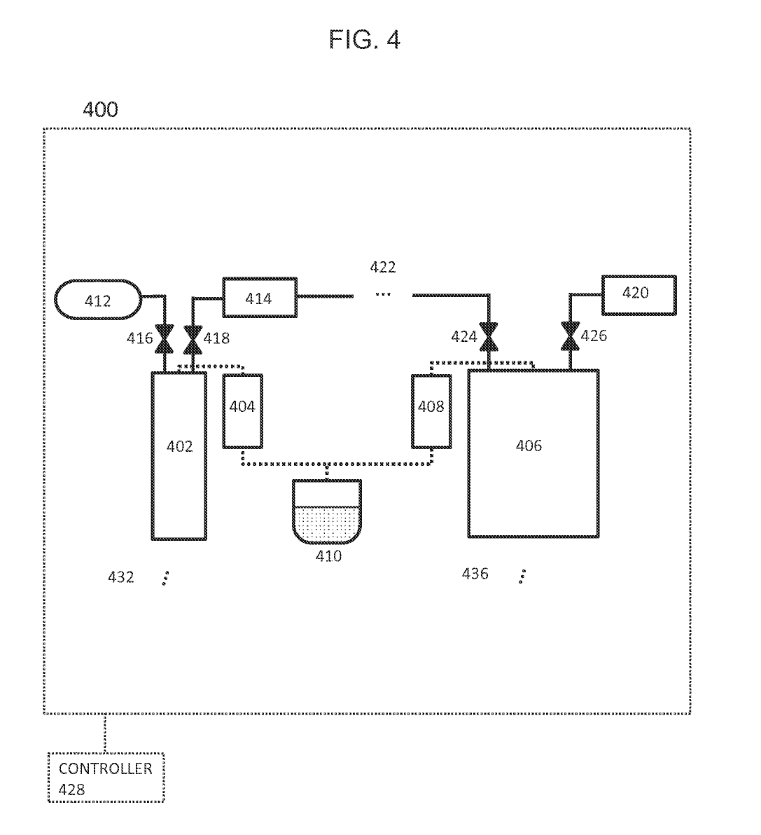

Furthermore, embodiments of the invention may be applied to systems in which cylinder assembly 201 (or a chamber thereof) is in fluid communication with a pneumatic chamber of a second cylinder (e.g., as shown in FIG. 4). That second cylinder, in turn, may communicate similarly with a third cylinder, and so forth. Any number of cylinders may be linked in this way. These cylinders may be connected in parallel or in a series configuration, where the compression and expansion is done in multiple stages.

The fluid circuit of heat exchanger 203 may be filled with water, a coolant mixture, an aqueous foam, or any other acceptable heat-exchange medium. In alternative embodiments, a gas, such as air or refrigerant, is used as the heat-exchange medium. In general, the fluid is routed by conduits to a large reservoir of such fluid in a closed or open loop. One example of an open loop is a well or body of water from which ambient water is drawn and the exhaust water is delivered to a different location, for example, downstream in a river. In a closed-loop embodiment, a cooling tower may cycle the water through the air for return to the heat exchanger. Likewise, water may pass through a submerged or buried coil of continuous piping where a counter heat-exchange occurs to return the fluid flow to ambient temperature before it returns to the heat exchanger for another cycle.

In various embodiments, the heat-exchange fluid is conditioned (i.e., pre-heated and/or pre-chilled) or used for heating or cooling needs by connecting the fluid inlet 238 and fluid outlet 240 of the external heat-exchange side of the heat exchanger 203 to an installation such as a heat-engine power plant, an industrial process with waste heat, a heat pump, and/or a building needing space heating or cooling, as described in the '731 patent. Alternatively, the external heat-exchange side of the heat exchanger 203 may be connected to a thermal well 242 as depicted in FIG. 2. The thermal well 242 may include or consist essentially of a large water reservoir that acts as a constant-temperature thermal fluid source for use with the system. Alternatively, the water reservoir may be thermally linked to waste heat from an industrial process or the like, as described above, via another heat exchanger contained within the installation. This allows the heat-exchange fluid to acquire or expel heat from/to the linked process, depending on configuration, for later use as a heating/cooling medium in the energy storage/conversion system. Alternatively, the thermal well 242 may include two or more bodies of energy-storage medium, e.g., a hot-water thermal well and a cold-water thermal well, that are typically maintained in contrasting energy states in order to increase the exergy of system 200 compared with a system in which thermal well 242 includes a single body of energy-storage medium. Storage media other than water may be utilized in the thermal well 242; temperature changes, phase changes, or both may be employed by storage media of thermal well 242 to store and release energy. Thermal or fluid links (not shown) to the atmosphere, ground, and/or other components of the environment may also be included in system 200, allowing mass, thermal energy, or both to be added to or removed from the thermal well 242. Moreover, as depicted in FIG. 2, the heat-transfer subsystem 224 does not interchange fluid directly with the thermal well 242, but in other embodiments, fluid is passed directly between the heat-transfer subsystem 224 and the thermal well 242 with no heat exchanger maintaining separation between fluids.

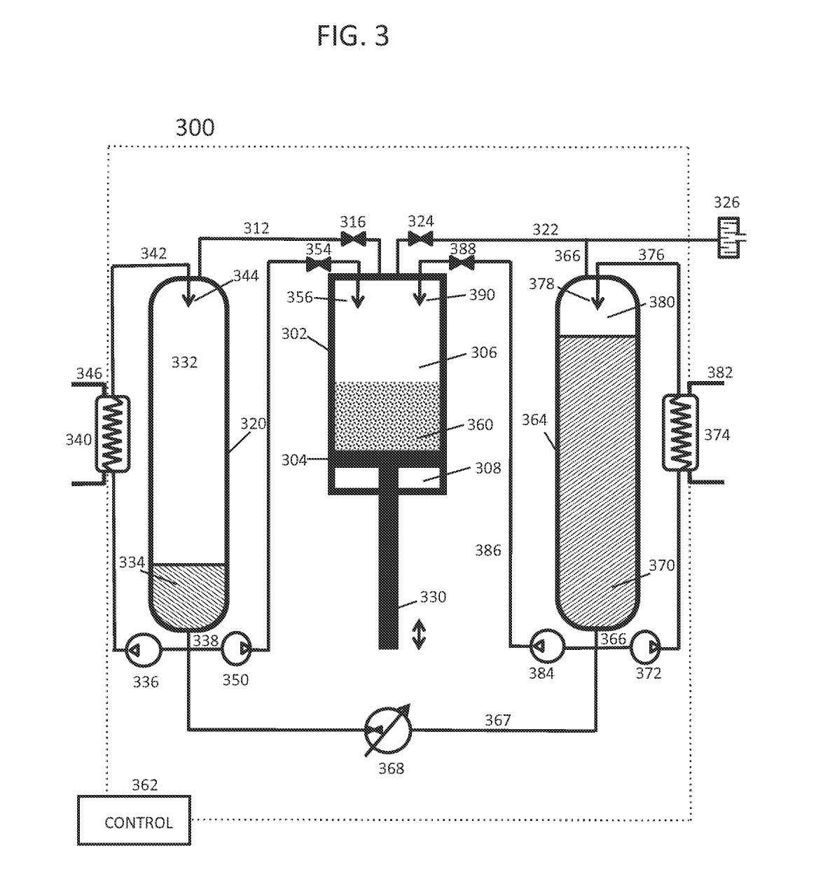

FIG. 3 is a schematic of the major components of an illustrative system 300 that employs a pneumatic cylinder 302 to efficiently convert (i.e., store) mechanical energy into the potential energy of compressed gas and, in another mode of operation, efficiently convert (i.e., recover) the potential energy of compressed gas into mechanical work. The pneumatic cylinder 302 may contain a slidably disposed piston 304 that divides the interior of the cylinder 302 into a distal chamber 306 and a proximal chamber 308. A port or ports (not shown) with associated pipes 312 and a bidirectional valve 316 enables gas from a high-pressure storage reservoir 320 to be admitted to chamber 306 as desired. A port or ports (not shown) with associated pipes 322 and a bidirectional valve 324 enables gas from the chamber 306 to be exhausted through a vent 326 to the ambient atmosphere as desired. In alternate embodiments, vent 326 is replaced by additional lower-pressure pneumatic cylinders (or pneumatic chambers of cylinders). A port or ports (not shown) enables the interior of the chamber 308 to communicate freely at all times with the ambient atmosphere. In alternate embodiments, cylinder 302 is double-acting and chamber 308 is, like chamber 306, equipped to admit and exhaust fluids in various states of operation. The distal end of a rod 330 is coupled to the piston 304. The rod 330 may be connected to a crankshaft, hydraulic cylinder, or other mechanisms for converting linear mechanical motion to useful work as described in the '678 and '842 patents.

In the energy recovery or expansion mode of operation, storage reservoir 320 is filled with high-pressure air (or other gas) 332 and a quantity of heat-transfer fluid 334. The heat-transfer fluid 334 may be an aqueous foam or a liquid that tends to foam when sprayed or otherwise acted upon. The liquid component of the aqueous foam, or the liquid that tends to foam, may include or consist essentially of water with 2% to 5% of certain additives; these additives may also provide functions of anti-corrosion, anti-wear (lubricity), anti-biogrowth (biocide), freezing-point modification (anti-freeze), and/or surface-tension modification. Additives may include a micro-emulsion of a lubricating fluid such as mineral oil, a solution of agents such as glycols (e.g. propylene glycol), or soluble synthetics (e.g. ethanolamines). Such additives tend to reduce liquid surface tension and lead to substantial foaming when sprayed. Commercially available fluids may be used at an approximately 5% solution in water, such as Mecagreen 127 (available from the Condat Corporation of Michigan), which consists in part of a micro-emulsion of mineral oil, and Quintolubric 807-WP (available from the Quaker Chemical Corporation of Pennsylvania), which consists in part of a soluble ethanolamine. Other additives may be used at higher concentrations (such as at a 50% solution in water), including Cryo-tek 100/A1 (available from the Hercules Chemical Company of New Jersey), which consists in part of a propylene glycol. These fluids may be further modified to enhance foaming while being sprayed and to speed defoaming when in a reservoir.

The heat-transfer fluid 334 may be circulated within the storage reservoir 320 via high-inlet-pressure, low-power-consumption pump 336 (such as described in the '731 patent). In various embodiments, the fluid 334 may be removed from the bottom of the storage reservoir 320 via piping 338, circulated via pump 336 through a heat exchanger 340, and introduced (e.g., sprayed) back into the top of storage reservoir 320 via piping 342 and spray head 344 (or other suitable mechanism). Any changes in pressure within reservoir 320 due to removal or addition of gas (e.g., via pipe 312) generally tend to result in changes in temperature of the gas 332 within reservoir 320. By spraying and/or foaming the fluid 334 throughout the storage reservoir gas 332, heat may be added to or removed from the gas 332 via heat exchange with the heat-transfer fluid 334. By circulating the heat-transfer fluid 334 through heat exchanger 340, the temperature of the fluid 334 and gas 332 may be kept substantially constant (i.e., isothermal). Counterflow heat-exchange fluid 346 at near-ambient pressure may be circulated from a near-ambient-temperature thermal well (not shown) or source (e.g., waste heat source) or sink (e.g., cold water source) of thermal energy, as described in more detail below.

In various embodiments of the invention, reservoir 320 contains an aqueous foam, either unseparated or partially separated into its gaseous and liquid components. In such embodiments, pump 336 may circulate either the foam itself, or the separated liquid component of the foam, or both, and recirculation of fluid into reservoir 320 may include regeneration of foam by apparatus not shown in FIG. 3.

In the energy recovery or expansion mode of operation, a quantity of gas may be introduced via valve 316 and pipe 312 into the upper chamber 306 of cylinder 302 when piston 304 is near or at the top of its stroke (i.e., “top dead center” of cylinder 302). The piston 304 and its rod 330 will then be moving downward (the cylinder 302 may be oriented arbitrarily but is shown vertically oriented in this illustrative embodiment). Heat-exchange fluid 334 may be introduced into chamber 306 concurrently via optional pump 350 (alternatively, a pressure drop may be introduced in line 312 such that pump 350 is not needed) through pipe 352 and directional valve 354. This heat-exchange fluid 334 may be sprayed into chamber 306 via one or more spray nozzles 356 in such a manner as to generate foam 360. (In some embodiments, foam 360 is introduced directly into chamber 306 in foam form.) The foam 360 may entirely fill the entire chamber 306, but is shown in FIG. 3, for illustrative purposes only, as only partially filling chamber 306. Herein, the term “foam” denotes either (a) foam only or (b) any of a variety of mixtures of foam and heat-exchange liquid in other, non-foaming states (e.g., droplets). Moreover, some non-foamed liquid (not shown) may accumulate at the bottom of chamber 306; any such liquid is generally included in references herein to the foam 360 within chamber 306.

System 300 is instrumented with pressure, piston position, and/or temperature sensors (not shown) and controlled via control system 362. At a predetermined position of piston 304, an amount of gas 332 and heat-transfer fluid 334 have been admitted into chamber 306 and valve 316 and valve 354 are closed. (Valves 316 and 354 may close at the same time or at different times, as each has a control value based on quantity of fluid desired.) The gas in chamber 306 then undergoes free expansion, continuing to drive piston 304 downward. During this expansion, in the absence of foam 360, the gas would tend to decrease substantially in temperature. With foam 360 largely or entirely filling the chamber, the temperature of the gas in chamber 306 and the temperature of the heat-transfer fluid 360 tend to approximate to each other via heat exchange. The heat capacity of the liquid component of the foam 360 (e.g., water with one or more additives) may be much higher than that of the gas (e.g., air) such that the temperature of the gas and liquid do not change substantially (i.e., are substantially isothermal) even over a many-times gas expansion (e.g., from 250 psig to near atmospheric pressure, or in other embodiments from 3,000 psig to 250 psig).

When the piston 304 reaches the end of its stroke (bottom dead center), the gas within chamber 306 will have expanded to a predetermined lower pressure (e.g., near atmospheric). Valve 324 will then be opened, allowing gas from chamber 306 to be vented, whether to atmosphere through pipe 322 and vent 326 (as illustrated here) or, in other embodiments, to a next stage in the expansion process (e.g., chamber in a separate cylinder), via pipe 322. Valve 324 remains open as the piston undergoes an upward (i.e., return) stroke, emptying chamber 306. Part or substantially all of foam 360 is also forced out of chamber 306 via pipe 322. A separator (not shown) or other means such as gravity separation is used to recover heat-transfer fluid, preferably de-foamed (i.e., as a simple liquid with or without additives), and to direct it into a storage reservoir 364 via pipe 366.

When piston 304 reaches top of stroke again, the process repeats with gas 332 and heat-transfer fluid 334 admitted from vessel 320 via valves 316 and 354. If additional heat-transfer fluid is needed in reservoir 320, it may be pumped back into reservoir 320 from reservoir 364 via piping 367 and optional pump/motor 368. In one mode of operation, pump 368 may be used to continuously refill reservoir 320 such that the pressure in reservoir 320 is held substantially constant. That is, as gas is removed from reservoir 320, heat-transfer fluid 334 is added to maintain constant pressure in reservoir 320. In other embodiments, pump 368 is not used or is used intermittently, the pressure in reservoir 320 continues to decrease during an energy-recovery process (i.e., involving removal of gas from reservoir 320), and the control system 362 changes the timing of valves 316 and 354 accordingly so as to reach approximately the same ending pressure when the piston 304 reaches the end of its stroke. An energy-recovery process may continue until the storage reservoir 320 is nearly empty of pressurized gas 332, at which time an energy-storage process may be used to recharge the storage reservoir 320 with pressurized gas 332. In other embodiments, the energy-recovery and energy-storage processes are alternated based on operator requirements.

In either the energy-storage or energy-compression mode of operation, storage reservoir 320 is typically at least partially depleted of high-pressure gas 332, as storage reservoir 320 also typically contains a quantity of heat-transfer fluid 334. Reservoir 364 is at low pressure (e.g., atmospheric or some other low pressure that serves as the intake pressure for the compression phase of cylinder 302) and contains a quantity of heat-transfer fluid 370.

The heat-transfer fluid 370 may be circulated within the reservoir 364 via low-power-consumption pump 372. In various embodiments, the fluid 370 may be removed from the bottom of the reservoir 364 via piping 367, circulated via pump 372 through a heat exchanger 374, and introduced (e.g., sprayed) back into the top of reservoir 364 via piping 376 and spray head 378 (or other suitable mechanism). By spraying the fluid 370 throughout the reservoir gas 380, heat may be added or removed from the gas via the heat-transfer fluid 370. By circulating the heat-transfer fluid 370 through heat exchanger 374, the temperature of the fluid 370 and gas 380 may be kept near constant (i.e., isothermal). Counterflow heat-exchange fluid 382 at near-ambient pressure may be circulated from a near-ambient-temperature thermal well (not shown) or source (e.g., waste heat source) or sink (e.g., cold water source) of thermal energy. In one embodiment, counterflow heat-exchange fluid 382 is at high temperature to increase energy recovery during expansion and/or counterflow heat-exchange fluid 382 is at low temperature to decrease energy usage during compression.

In the energy-storage or compression mode of operation, a quantity of low-pressure gas is introduced via valve 324 and pipe 322 into the upper chamber 306 of cylinder 302 starting when piston 304 is near top dead center of cylinder 302. The low-pressure gas may be from the ambient atmosphere (e.g., may be admitted through vent 326 as illustrated herein) or may be from a source of pressurized gas such as a previous compression stage. During the intake stroke, the piston 304 and its rod 330 will move downward, drawing in gas. Heat-exchange fluid 370 may be introduced into chamber 306 concurrently via optional pump 384 (alternatively, a pressure drop may be introduced in line 386 such that pump 384 is not needed) through pipe 386 and directional valve 388. This heat exchange fluid 370 may be introduced (e.g., sprayed) into chamber 306 via one or more spray nozzles 390 in such a manner as to generate foam 360. This foam 360 may fill the chamber 306 partially or entirely by the end of the intake stroke; for illustrative purposes only, foam 360 is shown in FIG. 3 as only partially filling chamber 306. At the end of the intake stroke, piston 304 reaches the end-of-stroke position (bottom dead center) and chamber 306 is filled with foam 360 generated from air at a low pressure (e.g., atmospheric) and heat-exchange liquid.

At the end of the stroke, with piston 304 at the end-of-stroke position, valve 324 is closed. Valve 388 is also closed, not necessarily at the same time as valve 324, but after a predetermined amount of heat-transfer fluid 370 has been admitted, creating foam 360. The amount of heat-transfer fluid 370 may be based upon the volume of air to be compressed, the ratio of compression, and/or the heat capacity of the heat-transfer fluid. Next, piston 304 and rod 330 are driven upwards via mechanical means (e.g., hydraulic fluid, hydraulic cylinder, mechanical crankshaft) to compress the gas within chamber 306.

During this compression, in the absence of foam 360, the gas in chamber 306 would tend to increase substantially in temperature. With foam 360 at least partially filling the chamber, the temperature of the gas in chamber 306 and the temperature of the liquid component of foam 360 will tend to equilibrate via heat exchange. The heat capacity of the fluid component of foam 360 (e.g., water with one or more additives) may be much higher than that of the gas (e.g., air) such that the temperature of the gas and fluid do not change substantially and are near-isothermal even over a many-times gas compression (e.g., from near atmospheric pressure to 250 psig, or in other embodiments from 250 psig to 3,000 psig).

The gas in chamber 306 (which includes, or consists essentially of, the gaseous component of foam 360) is compressed to a suitable pressure, e.g., a pressure approximately equal to the pressure within storage reservoir 320, at which time valve 316 is opened. The foam 360, including both its gaseous and liquid components, is then transferred into storage reservoir 320 through valve 316 and pipe 312 by continued upward movement of piston 304 and rod 330.

When piston 304 reaches top of stroke again, the process repeats, with low-pressure gas and heat-transfer fluid 370 admitted from vent 326 and reservoir 364 via valves 324 and 388. If additional heat-transfer fluid is needed in reservoir 364, it may be returned to reservoir 364 from reservoir 320 via piping 367 and optional pump/motor 368. Power recovered from motor 368 may be used to help drive the mechanical mechanism for driving piston 304 and rod 330 or may be converted to electrical power via an electric motor/generator (not shown). In one mode of operation, motor 368 may be run continuously, while reservoir 320 is being filled with gas, in such a manner that the pressure in reservoir 320 is held substantially constant. That is, as gas is added to reservoir 320, heat-transfer fluid 334 is removed from reservoir 320 to maintain substantially constant pressure within reservoir 320. In other embodiments, motor 368 is not used or is used intermittently; the pressure in reservoir 320 continues to increase during an energy-storage process and the control system 362 changes the timing of valves 316 and 388 accordingly so that the desired ending pressure (e.g., atmospheric) is attained within chamber 306 when the piston 304 reaches bottom of stroke. An energy-storage process may continue until the storage reservoir 320 is full of pressurized gas 332 at the maximum storage pressure (e.g., 3,000 psig), after which time the system is ready to perform an energy-recovery process. In various embodiments, the system may commence an energy-recovery process when the storage reservoir 320 is only partly full of pressurized gas 332, whether at the maximum storage pressure or at some storage pressure intermediate between atmospheric pressure and the maximum storage pressure. In other embodiments, the energy-recovery and energy-storage processes are alternated based on operator requirements.

FIG. 4 depicts an illustrative system 400 that features at least two cylinder assemblies 402, 406 (i.e., an embodiment of assembly 101 in FIG. 1; e.g., cylinder assembly 201 in FIG. 2) and a heat-transfer subsystem 404, 408 (e.g., subsystem 224 in FIG. 2) associated with each cylinder assembly 402, 406. Additionally, the system includes a thermal well 410 (e.g., thermal well 242 in FIG. 2) which may be associated with either or both of the heat-transfer subsystems 404, 408 as indicated by the dashed lines.

Assembly 402 is in selective fluid communication with a storage reservoir 412 (e.g., 112 in FIG. 1, 222 in FIG. 2) capable of holding fluid at relatively high pressure (e.g., approximately 3,000 psig). Assembly 406 is in selective fluid communication with assembly 402 and/or with optional additional cylinder assemblies between assemblies 402 and 406 as indicated by ellipsis marks 422. Assembly 406 is in selective fluid communication with an atmospheric vent 420 (e.g., 120 in FIG. 1, 223 in FIG. 2).

System 400 may compress air at atmospheric pressure (admitted to system 400 through the vent 420) stagewise through assemblies 406 and 402 to high pressure for storage in reservoir 412. System 400 may also expand air from high pressure in reservoir 412 stagewise through assemblies 402 and 406 to a low pressure (e.g., approximately 5 psig) for venting to the atmosphere through vent 420.

As described in U.S. Pat. No. 8,191,362, filed Apr. 6, 2011 (the '362 patent), the entire disclosure of which is incorporated by reference herein, in a group of N cylinder assemblies used for expansion or compression of gas between a high pressure (e.g., approximately 3,000 psig) and a low pressure (e.g., approximately 5 psig), the system will contain gas at N−1 pressures intermediate between the high-pressure extreme and the low pressure. Herein each such intermediate pressure is termed a “mid-pressure.” In illustrative system 400, N=2 and N−1=1, so there is one mid-pressure (e.g., approximately 250 psig during expansion) in the system 400. In various states of operation of the system, mid-pressures may occur in any of the chambers of a series-connected cylinder group (e.g., the cylinders of assemblies 402 and 406) and within any valves, piping, and other devices in fluid communication with those chambers. In illustrative system 400, the mid-pressure, herein denoted “mid-pressure P1,” occurs primarily in valves, piping, and other devices intermediate between assemblies 402 and 406.

Assembly 402 is a high-pressure assembly: i.e., assembly 402 may admit gas at high pressure from reservoir 412 to expand the gas to mid-pressure P1 for transfer to assembly 402, and/or may admit gas at mid-pressure P1 from assembly 406 to compress the gas to high pressure for transfer to reservoir 412. Assembly 406 is a low-pressure assembly: i.e., assembly 406 may admit gas at mid-pressure P1 from assembly 402 to expand the gas to low pressure for transfer to the vent 420, and/or may admit gas at low pressure from vent 420 to compress the gas to mid-pressure P1 for transfer to assembly 402.

In system 400, extended cylinder assembly 402 communicates with extended cylinder assembly 406 via a mid-pressure assembly 414. Herein, a “mid-pressure assembly” includes or consists essentially of a reservoir of gas that is placed in fluid communication with the valves, piping, chambers, and other components through or into which gas passes. The gas in the reservoir is at approximately at the mid-pressure which the particular mid-pressure assembly is intended to provide. The reservoir is large enough so that a volume of mid-pressure gas approximately equal to that within the valves, piping, chambers, and other components with which the reservoir is in fluid communication may enter or leave the reservoir without substantially changing its pressure. Additionally, the mid-pressure assembly may provide pulsation damping, additional heat-transfer capability, fluid separation, and/or house one or more heat-transfer sub-systems such as part or all of sub-systems 404 and/or 408. As described in the '362 patent, a mid-pressure assembly may substantially reduce the amount of dead space in various components of a system employing pneumatic cylinder assemblies, e.g., system 400 in FIG. 4. Reduction of dead space tends to increase overall system efficiency.

Alternatively or in conjunction, pipes and valves (not shown in FIG. 4) bypassing mid-pressure assembly 414 may enable fluid to pass directly between assembly 402 and assembly 406. Valves 416, 418, 424, and 426 control the passage of fluids between the assemblies 402, 406, 412, and 414.

A control system 428 (e.g., 122 in FIG. 1, 226 in FIG. 2, 362 in FIG. 3) may control operation of, e.g., all valves of system 400 based on various system inputs (e.g., pressure, temperature, piston position, and/or fluid state) from assemblies 402 and 406, mid-pressure assembly 414, storage reservoir 412, thermal well 410, heat transfer sub-systems 404, 408, and/or the environment surrounding system 420.

It will be clear to persons reasonably familiar with the art of pneumatic machines that a system similar to system 400 but differing by the incorporation of one, two or more mid-pressure extended cylinder assemblies may be devised without additional undue experimentation. It will also be clear that all remarks herein pertaining to system 400 may be applied to such an N-cylinder system without substantial revision, as indicated by elliptical marks 422. Such N-cylinder systems, though not discussed further herein, are contemplated and within the scope of the invention. As shown and described in the '678 patent, N appropriately sized cylinders, where N≧2, may reduce an original (single-cylinder) operating fluid pressure range R to R^{1/N} and correspondingly reduce the range of force acting on each cylinder in the N-cylinder system as compared to the range of force acting in a single-cylinder system. This and other advantages, as set forth in the '678 patent, may be realized in N-cylinder systems. Additionally, multiple identical cylinders may be added in parallel and attached to a common or separate drive mechanism (not shown) with the cylinder assemblies 402, 406 as indicated by ellipsis marks 432, 436, enabling higher power and air-flow rates.

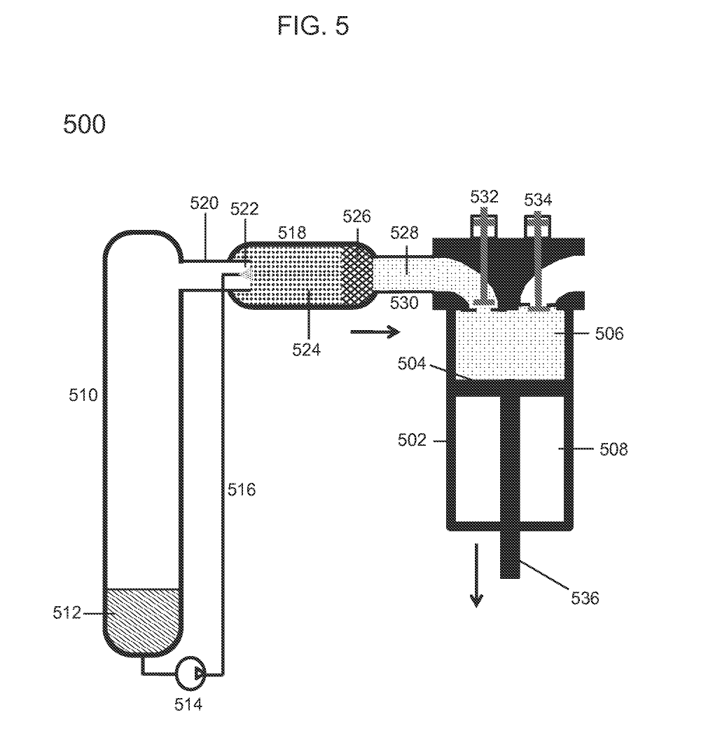

FIG. 5 is a schematic diagram showing components of a system 500 for achieving approximately isothermal compression and expansion of a gas for energy storage and recovery using a pneumatic cylinder 502 (shown in partial cross-section) according to embodiments of the invention. The cylinder 502 typically contains a slidably disposed piston 504 that divides the cylinder 502 into two chambers 506, 508. A reservoir 510 contains gas at high pressure (e.g., 3,000 psi); the reservoir 510 may also contain a quantity of heat-exchange liquid 512. The heat-exchange liquid 512 may contain an additive that increases the liquid's tendency to foam (e.g., by lowering the surface tension of the liquid 512). Additives may include surfactants (e.g., sulfonates), a micro-emulsion of a lubricating fluid such as mineral oil, a solution of agents such as glycols (e.g., propylene glycol), or soluble synthetics (e.g., ethanolamines). Foaming agents such as sulfonates (e.g., linear alkyl benzene sulfonate such as Bio-Soft D-40 available from Stepan Company of Illinois) may be added, or commercially available foaming concentrates such as firefighting foam concentrates (e.g., fluorosurfactant products such as those available from ChemGuard of Texas) may be used. Such additives tend to reduce liquid surface tension of water and lead to substantial foaming when sprayed. Commercially available fluids may be used at an approximately 5% solution in water, such as Mecagreen 127 (available from the Condat Corporation of Michigan), which consists in part of a micro-emulsion of mineral oil, and Quintolubric 807-WP (available from the Quaker Chemical Corporation of Pennsylvania), which consists in part of a soluble ethanolamine. Other additives may be used at higher concentrations (such as at a 50% solution in water), including Cryo-tek 100/A1 (available from the Hercules Chemical Company of New Jersey), which consists in part of a propylene glycol. These fluids may be further modified to enhance foaming while being sprayed and to speed defoaming when in a reservoir.

A pump 514 and piping 516 may convey the heat-exchange liquid to a device herein termed a “mixing chamber” (518). Gas from the reservoir 510 may also be conveyed (via piping 520) to the mixing chamber 518. Within the mixing chamber 518, a foam-generating mechanism 522 combines the gas from the reservoir 510 and the liquid conveyed by piping 516 to create foam 524 of a certain grade (i.e., bubble size variance, average bubble size, void fraction), herein termed Foam A, inside the mixing chamber 518.

The mixing chamber 518 may contain a screen 526 or other mechanism (e.g., source of ultrasound) to vary or homogenize foam structure. Screen 526 may be located, e.g., at or near the exit of mixing chamber 518. Foam that has passed through the screen 526 may have a different bubble size and other characteristics from Foam A and is herein termed Foam B (528). In other embodiments, the screen 526 is omitted, so that Foam A is transferred without deliberate alteration to chamber 506.

The exit of the mixing chamber 518 is connected by piping 530 to a port in the cylinder 502 that is gated by a valve 532 (e.g., a poppet-style valve) that permits fluid from piping 530 to enter the upper chamber (air chamber) 506 of the cylinder 502. Valves (not shown) may control the flow of gas from the reservoir 510 through piping 520 to the mixing chamber 518, and from the mixing chamber 518 through piping 528 to the upper chamber 506 of the cylinder 502. Another valve 534 (e.g., a poppet-style valve) permits the upper chamber 506 to communicate with other components of the system 500, e.g., an additional separator device (not shown), the upper chamber of another cylinder (not shown), or a vent to the ambient atmosphere (not shown).

The volume of reservoir 510 may be large (e.g., at least approximately four times larger) relative to the volume of the mixing chamber 518 and cylinder 502. Foam A and Foam B are preferably statically stable foams over a portion or all of the time-scale of typical cyclic operation of system 500: e.g., for a 120 RPM system (i.e., 0.5 seconds per revolution), the foam may remain substantially unchanged (e.g., less than 10% drainage) after 5.5 seconds or a time approximately five times greater than the revolution time.

In an initial state of operation of a procedure whereby gas stored in the reservoir 510 is expanded to release energy, the valve 532 is open, the valve 534 is closed, and the piston 504 is near top dead center of cylinder 502 (i.e., toward the top of the cylinder 502). Gas from the reservoir 510 is allowed to flow through piping 520 to the mixing chamber 518 while liquid from the reservoir 510 is pumped by pump 514 to the mixing chamber 518. The gas and liquid thus conveyed to the mixing chamber 518 are combined by the foam-generating mechanism 522 to form Foam A (524), which partly or substantially fills the main chamber of the mixing chamber 518. Exiting the mixing chamber 518, Foam A passes through the screen 526, being altered thereby to Foam B. Foam B, which is at approximately the same pressure as the gas stored in reservoir 510, passes through valve 532 into chamber 506. In chamber 506, Foam B exerts a force on the piston 504 that may be communicated to a mechanism (e.g., an electric generator, not shown) external to the cylinder 502 by a rod 536 that is connected to piston 504 and that passes slideably through the lower end cap of the cylinder 502.

The gas component of the foam in chamber 506 expands as the piston 504 and rod 536 move downward. At some point in the downward motion of piston 504, the flow of gas from reservoir 510 into the mixing chamber 518 and thence (as the gas component of Foam B) into chamber 506 may be ended by appropriate operation of valves (not shown). As the gas component of the foam in chamber 506 expands, it will tend, unless heat is transferred to it, to decrease in temperature according to the Ideal Gas Law; however, if the liquid component of the foam in chamber 506 is at a higher temperature than the gas component of the foam in chamber 506, heat will tend to be transferred from the liquid component to the gas component. Therefore, the temperature of the gas component of the foam within chamber 506 will tend to remain constant (approximately isothermal) as the gas component expands.

When the piston 504 approaches bottom dead center of cylinder 502 (i.e., has moved down to approximately its limit of motion), valve 532 may be closed and valve 534 may be opened, allowing the expanded gas in chamber 506 to pass from cylinder 502 to some other component of the system 500, e.g., a vent or a chamber of another cylinder for further expansion.

In some embodiments, pump 514 is a variable-speed pump, i.e., may be operated so as to transfer liquid 512 at a slower or faster rate from the reservoir 510 to the foam-generating mechanism 522 and may be responsive to signals from the control system (not shown). If the rate at which liquid 512 is transferred by the pump 514 to the foam-mechanism 522 is increased relative to the rate at which gas is conveyed from reservoir 510 through piping 520 to the mechanism 522, the void fraction of the foam produced by the mechanism 522 may be decreased. If the foam generated by the mechanism 522 (Foam A) has a relatively low void fraction, the foam conveyed to chamber 506 (Foam B) will generally also tend to have a relatively low void fraction. When the void fraction of a foam is lower, more of the foam consists of liquid, so more thermal energy may be exchanged between the gas component of the foam and the liquid component of the foam before the gas and liquid components come into thermal equilibrium with each other (i.e., cease to change in relative temperature). When gas at relatively high density (e.g., ambient temperature, high pressure) is being transferred from the reservoir 510 to chamber 506, it may be advantageous to generate foam having a lower void fraction, enabling the liquid fraction of the foam to exchange a correspondingly larger quantity of thermal energy with the gas fraction of the foam.

All pumps shown in subsequent figures herein may also be variable-speed pumps and may be controlled based on signals from the control system. Signals from the control system may be based on system-performance (e.g., gas temperature and/or pressure, cycle time, etc.) measurements from one or more previous cycles of compression and/or expansion.

Embodiments of the invention increase the efficiency of a system 500 for the storage and retrieval of energy using compressed gas by enabling the surface area of a given quantity of heat-exchange liquid 512 to be greatly increased (with correspondingly accelerated heat transfer between liquid 512 and gas undergoing expansion or compression within cylinder 502) with less investment of energy than would be required by alternative methods of increasing the surface of area of the liquid, e.g., the conversion of the liquid 512 to a spray.

In other embodiments, the reservoir 510 is a separator rather than a high-pressure storage reservoir as depicted in FIG. 5. In such embodiments, piping, valves, and other components not shown in FIG. 5 are supplied that allow the separator to be placed in fluid communication with a high-pressure gas storage reservoir as well as with the mixing chamber 518, as shown and described in the '128 application.

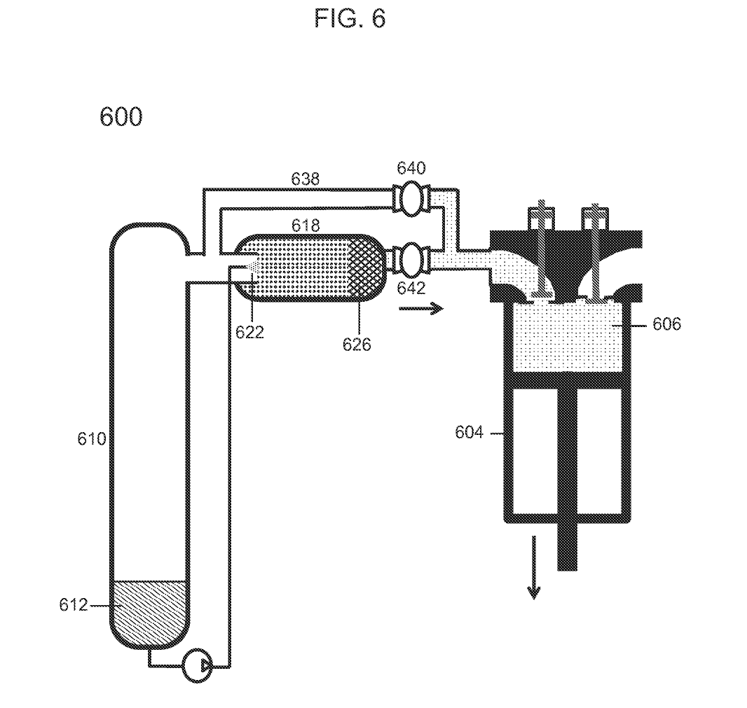

FIG. 6 is a schematic diagram showing components of a system 600 for achieving approximately isothermal compression and expansion of a gas for energy storage and recovery using a pneumatic cylinder 604 (shown in partial cross-section) according to embodiments of the invention. System 600 is similar to system 500 in FIG. 5, except that system 600 includes a bypass pipe 638. Moreover, two valves 640, 642 are explicitly depicted in FIG. 6. Bypass pipe 638 may be employed as follows: (1) when gas is being released from the storage reservoir 610, mixed with heat-exchange liquid 612 in the mixing chamber 618, and conveyed to chamber 606 of cylinder 604 to be expanded therein, valve 640 will be closed and valve 642 open; (2) when gas has been compressed in chamber 606 of cylinder 604 and is to be conveyed to the reservoir 610 for storage, valve 640 will be open and valve 642 closed. Less friction will tend to be encountered by fluids passing through valve 640 and bypass pipe 638 than by fluids passing through valve 642 and screen 626 and around the foam-generating mechanism 622. In other embodiments, valve 642 is omitted, allowing fluid to be routed through the bypass pipe 638 by the higher resistance presented by the mixing chamber 618, and valve 640 is a check valve preventing fluid flow when gas is being released in expansion mode. The direction of fluid flow from chamber 606 to the reservoir 610 via a lower-resistance pathway (i.e., the bypass pipe 638) will tend to result in lower frictional losses during such flow and therefore higher efficiency for system 600.

In other embodiments, the reservoir 610 is a separator rather than a high-pressure storage reservoir as depicted in FIG. 6. In such embodiments, piping, valves, and other components not shown in FIG. 6 are supplied that allow the separator to be placed in fluid communication with a high-pressure gas storage reservoir as well as with the mixing chamber 618 and bypass pipe 638.

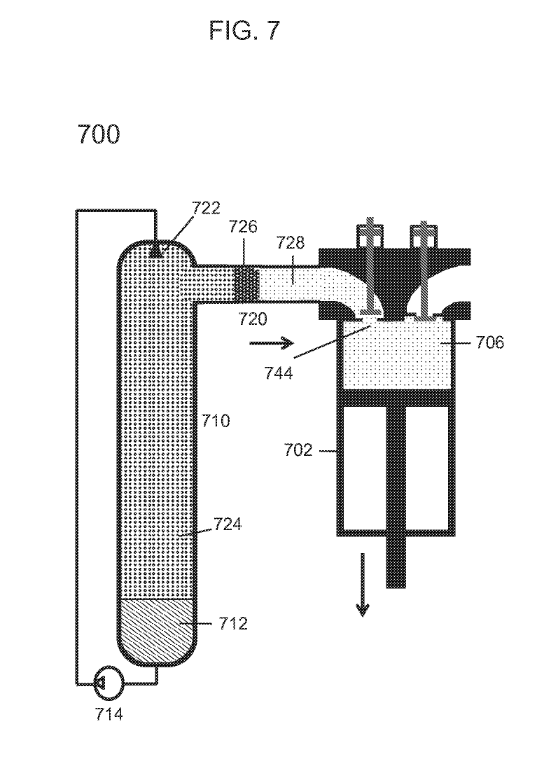

FIG. 7 is a schematic diagram showing components of a system 700 for achieving approximately isothermal compression and expansion of a gas for energy storage and recovery using a pneumatic cylinder 702 (shown in partial cross-section) according to embodiments of the invention. System 700 is similar to system 500 in FIG. 5, except that system 700 omits the mixing chamber 518 and instead generates foam inside the storage reservoir 710. In system 700, a pump 714 circulates heat-exchange liquid 712 to a foam-generating mechanism 722 (e.g., one or more spray nozzles) inside the reservoir 710. The reservoir 710 may, by means of the pump 714 and mechanism 722, be filled partly or entirely by foam of an initial or original character, Foam A (724). The reservoir 710 may be placed in fluid communication via pipe 720 with a valve-gated port 744 in cylinder 702. Valves (not shown) may govern the flow of fluid through pipe 720. An optional screen 726 (or other suitable mechanism such as an ultrasound source), shown in FIG. 7 inside pipe 720 but locatable anywhere in the path of fluid flow between reservoir 710 and chamber 706 of the cylinder 702, serves to alter Foam A (724) to Foam B (728), regulating characteristics such as bubble-size variance and average bubble size.

In other embodiments, the reservoir 710 is a separator rather than a high-pressure storage reservoir as depicted in FIG. 7. In such embodiments, piping, valves, and other components not shown in FIG. 7 will be supplied that allow the separator to be placed in fluid communication with a high-pressure gas storage reservoir as well as with the cylinder 702. In other embodiments, a bypass pipe similar to that depicted in FIG. 6 is added to system 700 in order to allow fluid to pass from cylinder 702 to reservoir 710 without passing through the screen 726.

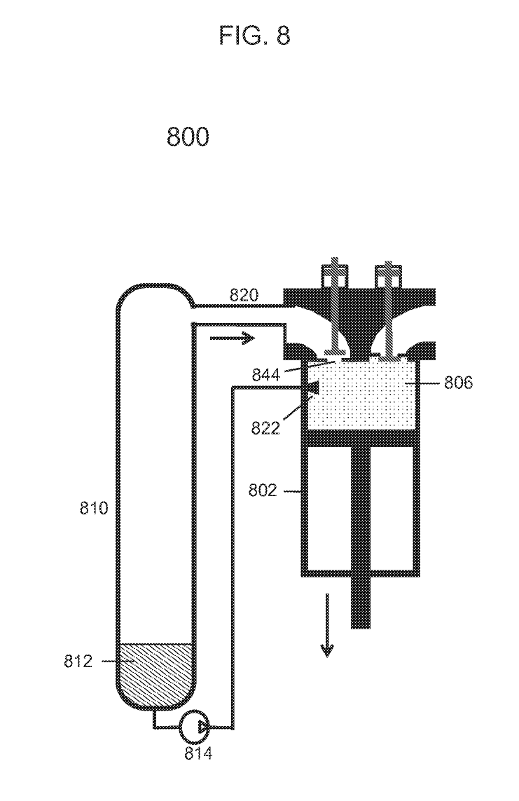

FIG. 8 is a schematic diagram showing components of a system 800 for achieving approximately isothermal compression and expansion of a gas for energy storage and recovery using a pneumatic cylinder 802 (shown in partial cross-section) according to embodiments of the invention. System 800 is similar to system 500 in FIG. 5, except that system 800 omits the mixing chamber 518 and instead generates foam inside the air chamber 806 of the cylinder 802. In system 800, a pump 814 circulates heat-exchange liquid 812 to a foam-generating mechanism 822 (e.g., one or more spray nozzles injecting into cylinder and/or onto a screen through which admitted air passes) either located within, or communicating with (e.g., through a port), chamber 806. The chamber 806 may, by means of the pump 814 and mechanism 822 (and by means of gas supplied from reservoir 810 via pipe 820 through a port 844), be filled partly or substantially entirely by foam. The reservoir 810 may be placed in fluid communication via pipe 820 with valve-gated port 844 in cylinder 802. Valves (not shown) may govern the flow of fluid through pipe 820.

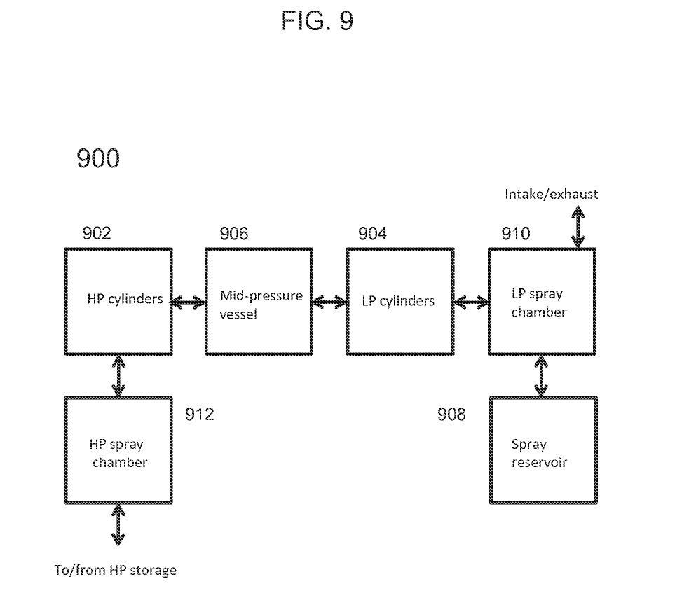

FIG. 9 is a schematic drawing of an illustrative CAES system 900 employing pairs of high- and low-pressure cylinders in which air is compressed and expanded. Half of the cylinders are high-pressure cylinders (HPCs, indicated in FIG. 900 by block 902) and half of the cylinders are low-pressure cylinders (LPCs, indicated in FIG. 900 by block 904), resulting in a two-stage compression process. Block 902 represents some number N of high-pressure cylinders (not shown) and block 904 represents an equal number N of low-pressure cylinders (not shown). The HPCs and LPCs jointly drive a crankshaft that in turn drives an electric generator or, in some states of operation of system 900, is driven by an electric motor. Systems employing principles of operation similar to those of 900 but including other subsystems, other mechanisms, other arrangements of parts, other numbers of stages (i.e., a single stage or more than one stage), and unequal numbers of high- and low-pressure cylinders, are also contemplated and within the scope of the invention.

Separating the LPCs from the HPCs is a mid-pressure vessel (MPV) 906 that buffers and decouples the HPCs 902 and LPCs 904 during either compression or expansion processes. This allows each cylinder assembly (i.e., each high- or low-pressure cylinder and the valves that control the entry or exit of gas from the cylinder) to operate independently from all the other cylinder assemblies within system 900. Independent operation of cylinder assemblies allows, in turn, for optimization of the performance (e.g., optimization of valve timing) of each cylinder assembly. A system controller (not shown), e.g., a computerized controller, coordinates the operation of individual cylinders with each other and with the other pneumatic components and processes within system 900.

In addition to the cylinders 902, 904 and MPV 906, system 900 also includes a spray reservoir 908 that holds a heat-transfer fluid (e.g., treated water) at low (e.g., atmospheric) pressure, a low-pressure spray chamber 910 that creates foam and/or spray at atmospheric pressure for intake into the LPCs for compression, and a high-pressure spray chamber 912 that creates foam and/or spray at storage pressure (i.e., the pressure at which gas and/or heat-transfer fluid is stored after compression and/or before expansion) for expansions in the HPCs. Finally, system 900 includes one or more storage reservoirs (not shown) that are connected to the HPCs 902 via the high-pressure spray chamber 912. The storage reservoirs typically contain compressed air, e.g., air compressed by system 900 and stored for future expansion to drive electricity generation.

Each of the cylinder assemblies in the HPC group 902 and LPC group 904 typically includes a cylinder similar to cylinder 201 in FIG. 2, a high-side valve similar to valve 220 in FIG. 2, and a low-side valve assembly similar to valve 221 in FIG. 2. Each high-side valve includes or consists essentially of one or more poppet elements that open out of the cylinder, connecting the expansion/compression chamber of the cylinder to a volume that is generally at higher pressure than the chamber. For a low-pressure cylinder, the high-side valve connects the cylinder's expansion/compression chamber to the MPV 906; for a high-pressure cylinder, the high-side valve connects the cylinder's expansion/compression chamber to the high-pressure spray chamber 912. Because these high-side valves open out of the cylinder rather than into the cylinder, they passively check open under an over-pressure condition in the cylinder, reducing the risk of a hydrolocking event with possible attendant damage to system components or interference with system operation.

Each low-side valve includes or consists essentially of one or more poppet elements that open into the cylinder, connecting the expansion/compression chamber of the cylinder to a volume that is generally at lower pressure than the chamber. For a low-pressure cylinder, the low-side valve connects the cylinder's expansion/compression chamber to the spray reservoir 908; for a high-pressure cylinder, the low-side valve connects the cylinder's expansion/compression chamber to the MPV 906. All of the valves, both low-side and high-side, may be hydraulically actuated. Other actuated valves such as variable cam-driven valves, electromagnetically actuated valves, mechanically actuated valves, and pneumatically actuated valves are also considered and may be utilized.

The system 900 may cyclically perform a normal compression process (or “compression cycle”) or a normal expansion process (or “expansion cycle”). In a normal compression process, each low-pressure and high-pressure cylinder progresses through a series of four conditions or phases, each of which has an associated a valve configuration. The four phases are (1) compression stroke, (2) direct fill, (3) regeneration or expansion stroke, and (4) breathe, intake, or auxiliary stroke. The numbering of the phases is arbitrary in the sense that when the phases are performed in a repeating cycle, no one phase is “first” other than by convention. It is assumed in this description that all high-side and low-side valves in system 900 activate instantaneously and ideally; the implications of non-ideal valve actuation will be described subsequently. The four phases are described in detail below.

The compression stroke begins with the cylinder's piston at the bottom of its stroke range. The cylinder's expansion/compression chamber (herein also referred to simply as “the chamber”) is filled with air at relatively low pressure (e.g., atmospheric). For example, the cylinder may have previously drawn in air through its low-side valve from a source on its low side (e.g., an HPC draws air in from the MPV 906, or an LPC draws air in from the ambient intake/exhaust port). With the piston at bottom of stroke, the cylinder's low-side valve and high-side valve both close, if they were not already closed, and the piston begins to move upward, compressing the air within the chamber: i.e., the compression stroke begins. The compression stroke continues as the piston moves up from bottom of stroke with both valves closed, compressing the air inside. The compression phase nominally ends when the pressure in the cylinder is approximately equal to the pressure in the component (e.g., MPV 906 or HP spray chamber and thence to high-pressure storage reservoir) to which the cylinder is connected on its high side. At this point, the direct-fill stroke or phase begins.

The direct-fill stroke or phase occurs while the piston is still moving upward and involves pushing the compressed air within the chamber out of the cylinder and into the high-side component. Direct fill begins when the pressures in the cylinder and the high-side vessel are approximately equal and the high-side valve is actuated to open. The low-side valve remains closed. Once the high-side valve is open, the cylinder pushes compressed air from its chamber into the high-side component as the piston continues to travel toward top of stroke. Direct fill ends when the cylinder reaches top of stroke, whereupon the high-side valve is closed.

The regeneration stroke occurs with both valves closed as the cylinder piston moves downward, away from top of stroke. Each cylinder has some amount of clearance volume, which is the physical space within the cylinder—above the piston and below the valves and in all the connections and crevices—that is present when the piston is at top of stroke. Moreover, in a CAES system that utilizes a liquid/water mixture to effect heat transfer within the cylinder (e.g., system 900), some fraction of the clearance volume will be occupied by liquid and some by air. That portion of the clearance volume occupied by air during a particular state of operation of the cylinder is the air dead volume (also herein termed simply the “dead volume”) of the cylinder in that state of operation. This is the portion of air that was compressed during the compression stroke that was not then subsequently pushed into the high-side component. This compressed air contains energy (i.e., both thermal and elastic potential), and the regeneration stroke allows this energy to be recaptured. The regeneration stroke starts at top of stroke with both valves closed and continues as the piston moves downward, expanding the dead volume air. The regeneration stroke ends when the pressure in the cylinder has dropped to the low-side vessel pressure and the low-side valve is commanded open.

As the cylinder piston is moving downward, once the low-side valve is opened the intake stroke begins. The intake stroke continues, drawing in new air to be compressed on the next stroke, until the piston reaches bottom of stroke. At this point, the low-side valve is closed and the next compression stroke may begin.

Each of the four compression stages is separated from preceding and subsequent stages by a valve transition event, i.e., the opening or closing of one or more valves. In the descriptions of the stages above, the valve transition points were clearly defined as top of stroke, bottom of stroke, or pressure equalization, but this assumes that the valves of system 900 respond ideally and instantaneously. However, because of finite valve response time, each valve transition event is an opportunity for system optimization.

The first valve transition event mentioned above is the transition from intake stroke to compression stroke, which nominally occurs at bottom dead center (BDC; the condition where the piston is at its nethermost point of motion). With finite (nonzero) valve response time, the low-side valve will need to be commanded closed slightly before BDC and will likely be full seat closed slightly after BDC. Transitioning this valve too early means that less air is drawn in than could have been, resulting in less air to be compressed during the following compression stroke (reduced capacity). Transitioning the valve too late means that some of the air drawn in will be re-exhausted before the valve fully seats, also resulting in reduced capacity.

The second valve event is at the end of compression, transitioning into direct-fill, where the high-side valve is opened to end admission of air into the chamber and start pushing air into the high-side vessel. Nominally, the high-side valve opens when the pressure in the chamber is equal to the pressure in the high-side component. However, because of finite valve response time, if the valve is commanded open when the pressures are equal, then the pressure in the chamber will spike significantly as the flow from the chamber is limited and throttled through the high-side valve while the valve is transitioning open. The pressure spike may be avoided by commanding the high-side valve to open before pressures are equal in the chamber and the high-side component. However, if the high-side valve starts to open when the chamber pressure is still lower than that within the high-side component, then some amount of back-flow into the chamber will occur as fluid from the high-side component flows backward through the high-side valve into the chamber. (This backflow will be throttled, since the high-side valve is partially open.) If the high-side valve is opened too early, then the pressure within the chamber will jump quickly to the high-side component pressure, and the piston will need to perform additional work to push the air back out of the chamber into the high-side component. Thus, this valve transition entails a tradeoff between backflow and pressure-spike, both of which impact the pressure profile and the work that needs to be performed by the piston upon the air.

The valve transition closing the high-side valve at the end of the direct fill impacts system capacity. If the high-side valve is closed too early, then less air is pushed into the high-side component than could have been, and the pressure will momentarily spike before dropping. If the high-side valve is closed too late, then some of the air pushed into the high-side component will be pulled back out again as the piston moves away from top dead center (TDC; the condition where the piston is at its uppermost point of motion), and as the high-side valve finishes closing the flow will be throttled so the energy of the air flowing back into the cylinder performs less work on the piston. Potential work lost to throttling is not, in general, recovered.

Finally, the transition at the end of the regeneration stroke that opens the low-side valve to start the intake stroke impacts the work done on the piston. If the low-side valve is opened too early, then the remaining air at higher pressure from the dead volume will no longer expand, doing work on the piston, but will expand (throttled) through the opening low-side valve. If the low-side valve opens too late, then the pressure in the chamber will drop below the low-side component pressure and the piston will have to do additional work to pull the piston down and pull air through the partially open low-side valve.

Similarly, in a normal expansion process, each low-pressure and high-pressure cylinder progresses through a series of four conditions or sub-processes, each of which has an associated a valve configuration. The four conditions are (1) vent (or exhaust, or auxiliary) stroke, (2) pre-compression stroke, (3) direct drive, and (4) expansion stroke. The numbering of the phases is arbitrary in the sense that when the phases are performed in a repeating cycle, no one phase is “first” other than by convention. It is assumed in this description that all high-side and low-side valves in system 900 activate instantaneously and ideally; the implications of non-ideal valve actuation will be described subsequently. The four phases are described in detail below.

An expansion cycle begins at the bottom of stroke with the piston beginning to move upward from BDC and the low-side valve open, commencing a vent stroke. As the piston moves upward away from BDC, air in the chamber (e.g., air that was expanded in a previous cycle) is exhausted through the low-side valve to the low-side component (e.g., exhausted from an HPC to the MPV 906 or from an LPC to the ambient intake/exhaust port). A vent stroke ends when the low-side valve is closed and a pre-compression stroke begins. In general, the piston continues to move upward without interruption as a vent stroke ends and a pre-compression stroke begins.

As the cylinder piston continues to move upward, before it reaches TDC the low-side valve is closed to begin the pre-compression stroke. In pre-compression, both the high-side valve and low-side valve are closed and the air volume trapped within the chamber is compressed. In controlling the events of pre-compression, a goal is to close off the low-side valve at such a time that the air trapped in the chamber is compressed as nearly as possible to the pressure of the cylinder's adjoining high-side component when the piston reaches TDC. This allows the high-side valve to open at top of stroke with equal pressures on either side, resulting in approximately zero throttled flow through that valve and approximately zero loss of exergy due to non-work-performing loss of pressure of a quantity of gas. Timing of the start of pre-compression (closure of the low-side valve) greatly impacts the achievement of the equal-pressure goal.

Once the piston is at TDC and the high-side valve is opened, the direct-drive stroke begins. In direct drive, the piston is moving down, away from TDC, and air in the high-side component is expanding and flowing through the high-side valve into the chamber, directly driving the piston downward. The direct drive stroke continues until an appropriate mass of air has been added to the cylinder, at which point the high-side valve closes and the expansion stroke begins. In general, the piston continues to move downward without interruption as a direct-drive stroke ends and an expansion stroke begins.

In an expansion stroke, both valves are closed, and the air that was admitted to the chamber during the direct-drive phase expands, continuing to perform work upon the piston as it drives it downward. If a correct mass of air was added to the cylinder during direct drive, then the air pressure at the end of the expansion stroke will be approximately equal to the end-of-stroke target pressure at the moment when the piston reaches BDC. For a high-pressure cylinder, the end-of-stroke target pressure is the pressure in the MPV; for a low-pressure cylinder, the end-of-stroke target pressure is the vent pressure, which is typically slightly higher than atmospheric pressure. Once the piston reaches BDC, the low-side valve is opened and the cylinder begins to move up in the next vent stroke.

Valve actuation timings during a compression or expansion cycle may have a significant impact on the efficiency of the cycle. Such impact tends, in some embodiments, to be greater during an expansion cycle than during a compression cycle. During an expansion cycle, the first valve transition, as described hereinabove, is the closing of the low-side valve to begin the pre-compression. Incorrect or suboptimal timing of this valve transition may have significant consequences for the cycle. First, this valve transition is associated with the need for rapid high-side valve transition (short actuation time): as the valve is closing, the pressure in the chamber is rising quickly, resulting in throttled flow through the valve during the transition. Thus, the slower the transition, the greater the flow losses. Second, if the valve is closed later than is ideal, there will be less air in the cylinder to compress and less stroke length during which to compress it, resulting in a pressure at TDC less than the pressure in the high-side vessel. If this difference is large enough, then the pressure will be below the minimum coupling pressure and the high-side valve will be physically unable to open (i.e., the actuator will not be able to provide enough force to open the valve against the pressure difference) and the cylinder will not be able to complete the expansion cycle. If the pressure at TDC is above the minimum coupling pressure but below the pressure within the high-side component, then the high-side valve will be able to open, but gas will flow into the cylinder during the opening event without performing useful work on the piston. Contrariwise, if the low-side valve closing at the start of the pre-compression occurs too early, then the pressure within the chamber will reach the pressure within the high-side component before the piston reaches TDC, and surpass the pressure within the high-side component by the time the piston reaches TDC. In this case, more air would have been re-compressed than necessary (and less air would have been exhausted), resulting in a capacity reduction. If the pressure in the chamber reaches the high-side vessel before TDC, then the high-side valve should open when the pressures are equal rather than waiting to TDC, in order to prevent over-pressurization of the cylinder.

Once the high-side valve is open at TDC and the cylinder is in direct drive, with the piston moving down, the next transition is the closing of the high-side valve at the end of direct drive. This transition may impact both capacity and efficiency. Under perfect valve timing (i.e., closure of the high-side valve occurs at a time such that the exactly correct mass of air is drawn into the cylinder), the pressure will decrease during expansion phase and be equal to the target pressure approximately at BDC. If the valve is closed too early, the chamber will reach target pressure before BDC and will have expanded less air during the stroke than it could have (i.e., there will be a loss of capacity). If the high-side valve is closed too late, then the chamber pressure will still be above target at BDC, and the pressure difference will entail a loss once the valve is opened.

The last valve transition is at the end of the expansion stroke, when the low-side valve is opened. Ideally, the pressure at the end of the expansion stroke is equal to the target pressure exactly at BDC. If the chamber pressure drops to the target pressure before BDC, then the valve is opened to prevent the crankshaft from having to work to pull the piston down. If the piston reaches BDC before the pressure has decreased to the target, then the valve should also open. (An exception may occur if the chamber pressure is above the maximum allowable vent pressure.) This valve opening event is also impacted by the finite valve response time, in a manner similar to that described hereinabove for other valve actuation events.

It will be evident to persons familiar with pneumatics and hydraulic devices that similar considerations apply to the timing and non-ideality of valve actuation events during a compression mode of system 900. For example, at the transition between a compression stroke and a direct-fill stroke, as described hereinabove, the high-side valve of a cylinder opens. If the high-side valve is opened too late, the pressure within the chamber will exceed that within the high-side component (e.g., high-pressure storage vessel), and gas will expand from the chamber into the high-side component in a non-work-performing manner upon valve actuation. If the high-side valve is opened too soon, the pressure within the chamber will be less than that within the high-side component, and gas will expand from the high-side component into the chamber in a non-work-performing manner upon valve actuation. Valve actuation timing is similarly constrained at other transitions between the other phases of cylinder operation during a compression process.

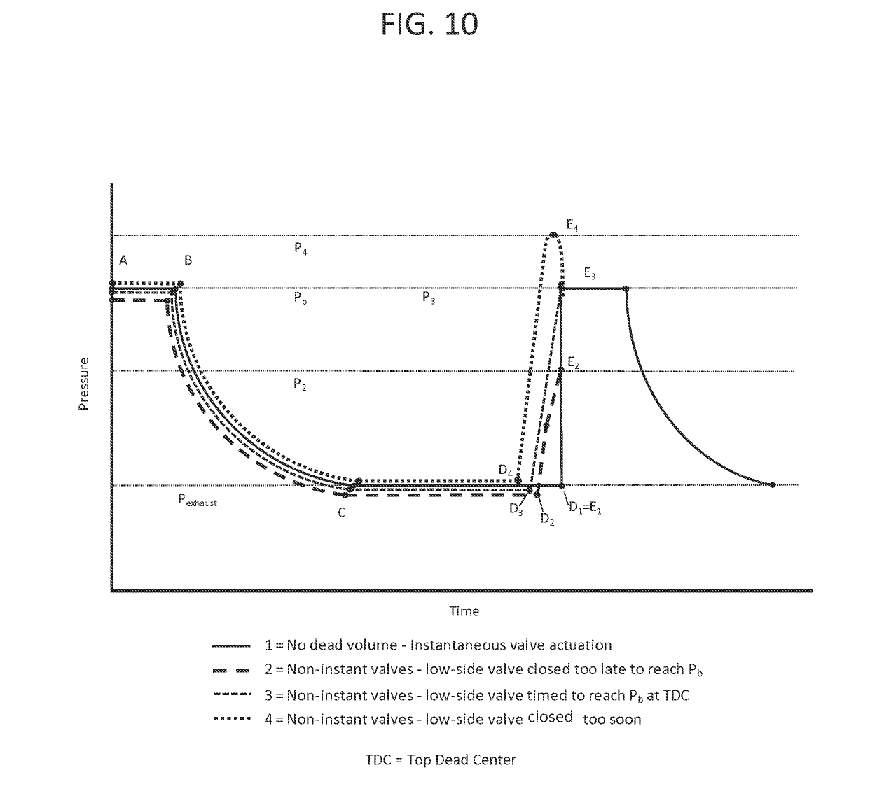

FIG. 10 is an illustrative plot of cylinder pressure as a function of time for four different expansion scenarios in an illustrative CAES system similar or even identical to the system 200 shown in FIG. 2. Points A, B, C, D, and E in FIG. 10, marked by dots, correspond to operating states of one or more components of system 200, or to changes in such operating states, as described below. In the illustrative plot shown, Point A represents an initial state of the pneumatic cylinder assembly (201 in FIG. 2) during which the piston slidably disposed therein (202 in FIG. 2) is at top dead center and the high-side valve (220 in FIG. 2) between the storage reservoir (222 in FIG. 2) and the lower-pressure cylinder assembly 201 is opened. Point B represents the end of a direct-drive phase of operation during which the high-side valve 220 between the storage reservoir 222 and the lower-pressure cylinder assembly 201 is closed and the pressure inside the cylinder assembly 201 is approximately equal to the bottle pressure P_{b} (i.e., the pressure of gas inside storage reservoir 222 in FIG. 2 (e.g., 300 psi)). Point C represents the end of an expansion stage or phase, during which the quantity of gas admitted into the cylinder assembly 201 performs work on the piston 202 slidably disposed therein, from top dead center at a bottle pressure P_{b} to bottom dead center at an exhaust pressure Pₑₓₕₐᵤₛₜ. Point C also represents the opening actuation of the low-side valve (221 in FIG. 2) between the vent to atmosphere (223 in FIG. 2) and the cylinder assembly 201 when the piston 202 is at bottom dead center. Points A, B, and C represent approximately the same operating states in all four scenarios of operation of system 200 described hereinbelow.

Four versions of Point D (labeled D₁, D₂, D₃, and D₄ to correspond to the four different valve-actuation scenarios) represent the end of the exhaust stage and beginning of a pre-compression stage; event D thus corresponds to the closing actuation of the low-side valve 221 between the vent 223 (or a lower-pressure stage) and the cylinder assembly 201. Four versions of event E (E₁, E₂, E₃, and E₄ for the four different valve-actuation scenarios) represent the end of the pre-compression stage, at which time the piston 202 is again at top dead center and the pressure inside the cylinder assembly 201 is approximately equal to the bottle pressure P_{b}. If the system is operated cyclically, Point E (any version) immediately precedes Point A and the expansion cycle may be repeated. The pressure inside the cylinder assembly 201 at the end of the pre-compression stroke (i.e., at any version of Point E) is determined by the relative timing of the closing of the low-side valve 221 (i.e., at any version of Point D).

In an idealized expansion scenario (Scenario 1, represented by a solid line in FIG. 10), there is no dead volume in the cylinder assembly 201 and all valve actuations occur instantaneously. The low-side valve 221 closes at Point D₁ when the piston 202 is at top dead center, instantaneously followed by the opening of the high-side valve 220 at Point E₁. In Scenario 1, pressurization of the cylinder assembly 201 occurs immediately and with no coupling loss, as there is no volume to pressurize at the top of stroke: this instantaneous pressurization of cylinder assembly 201, simultaneous with D₁ and E₁, is represented by the perfect verticality of the Scenario 1 line in FIG. 10 at Point D₁/E₁. Scenario 1 is shown as a reference line in FIG. 10.

In a second scenario (Scenario 2, represented by a bold dashed line in FIG. 10), dead volume exists in the cylinder assembly 201. Between Point C and Point D₁, the piston 202 performs a return stroke within the cylinder assembly 201, with the low-side valve 221 open to allow venting of gas from the upper chamber of cylinder assembly 201. At Point D₁, the low-side valve 221 is closed so that the gas remaining in the upper chamber of cylinder assembly 201 will be pressurized during the remainder of the return stroke. However, in Scenario 2 the low-side valve 221 is closed too late, trapping an insufficient amount of gas in the upper chamber of cylinder assembly 201, so when the piston 202 reaches top dead center the gas inside the upper chamber of cylinder assembly 201 is at a pressure P₂ that is lower than the storage bottle pressure P_{b}. In other words, operational Point D₂ occurs too late in time (or piston position) to allow adequate pre-compression by Point E₂ of the gas remaining in the cylinder assembly 201. Adequate pre-compression would be to approximately reservoir pressure P_{b}. When the high-side valve is opened at Point E₂, a coupling loss occurs when pressurized gas at reservoir pressure P_{b} is admitted from the storage reservoir 222 (or, in some other embodiments, the previous cylinder stage) to the lower-pressure cylinder assembly 201.

In a third scenario (Scenario 3, represented by a short-dash line in FIG. 10), point D₃, i.e., closure of the valve 221 between the vent 223 and the cylinder assembly 201, is timed correctly to enable the gas in the upper chamber of cylinder assembly 201 to reach a pressure P₃ when the piston 202 is at top dead center (point E₃), where P₃ substantially equal to the stored bottle pressure P_{b}. In other words, operational Point D₃ is at the correct time (or piston position) so that pre-compression of the gas remaining in the cylinder assembly 201 is to a pressure P₃ approximately equal to the reservoir pressure P_{b} at Point E₃. When the pressure P₃ inside the upper chamber of the cylinder assembly 202 is approximately equal to the pressure P_{b} of gas from the storage reservoir 222 (or previous cylinder stage), then there will be little or no coupling loss when valve 220 is opened, and overall system efficiency and performance will be improved.

In a fourth scenario (Scenario 4, represented by a bold dotted line in FIG. 10), the valve 221 between the vent 223 and the cylinder assembly 201 is closed (point D₄) too soon and the pressure inside the upper chamber of cylinder assembly 201 reaches a pressure P₄ higher than the stored bottle pressure P_{b} when the piston 202 reaches top dead center (Point E₄). In other words, operational Point D₄ is too early in time (or piston position) and the pre-compression of the remaining air in the upper chamber of the cylinder assembly 201 exceeds reservoir pressure P_{b} at Point E₄. When the valve 220 between the storage vessel 222 (or earlier cylinder stage) and the cylinder assembly 201 is opened (Point E₄), the difference in pressure between results in a coupling loss.

The system controller (226 in FIG. 2) may be programmed in such a manner as to receive feedback (e.g., information from measurements) from previous expansion cycles and the present state of system 200. Such feedback, whether informational or mechanical, may be used to adjust the timing of Point D, the closing of the low-side valve 221 to commence pre-compression. For example, a lookup table may be employed to set valve actuation times in response to measurements of conditions in the system. In one embodiment, the controller 226 utilizes timing information from previous expansion strokes and pressure measurements of the cylinder 201 and reservoir 222 at the completion of the pre-compression process (Point E) to set the next time of closure of valve 221. Such feedback may provide optimal performance of the expander/compressor, improving efficiency, performance, and system component lifetime. The time of opening of valve 220 and other events in the expansion cycle may also be adjusted by the system controller 226 based on feedback.

Thus, in accordance with embodiments of the invention, efficiency is maximized during a gas compression or expansion by a combination of feedforward and feedback control of the valve timing where either early or late actuation of the valves would reduce overall efficiency of the compression or expansion process. This efficiency of the valve timing may be calculated mathematically by comparing the work required with ideal valve timing to the actual measured work with the experimental or sub-optimal valve timing. Other factors that are measurable or may be calculated via measurable values and impact efficiency are the rate of pressure decrease of the storage system during the expansion process, the rate of mass storage during the compression process, and the degree of under- or over-pressurization during either process. For both the compression and expansion processes, there is typically a known ideal pressure profile that may be approached by optimizing valve timing. The ideal pressure profile may be approached by determining valve timing that minimizes or maximizes the integrated work about key points in the pressure-volume curve. Deriving and subjecting the system to such timing values constitutes the feedforward component of the valve timing controller. Correcting for modeling uncertainties, system disturbances, quickly occurring system changes, or longer-term system drift is performed by incorporating representative measurements in the valve timing controller, and this constitutes the feedback component of the valve timing controller. Each valve transition event may be optimized for efficiency as described herein. For example, in opening a high-side valve at the end of a compression stroke to begin direct fill, an early actuation would cause gas to travel backwards from the high-side reservoir into the cylinder, reducing efficiency of the compression process, and late actuation would result in a pressure spike, increasing work required to complete the compression and causing a loss of useful energy when the valve opens and the air in the cylinder pressure equalizes with storage. Thus, in short, as utilized herein, “maximizing efficiency” of a compression or expansion process entails valve-timing optimization to minimize or eliminate lost work during an expansion of a particular amount of gas or minimizing or eliminating additional work required to compress a particular amount of gas.

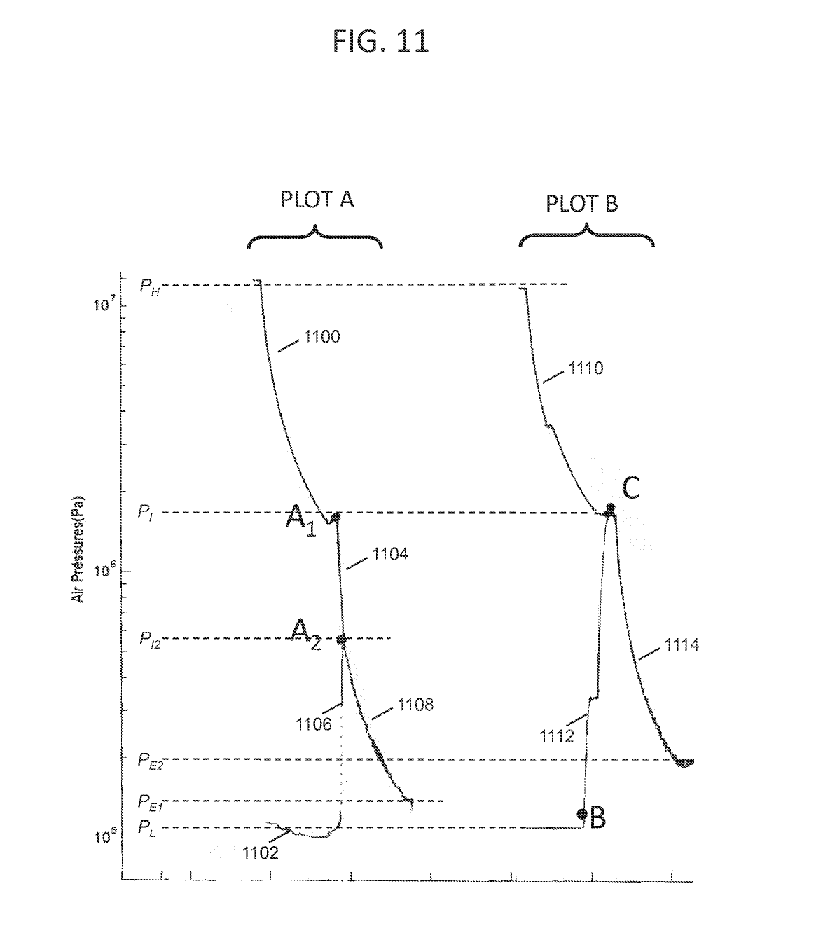

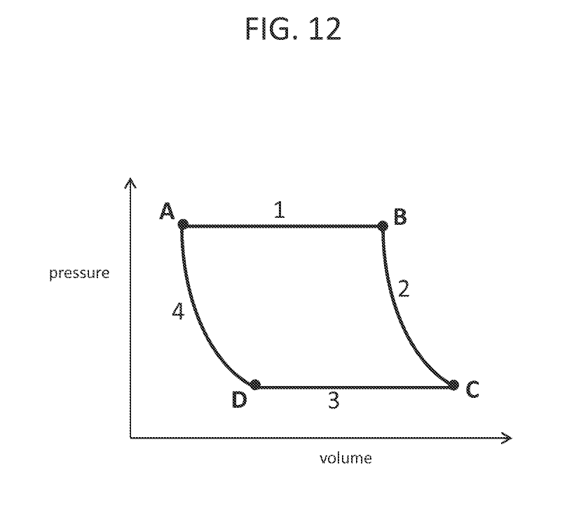

FIG. 11 is a graphical display of experimental test data from an expansion process involving expansion of gas first in a high-pressure pneumatic cylinder and then in a low-pressure pneumatic cylinder. That is, in the physical system from which the data in FIG. 11 were drawn, a first, high-pressure cylinder expanded gas from a high pressure P_{H} to an intermediate pressure P_{I} while a second, low-pressure cylinder either (a) did not pre-compress the gas in its expansion chamber from a preexisting default pressure P_{L} (PLOT A in FIG. 11) or (b) pre-compressed the gas in its expansion chamber from the preexisting default pressure P_{L} to the intermediate pressure P_{I} (PLOT B in FIG. 12).

In PLOT A, the pressure in the expansion chamber of the first, high-pressure cylinder as a function of time during expansion of the chamber's contents from P_{H} to P_{I} is indicated by curves 1100 and 1104, and the pressure in the expansion chamber of the second, low-pressure cylinder as a function of time is indicated by curves 1102, 1106, and 1108. Expansion of the gas in the high-pressure cylinder is indicated by curve 1100. The approximately constant pressure of the gas in the low-pressure cylinder, being exhausted by a return stroke concurrently with the expansion recorded by curve 1100, is indicated by curve 1102.

At the moment corresponding to labeled point A₁, a valve is opened to place the expansion chamber of the first, high-pressure cylinder in fluid communication with the expansion chamber of the second, low-pressure cylinder. Because the two chambers are at different pressures at that time (i.e., the gas in the high-pressure cylinder chamber is at P_{I} and the gas in the low-pressure cylinder chamber is at P_{L}), after point A₁ (valve opening) the pressure within the chamber of the high-pressure cylinder decreases rapidly to an intermediate pressure P_{I2} (curve 1104) while the pressure within the chamber of the low-pressure cylinder increases rapidly to the intermediate pressure P_{I2} (curve 1106). By point A₂, shortly after A₁, the pressures in the two cylinder chambers have equilibrated. The rapid expansion indicated by curve 1104 performs no work on any mechanical component of the system and therefore entails a loss of available energy (i.e., a dead-volume loss). At point A₂, an expansion occurs in the expansion chamber of the low-pressure cylinder, from P_{I2} to some low end pressure P_{E1} (curve 1108).

In PLOT B, the pressure in the expansion chamber of the first, high-pressure cylinder as a function of time during expansion of the chamber's contents from P_{H} to I₂ is indicated by curve 1110, and the pressure in the expansion chamber of the second, low-pressure cylinder as a function of time during pre-compression of the gas in the low-pressure cylinder chamber from P_{L} to approximately P_{I} is indicated by curve 1112. Prior to labeled point B, the low-pressure cylinder is performing an exhaust stroke, and gas is being expelled from the expansion chamber of the low-pressure chamber at approximately constant pressure P_{L} through an open exhaust valve. At the moment corresponding to point B, the valve permitting gas to exit the expansion chamber of the low-pressure cylinder is closed, trapping a fixed quantity of gas within the chamber at pressure P_{L}. This quantity of gas is then compressed to pressure P_{I} as indicated by curve 1112.

At point C, the pressure in the expansion chamber of the low-pressure cylinder is approximately equal to the pressure P_{I} in the expansion chamber of the high-pressure cylinder and a valve is opened to place the two chambers in fluid communication with each other. Because the two chambers are at approximately equal pressures, there is no significant equilibration upon valve opening (i.e., there is no curve in PLOT B corresponding to the expansion of gas in the high-pressure cylinder indicated by curve 1104 in PLOT A) and thus little or no energy loss due to equilibration. Subsequent to point C, an expansion occurs in the expansion chamber of the low-pressure cylinder, from P_{I} to some low end pressure P_{E2} (curve 1114). In FIG. 11, end pressure P_{E2} is not equal to end pressure P_{E1}, but this is not a necessary result of the pre-compression process illustrated in FIG. 11 and end pressure P_{E2} may have any of a range of values in accordance with embodiments of the present invention.

FIG. 12 is an illustrative plot of the ideal pressure-volume cycle in a cylinder operated as either a compressor or expander. FIG. 12 provides explanatory context for subsequent figures. Instantaneous and perfectly timed valve actuations are presumed for the system whose behavior is represented in FIG. 12. The horizontal axis represents volume (increasing rightward) and the vertical axis represents pressure (increasing upward). In FIG. 12, the volume represented by the horizontal axis is the volume of the expansion/compression chamber of a cylinder assembly that is similar or identical to cylinder 201 in FIG. 2 and is being operated as either an expander or compressor. The four curves in FIG. 12 (labeled 1, 2, 3, and 4) form a cyclic loop; each curve represents one of the four distinct phases of operation described above for both compression and expansion. For a cylinder operating as a compressor, Curves 1 through 4 are traversed counterclockwise (e.g., in order 1, 4, 3, 2), where Curve 1 represents the direct-fill phase; Curve 2 represents the compression stroke; Curve 3 represents the intake stroke; and Curve 4 represents the regeneration stroke. For a cylinder operating as an expander, Curves 1 through 4 are traversed clockwise (e.g., in order 1, 2, 3, 4). Curve 1 represents the direct-fill phase; Curve 2 represents the expansion stroke; Curve 3 represents the exhaust stroke; and Curve 4 represents the precompression stroke. Points A, B, C, and D in FIG. 12 represent valve transition events. As each Event (A, B, C, or D) is traversed during cyclic operation of the cylinder, the valve actuations that occur at each point depend on whether the cylinder is being operated as an expander or compressor. Specifically, if the cylinder is being operated as a compressor, at Event A a high-side valve V1 (220 in FIG. 2) is closed and a low-side valve V2 (221 in FIG. 2) remains closed; at Event D, V1 remains closed and V2 is opened; at Event C, V1 remains closed and V2 is opened; and at Event B, V1 is opened while V2 remains closed. If the cylinder is being operated as an expander, at Event A, V1 is opened and V2 remains closed; at Event B, V1 is closed and V2 remains closed; at Event C, V1 remains closed and V2 is opened; at Event D, V1 remains closed and V2 is closed.

As will be made clear by subsequent figures, the effects of finite (non-ideal, nonzero) actuation times for valves V1 and V2 at all valve transitions in FIG. 12 tend to decrease system capacity and/or efficiency and to alter the shapes of Curves 1, 2, 3, and 4. Also, mistiming of valve transitions in FIG. 12 may decrease system capacity and/or efficiency. An optimal actuation timing exists for each valve actuation event under any given conditions of operation; this optimal time will, in general, change as the conditions under which the system is being operated change (e.g., as the pressure in a high-pressure gas storage reservoir gradually increases or decreases).

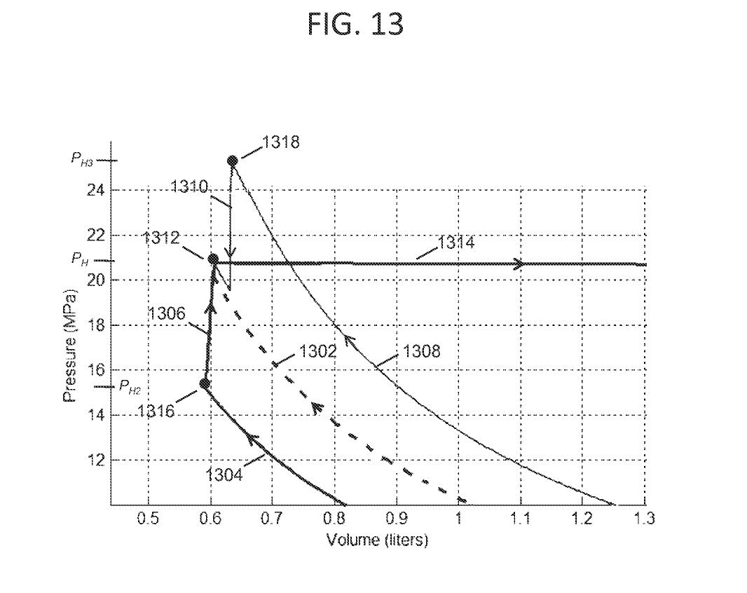

FIG. 13 is an illustrative plot of cylinder chamber pressure as a function of cylinder chamber volume for three different expansion scenarios in an illustrative CAES system similar or even identical to the system 200 shown in FIG. 2. FIG. 13 shows the effects of early, correctly timed, and tardy closure of valve V2 in the transition (Event D in FIG. 12; not shown in FIG. 13) from intake phase to pre-compression phase (i.e., from Curve 3 to Curve 4 in FIG. 12). The three scenarios depicted in a pressure-volume plot in FIG. 13 greatly resemble the scenarios depicted in a pressure-time plot in FIG. 10, as shall be explained below.

The region of the expander's pressure-volume cycle portrayed in FIG. 13 corresponds to Point A in FIG. 12 as defined for an expansion process. (In a non-ideal system, events occurring during a valve transition event do not occur without changes of pressure and volume, and so cannot be represented by a single point in a pressure-volume plot. The instant that an actuated valve is commanded to transition is one representation of the start of a valve transition.) The dashed curve 1302 represents the pressure-volume history of the gas within the cylinder chamber during the latter part of the pre-compression phase (Curve 4 in FIG. 12) for a scenario (the Correct V2(D) Closure scenario) in which closure of V2 (the low-pressure valve, 221 in FIG. 2) in the transition from vent phase to pre-compression phase occurs at an optimal time. The Correct V2(D) Closure scenario corresponds to the curve passing through points D₂ and E₂ in FIG. 10.

The thick solid curves 1304, 1306 represent the pressure-volume history of the gas during the latter part of the pre-compression phase for a scenario (the Late V2(D) Closure scenario) in which closure of V2 in the transition from vent phase to pre-compression phase is tardy. The Late V2(D) Closure scenario corresponds to the curve passing through points D₃ and E₃ in FIG. 10. The thin solid curves 1308, 1310 represent the pressure-volume history of the gas during the latter part of the pre-compression phase for a scenario (the Early V2(D) Closure scenario) in which closure of V2 in the transition from vent phase to pre-compression phase occurs too early. The Early V2(D) Closure scenario corresponds to the curve passing through points D₄ and E₄ in FIG. 10.

All curves in FIGS. 13-16 are traversed, in time, in the sense shown by the arrowheads attached to each curve.

In the systems whose behavior is partly represented by FIGS. 13-16, the gas volume of the high-side component (e.g., high-pressure storage reservoir 222 in FIG. 2) that is connected to the cylinder through V1 is presumed to be sufficiently large that exchanges of air between the high-side component and the cylinder chamber do not substantially change the pressure P_{H} of the gas within the high-side component.

In the Correct V2(D) Closure Scenario, closure of V2 traps the correct amount of air in the cylinder chamber to produce at TDC a chamber pressure approximately equal to that the pressure P_{H} within the high-side component. In FIG. 13, P_{H} is approximately 21.5 megapascals (MPa). At point 1312, when the gas in the chamber approximates pressure P_{H}, V1 is opened; since both the gas in the high-side component and the gas in the chamber are at or near to P_{H}, the pressure of the gas in the chamber does not change significantly. Subsequently, gas is transferred during direct-drive phase at approximately constant P_{H} from the high-side component to the chamber as the piston descends in the cylinder (solid curve 1314). The effects of dead volume during the transition from pre-compression phase to direct-drive phase are minimized or even nonexistent in the Correct V2(D) Closure Scenario.

In the Late V2(D) Closure Scenario, closure of V2 traps insufficient air in the chamber to produce at TDC a chamber pressure approximately equal to P_{H}. Instead, the gas in the chamber achieves some lower pressure P_{H2}; in FIG. 13, P_{H2} is approximately 15 MPa. At point 1316, V1 opens; since the gas in the high-side component is at a higher pressure (P_{H}) than the gas in the chamber (P_{H2}), gas from the high-side component rapidly enters the chamber, raising the pressure of the gas in the chamber while the volume of the chamber does not change significantly. This pressure-volume change at near-constant volume is represented by curve 1306. Potentially useful pressure energy is lost during this non-work-performing expansion of gas from the high-pressure component into the chamber, i.e., a dead-volume loss occurs. At the end of curve 1306, the gas in the chamber reaches point 1312, after which the Late V2(D) Closure Scenario coincides with the Correct V2(D) Closure Scenario (curve 1314).

In the Early V2(D) Closure Scenario, closure of V2 traps more air in the chamber than is needed to produce at TDC a pressure approximately equal to P_{H}. Instead, the gas achieves some higher pressure P_{H3}; in FIG. 13, P_{H3} is approximately 25 MPa. At point 1318, V1 opens; since the gas in the high-side component is at a lower pressure (P_{H}) than the gas in the chamber (P_{H3}), gas from chamber rapidly enters the high-side component, lowering the pressure of the gas in the chamber while its volume does not change significantly. This pressure-volume change at near-constant volume is represented by curve 1310. Potentially useful pressure energy is lost during this non-work-performing expansion of gas from the chamber into the high-pressure component, i.e., a dead-volume loss occurs. At the end of curve 1318, the gas in the chamber is at point 1312, after which the Early V2(D) Closure Scenario coincides with the Correct V2(D) Closure Scenario (curve 1314).

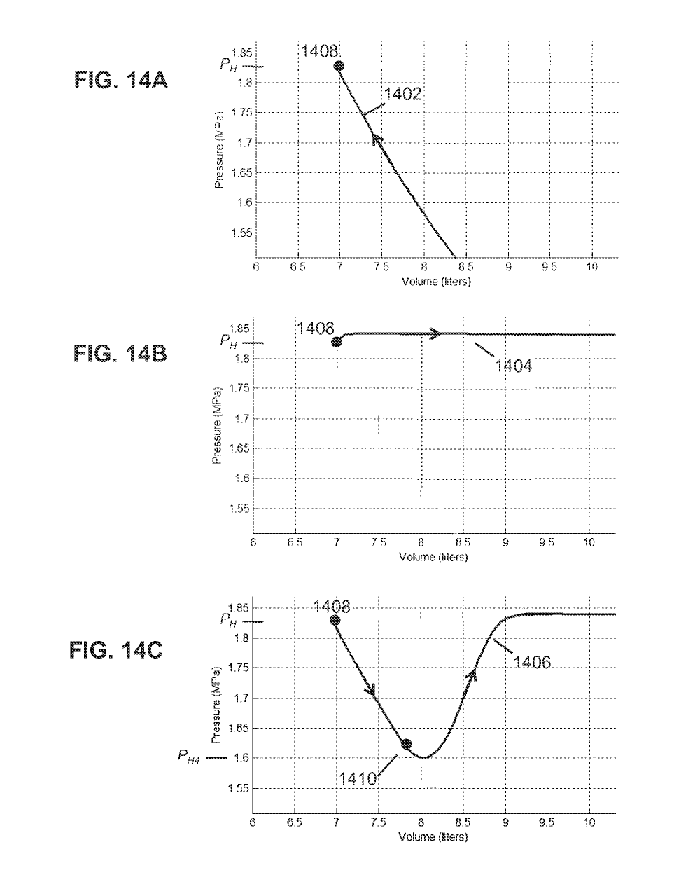

FIGS. 14A-14C are illustrative plots of cylinder chamber pressure as a function of cylinder chamber volume for two different expansion scenarios in an illustrative CAES system similar or even identical to the system 200 shown in FIG. 2. The two scenarios depicted in FIGS. 14A-14C are the Correct V1(A) Opening Scenario and the Late V1(A) Opening Scenario. The region of the expander's pressure-volume cycle portrayed in FIGS. 14A-14C corresponds to Point A in FIG. 12 as defined for an expansion process. Valves V1 and V2 are defined as for FIG. 13. FIGS. 14A-14C show the effects of correctly timed and tardy opening of valve V1 in the transition from pre-compression phase to direct-drive phase (i.e., from Curve 4 to Curve 1 in FIG. 12). It is presumed that in the scenarios depicted in FIGS. 14A-14C, the previous valve transition (Event D in FIG. 12) was optimally made. Three separate figures, FIGS. 14A-14C, depicting curves 1402, 1404, and 1406 respectively, are employed to avoid partial obscuration of curve 1402 by curve 1406.

Curve 1402 of FIG. 14A represents the volume-pressure history of both scenarios until point 1408 is reached. Thereafter, the two scenarios diverge. In the Correct V1(A) Opening Scenario, V1 is opened at point 1408, just as the cylinder reaches TDC. Because pre-compression was optimally performed, the pressure in the chamber approximates P_{H} and there is little or no gas exchange between the chamber and the high-pressure component when V1 is opened, and subsequent to point 1408 gas is vented during a direct-drive phase at approximately constant P_{H} from the high-side component to the chamber as the piston descends in the cylinder (curve 1404 in FIG. 14B). In FIGS. 14A-14C, P_{H} is approximately 1.82 MPa. The effects of dead volume during the transition from pre-compression phase to direct-drive phase are minimal or nonexistent in the Correct V1(A) Opening Scenario.

In the Late V1(A) Opening Scenario, V1 is not opened at point 1408, when the piston is at TDC, but remains closed for a time thereafter. As the piston descends, the pressure-volume state of the gas in the chamber thus begins to retrace curve 1402 in the opposite direction (left-hand portion of curve 1406, FIG. 14C): that is, the gas trapped in the chamber simply begins to re-expand. At point 1410 (FIG. 14C), at which the gas in the chamber has achieved some pressure P_{H4} significantly lower than P_{H}, V1 is opened. Gas then enters the chamber from the high-side component, raising the pressure of the gas in the chamber to P_{H} while the volume of the chamber is increasing (rising portion of curve 1406). Potential energy is lost and less work is done during this non-work-performing expansion of gas from the high-pressure component into the chamber, i.e., a dead-volume loss occurs.

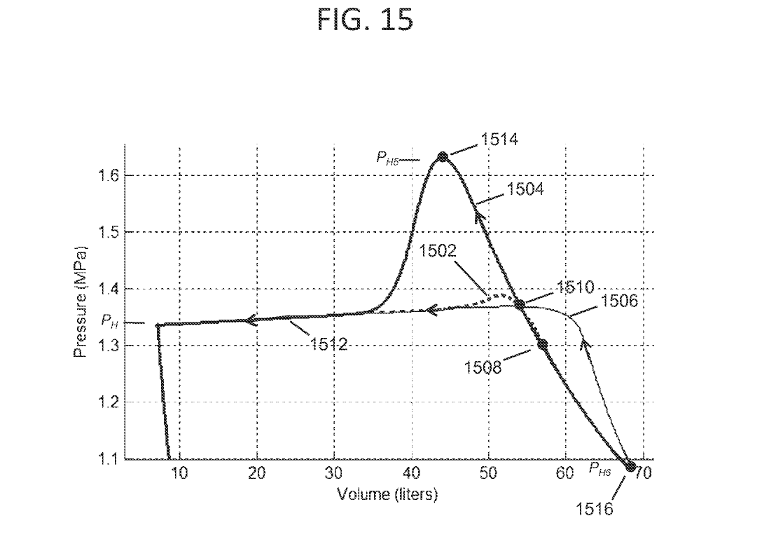

FIG. 15 is an illustrative plot of cylinder chamber pressure as a function of cylinder chamber volume for three different compression scenarios in an illustrative CAES system similar or even identical to the system 200 shown in FIG. 2. FIG. 15 shows the effects of early, correctly timed, and tardy opening of valve V1 in the transition (Event B in FIG. 12, defined for compression mode) from compression phase to direct-fill phase (i.e., from Curve 2 to Curve 1 in FIG. 12). The region of the expander's pressure-volume cycle portrayed in FIG. 15 corresponds to Point B in FIG. 12 as defined for a compression process.

The dotted curve 1502 (partly obscured by thick solid curve 1504) represents the pressure-volume history of the gas within the cylinder chamber during the latter part of the compression phase (Curve 2 in FIG. 12) for a scenario (the Correct V1(B) Opening scenario) in which opening of V1 in the transition from compression phase to direct-fill phase occurs at an optimal time. The thick solid curve 1504 represents the pressure-volume history of the gas in the chamber during the latter part of the compression phase for a scenario (the Late V1(B) Opening scenario) in which opening of V1 in the transition from compression phase to direct-fill phase is tardy. The thin solid curve 1506 represents the pressure-volume history of the gas during the latter part of the compression phase for a scenario (the Early V1(B) Opening scenario) in which opening of V1 in the transition from compression phase to direct-fill phase occurs too early.

In the system whose behavior is partially depicted in FIG. 15, V1 and V2 have nonzero actuation times. Therefore, the optimal time of opening of V1 (i.e., the timing of V1 opening for the Correct V1(B) Opening scenario) occurs at point 1508, before the pressure in the chamber reaches P_{H}. At point 1508 the gas in the cylinder chamber has not yet achieved the pressure P_{H} of the gas in the high-pressure component, but only a small amount of gas is throttled through the partly-open valve into the chamber as the pressure-volume state of the gas in the chamber evolves from point 1508 to point 1510, at which time the pressure in the chamber approximates P_{H}. A small amount of pressure overshoot may occur (represented by the small hump in curve 1502); subsequently, gas is exhausted during direct-fill phase at approximately constant P_{H} from the cylinder chamber to the high-side component as the piston continues to ascend in the cylinder (curve 1512). The effects of dead volume during the transition from pre-compression phase to direct-drive phase are minimal or nonexistent in the Correct V1(B) Opening Scenario.

In the Late V1(B) Opening scenario, V1 is opened at point 1514, by which time the gas in the chamber has reached a pressure P_{H5}, significantly higher than P_{H}. After the tardy opening of V1, gas in the chamber transfers into the high-pressure component as the pressure in the chamber decreases (left-hand side of large hump in curve 1514). Energy is lost during this non-work-performing expansion of gas from the chamber into the high-pressure component, i.e., a dead-volume loss occurs.

A similar curve would be traced even if the valve started to transition open at point 1510 when the pressures are equal, due to the nonzero time to open the valve and pressure rise that occurs with a partially open valve. Notably, in systems employing a pressure-driven check valve for V1 rather than an actuated valve, a pressure-volume history similar to that of the Late V1(B) Opening scenario (curve 1504), although not necessarily so extreme, typically occurs in every compression cycle, as an overpressure (e.g., P_{H5} or some other pressure significantly higher than P_{H}) must be achieved on the chamber side of V1 with respect to the high-pressure-component side of V1 in order for V1 to be actuated. The use of actuated valves rather than check valves in CAES systems is thus advantageous in this, as well as in other, respects.

In the Early V1(B) Opening scenario, V1 is opened at point 1516, by which time the gas in the chamber has reached a pressure of only P_{H6}, significantly lower than P_{H}. After the early opening of V1, gas in the high-pressure component flows into the chamber as the pressure in the chamber increases (right-hand side of curve 1506). Energy is lost during this non-work-performing expansion of gas from the high-pressure component into the chamber, i.e., a dead-volume loss occurs.

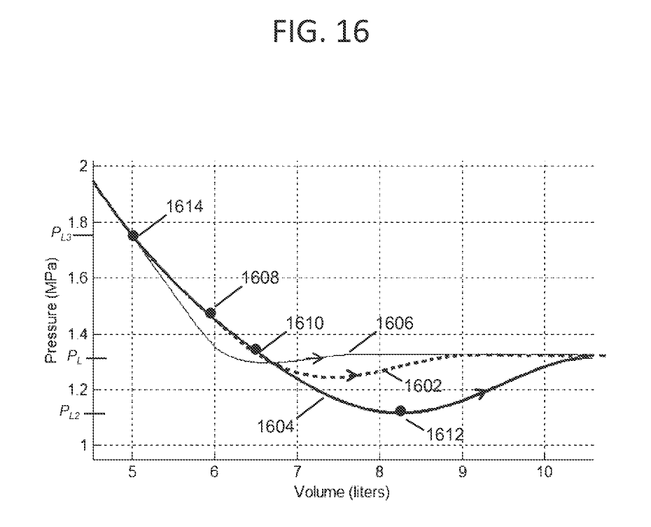

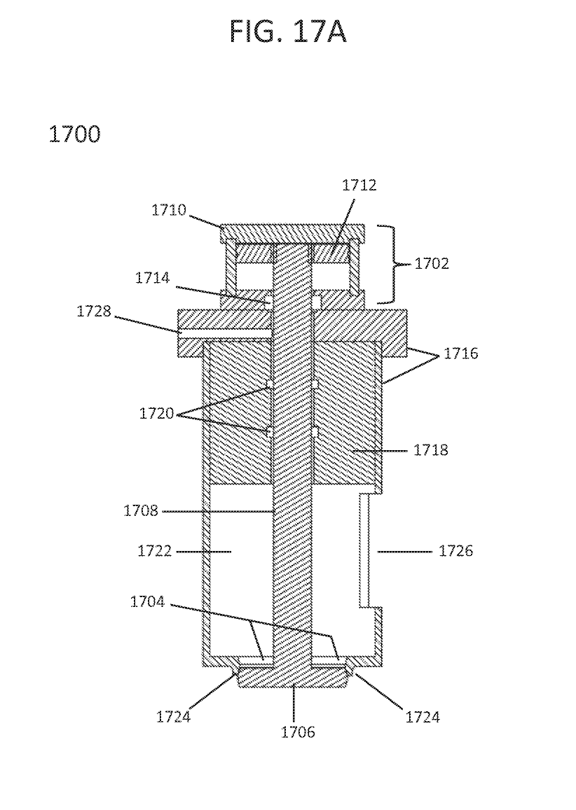

FIG. 16 is an illustrative plot of cylinder pressure as a function of cylinder volume for three different compression scenarios in an illustrative CAES system similar or even identical to the system 200 shown in FIG. 2. FIG. 16 shows the effects of early, correctly timed, and tardy opening of valve V2 in the transition (Event D in FIG. 12, defined for compression mode) from regeneration phase to intake phase (i.e., from Curve 4 to Curve 3 in FIG. 12). The region of the expander's pressure-volume cycle portrayed in FIG. 16 corresponds to Point D in FIG. 12 as defined for a compression process.

The dotted curve 1602 represents the pressure-volume history of the gas within the cylinder chamber during the latter part of the regeneration phase (Curve 4 in FIG. 12) for a scenario (the Correct V2(D) Opening scenario) in which opening of V2 in the transition from regeneration phase to intake phase occurs at an optimal time. The thick solid curve 1604 represents the pressure-volume history of the gas in the chamber during the latter part of the compression phase for a scenario (the Late V2(D) Opening scenario) in which opening of V2 in the transition from regeneration phase to intake phase is tardy. The thin solid curve 1606 represents the pressure-volume history of the gas during the latter part of the compression phase for a scenario (the Early V2(D) Opening scenario) in which opening of V2 in the transition from regeneration phase to intake phase occurs too early.

In the system whose behavior is partially depicted in FIG. 16, V1 and V2 have nonzero actuation times. Therefore, the optimal time of opening of V2 (the timing of V2 opening for the Correct V2(D) Opening scenario) occurs at point 1608, before the pressure in the chamber approximates P_{L} (the pressure of the low-pressure component that communicates with the cylinder through V2, e.g., vent 223 in FIG. 2). The gas in the cylinder chamber has not yet decreased to the pressure P_{L} of the gas in the low-pressure component, but only a small amount of gas is throttled through the partly-open valve V2 into the chamber as the pressure-volume state of the gas in the chamber evolves from point 1608 to point 1610, at which time the pressure in the chamber approximates P_{L}. A small amount of pressure overshoot may occur (dip in curve 1602); subsequently, gas is admitted to the chamber during the intake phase at approximately constant P_{L} from the low-side component to the chamber as the piston continues to descend in the cylinder. The effects of dead volume during the transition from regeneration phase to intake phase are minimal or nonexistent in the Correct V2(D) Opening Scenario.

In the Late V2(D) Opening scenario, V2 is opened at point 1612, by which time the gas in the chamber has decreased to a pressure of P_{L2}, significantly lower than P_{L}. After the tardy opening of V2, gas from the low-pressure component flows into the chamber as the pressure in the chamber increases (right-hand side of large dip in curve 1604). Energy is lost during this non-work-performing expansion of gas into the chamber from the low-pressure component: i.e., a dead-volume loss occurs.

Notably, in systems employing a pressure-driven check valve for V2 rather than an actuated valve, a pressure-volume history similar to that of the Late V2(D) Opening scenario (curve 1604) typically occurs in every compression cycle, as an underpressure (e.g., P_{L2} or some other pressure significantly lower than P_{L}) must be achieved on the chamber side of V2 with respect to the low-pressure-component side of V2 in order for V2 to be actuated. The use of actuated valves rather than check valves in CAES systems is thus advantageous in this, as well as in other, respects.

In the Early V2(D) Opening scenario, V2 is opened at point 1614, by which time the gas in the chamber has only declined to a pressure of P_{L3}, significantly higher than P_{L}. After the early opening of V2, gas in the chamber exits to the low-pressure component as the pressure in the chamber decreases (left-hand side of curve 1606). Energy is lost during this non-work-performing expansion of gas from chamber into the low-pressure component, i.e., a dead-volume loss occurs.

It will be clear to persons familiar with the sciences of hydraulics and pneumatics that considerations similar to those described above with reference to FIGS. 10 and 13-16 also pertain to optimal, early, and late valve actuation at valve transition events not explicitly depicted herein, for both compression and expansion modes of operation of a CAES system. Optimization by the means described of valve actuations at all valve transition events in a CAES system is contemplated and within the scope of the invention. In brief, wherever two or more volumes of gas are to be brought into fluid communication with each other in the course of operating a CAES system, optimally timed valve actuations will generally be those that occur at moments calculated to bring the volumes of gas into fluid communication with each other when their pressures are approximately equal.

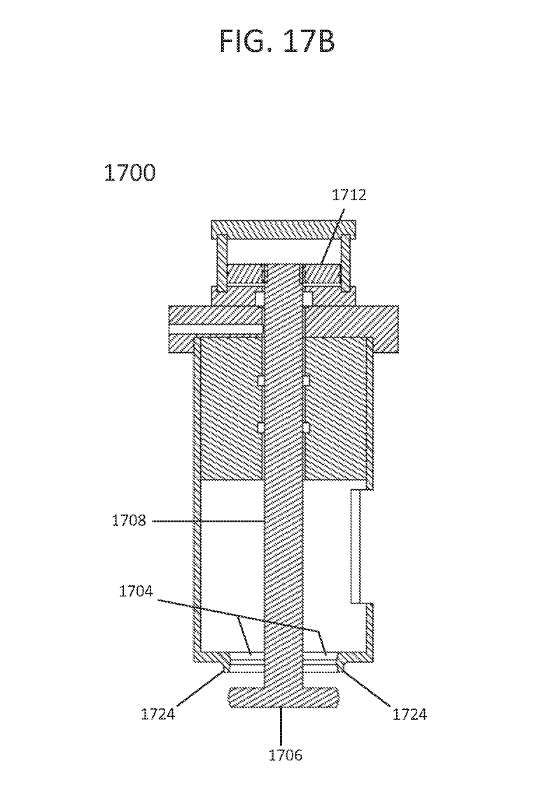

FIG. 17A is a schematic cross-sectional drawing of the major components of an illustrative poppet valve 1700 that employs a hydraulic actuation mechanism 1702 to open and close a port (or opening) 1704 by moving a disc (or valve member) 1706 connected to a stem (or rod) 1708. In other embodiments, the valve 1700 is actuated by electrical and/or mechanical actuation systems. The valve may include a mechanical or pneumatic spring (not shown) to bias the valve towards closing, cushion opening forces, and/or replace or supplement the closing actuation mechanism. The valve 1700 shown in FIG. 17A is a low-side valve, as defined above.

As depicted in FIG. 17A, the actuation mechanism 1702 features a hydraulic cylinder 1710 containing a piston 1712. The piston 1712 is connected to stem 1708 that passes out of the actuation mechanism 1702 through a gasket 1714, passes into the body 1716 of the valve 1700, and passes through a ring 1718 and additional gaskets 1720. Exiting the ring 1718, the stem 1708 passes into a flow chamber 1722 and through port 1704. The stem 1708 is connected to disc 1706. The port 1704 is surrounded by a lip or flange 1724 termed the “seat.” The seat is shaped and sized so that the entire periphery of the disc 1706 may make tight contact with the surface of the seat 1724. A second port 1726 is typically permanently open and may be connected to piping (not shown). The stem 1708, piston 1712, disc 1706, port 1704, and seat 1724 may be circular in cross-section or may have some other cross-sectional form.

As depicted in FIG. 17A, the low-side valve 1700 is closed. That is, the stem 1708, actuator piston 1712, and disc 1706 are in a position that places the disc 1706 in firm contact with the seat 1724, occluding the port 1704. If greater force is exerted by fluid on the outside of the disc 1706 than by fluid within the flow chamber 1722, the valve will remain closed even if no force is applied to the stem 1708 by the actuation mechanism 1702. (The disc 1706 is too large to pass through the port 1704.) A drain 1728 is provided for fluid leakage that may occur from the actuation mechanism 1702 through gasket 1714 or from chamber 1722 through gasket 1720.

The valve 1700 may be designed to open at a predetermined pressure differential determined by the area ratios on either side of disc 1706. The valve 1700 may be responsive to a control system (e.g., control system 122 or control system 226) that actuates the valve at a time just prior to the valve checking open due to the predetermined pressure differential such that the pressure drop across the valve 1700 stays below a threshold value (e.g., <2% of the absolute pressure), improving the efficiency of the energy storage system. Further, the actuation of the valve 1700 may be such as to bias the valve towards opening or closing, and the actual hydraulic actuation may need not occur at the precise time of valve opening or closing. The control system may operate on a feedback loop that adjusts valve timing based on pressure drop across the valve 1700 on a previous valve opening or closing occurrence or based on another feedback measurement such as actuation time of a previous occurrence. A pneumatic spring (not shown) may be included in the valve 1700 to further bias the valve 1700 towards closing. The pressure within the pneumatic spring may be adjusted during operation of the system and may even be vented for part of a cylinder stroke in order to achieve optimal valve performance.

FIG. 17B depicts the high-side valve 1700 in a fully open position. That is, the stem 1708, actuator piston 1712, and disc 1706 are in a position that places the disc 1706 as far out of contact with the seat 1724 as the dimensions of the mechanism permit, opening the port 1704.

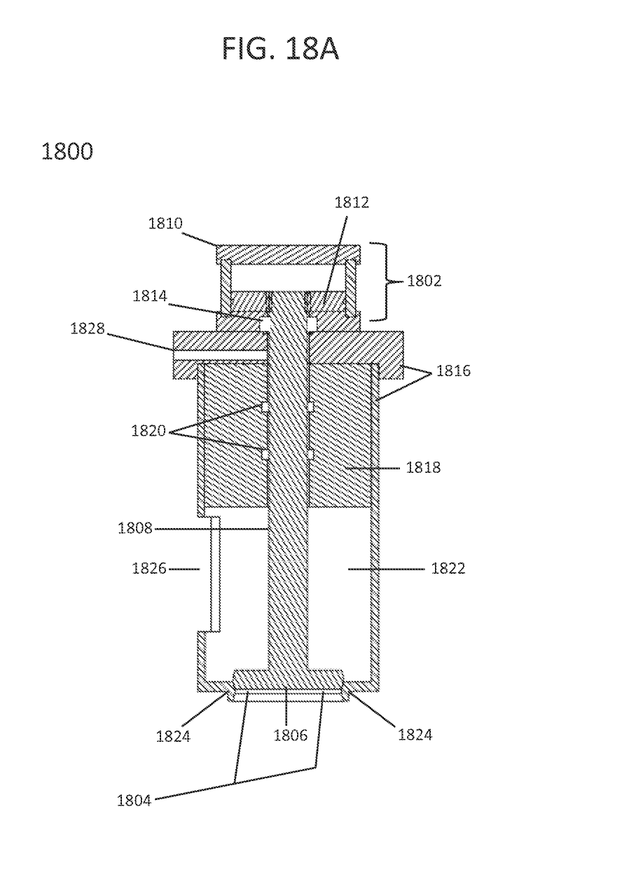

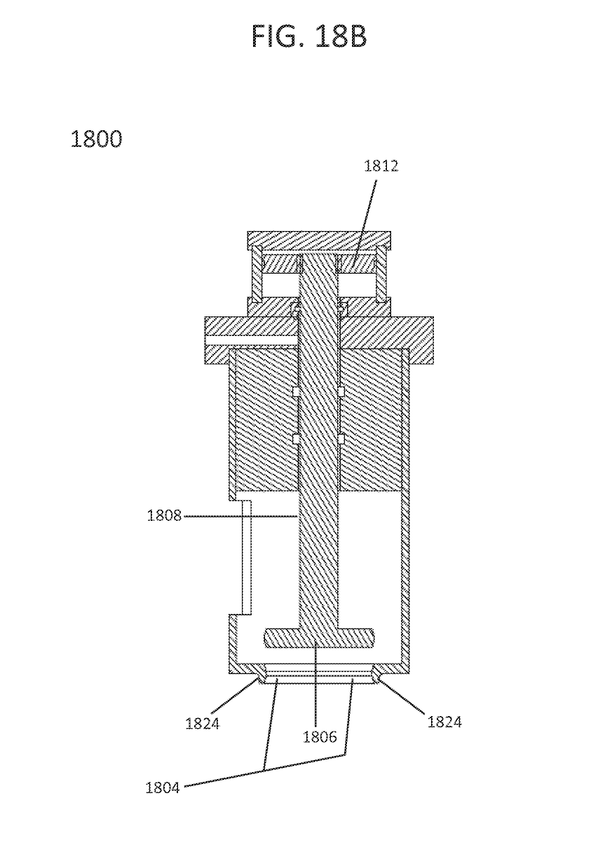

FIG. 18A is a schematic cross-sectional drawing of the major components of an illustrative poppet valve 1800 that employs a hydraulic actuation mechanism 1802 to open and close a port 1804 by moving a disc 1806 connected to a stem 1808. In other embodiments, the valve 1800 is actuated by electrical and/or mechanical actuation systems. The valve 1800 shown in FIG. 18A is a high-side valve, as defined above.

As depicted in FIG. 18A, the actuation mechanism 1802 features a hydraulic cylinder 1810 containing a piston 1812. The piston 1812 is connected to stem 1808 that passes out of the actuation mechanism 1802 through a gasket 1814, passes into the body 1816 of the valve 1800, and passes through a ring 1818 and additional gaskets 1820. Exiting the ring 1818, the stem 1808 passes into a flow chamber 1822 and through port 1804. The stem 1808 is connected to disc 1806. The port 1804 is surrounded by a lip or flange 1824 termed the “seat.” The seat is shaped and sized so that the entire periphery of the disc 1806 may make tight contact with the surface of the seat 1824. A second port 1826 is typically permanently open and may be connected to piping (not shown). The stem 1808, piston 1812, disc 1806, port 1804, and seat 1824 may be circular in cross-section or may have some other cross-sectional form.

As depicted in FIG. 18A, the high-side valve 1800 is closed. That is, the stem 1808, actuator piston 1812, and disc 1806 are in a position that places the disc 1806 in firm contact with the seat 1824, occluding the port 1804. If less force is exerted by fluid on the outside of the disc 1806 than by fluid within the flow chamber 1822, the valve will remain closed even if no force is applied to the stem 1808 by the actuation mechanism 1802. (The disc 1806 is too large to pass through the port 1804.) A drain 1828 is provided for fluid leakage that may occur from the actuation mechanism 1802 through gasket 1814 or from the chamber 1822 through gasket 1820.

The valve 1800 may be designed to open at a predetermined pressure differential determined by the area ratios on either side of disc 1806. The valve 1800 may be responsive to a control system (e.g., control system 122 or control system 226) that actuates the valve at a time just prior to the valve checking open due to the predetermined pressure differential such that the pressure drop across the valve 1800 stays below a threshold value (e.g. <2% of the absolute pressure), improving the efficiency of the energy storage system. Further, the actuation of the valve 1800 may be such as to bias the valve towards opening or closing, and the actual hydraulic actuation may need not occur at the precise time of valve opening or closing. The control system may operate on a feedback loop that adjusts valve timing based on pressure drop across the valve 1800 on a previous valve opening or closing occurrence or based on another feedback measurement such as actuation time of a previous occurrence. A pneumatic spring (not shown) may be included in the valve 1800 to further bias the valve 1800 towards closing. The pressure within the pneumatic spring may be adjusted during operation of the system and may even be vented for part of a cylinder stroke in order to achieve optimal valve performance.

FIG. 18B depicts the high-side valve 1800 in a fully open position. That is, the stem 1808, actuator piston 1812, and disc 1806 are in a position that places the disc 1806 as far out of contact with the seat 1824 as the dimensions of the mechanism permit, opening the port 1804.

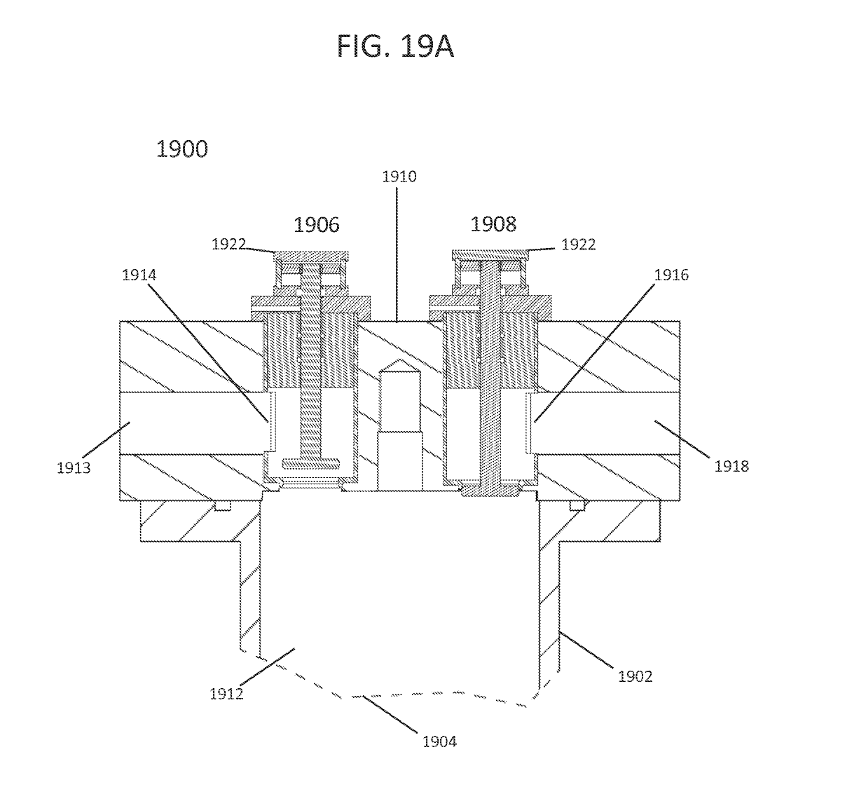

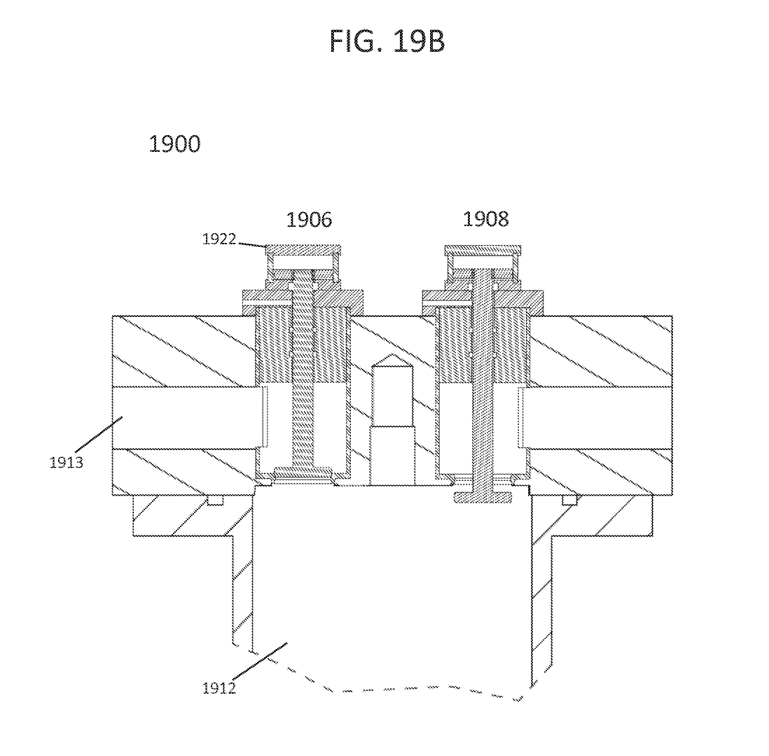

FIG. 19A is a schematic cross-sectional drawing of several components of a cylinder assembly 1900. FIG. 19A depicts one end of a pneumatic or pneumatic-hydraulic cylinder 1902. Portions of the cylinder 1902 and cylinder assembly 1900 are not depicted in FIG. 19A, as indicated by the irregular dashed line 1904. A high-side valve 1906 and a low-side valve 1908 are integrated with the head 1910 (end cap) of the cylinder 1902. That is, the valves 1906, 1908 are in this embodiment not connected to a chamber 1912 within the cylinder 1902 by piping, but communicate directly with the chamber 1912. High-side valve 1906 is substantially identical to the valve depicted in FIGS. 18A and 18B. Low-side valve 1908 is substantially identical to the valve depicted in FIGS. 17A and 17B. The valves may be sized in a manner to allow low pressure drop (e.g., <2% of absolute pressure) when passing two-phase flow (i.e., both gas and liquid) including a substantial volume fraction of liquid (e.g., >20% of the total volume is liquid). The mass of the valves and actuation forces may be sized such that actuation time is rapid with respect to cylinder stroke time (e.g., <5% of total stroke time).

As depicted in FIG. 19A, a port 1914 of high-side valve 1906 communicates with a channel 1913 within the cylinder head 1910. The channel 1913 may in turn be connected with piping that places channel 1913 in fluid communication with a store of gas at high pressure (e.g., 3,000 psi). Port 1916 of low-side valve 1908 communicates with a channel 1918 within the cylinder head 1910. The channel 1918 may in turn be connected with piping that places channel 1918 in communication with a vent to the atmosphere (not shown), with a store of pressurized gas (not shown), or with the inlet of another pneumatic or pneumatic-hydraulic cylinder (not shown).

In the state of operation depicted in FIG. 19A, high-side valve 1906 is open to admit gas from a high-pressure store (not shown) into chamber 1912 of the cylinder 1902. Low-side valve 1908 is closed, and, barring the application of sufficient force by the actuation mechanism 1920 of the valve 1908, will remain closed by the pressure within the chamber 1912, which is high relative to the pressure within the channel 1918.

In a state of operation (not shown) subsequent to the state depicted in FIG. 19A, valves 1906 and 1908 are both closed. In this state, gas within the chamber 1912 may be expanded, performing work on a piston (not shown) within the cylinder 1902. Valve 1906 may be configured so that if for any reason pressure of the fluid in chamber 1912 exceeds that of the gas in the high-pressure store by some predetermined amount, valve 1906 opens, acting as a pressure-relief to prevent overpressurization of the cylinder 1902.

FIG. 19B depicts the cylinder assembly of FIG. 19A in another state of operation. In the state of operation depicted in FIG. 19B, high-side valve 1906 is closed and, barring the application of sufficient force by the actuation mechanism 1922 of the valve 1906, will be kept closed by the pressure within the channel 1913, which is high relative to the pressure within the chamber 1912. Low-side valve 1908 is open to allow transfer (e.g., venting) of gas from chamber 1912. When sufficient gas is transferred from chamber 1912 in this state of operation, the cylinder assembly 1900 may be returned to the state of operation depicted in FIG. 19A in order to admit another installment of high-pressure gas to chamber 1912.

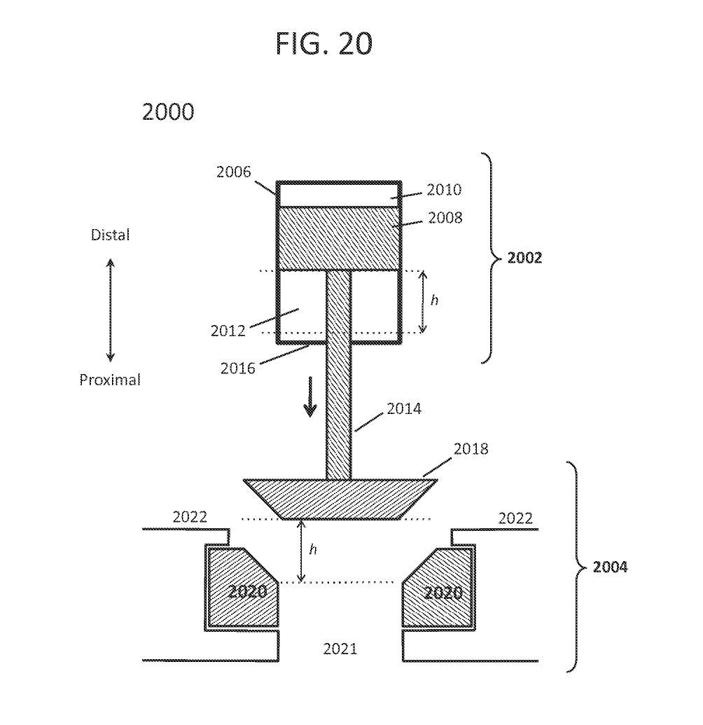

FIG. 20 is a schematic drawing of components of an illustrative system 2000 that includes a hydraulic activation cylinder 2002 and a poppet valve 2004. Various components of system 2000 have been omitted for clarity. System 2000 does not employ the invention but displays a context in which various embodiments of the invention may be employed. System 2000 is shown in a vertical orientation for illustrative purposes in FIG. 20, but other orientations may be employed.

Activation cylinder 2002 includes a cylinder 2006, a piston 2008 that divides the interior of cylinder 2006 into a distal chamber 2010 and a proximal chamber 2012, and a stem 2014 connected to piston 2008. The chambers 2010, 2012 are fluid-filled; appropriate ports, valves, piping, and other devices (not shown) enable the controlled entry and exit of a substantially incompressible fluid from the chambers 2010, 2012, the pressure of which may drive the piston 2008 in the distal or proximal direction. The stem 2014 passes through the proximal end-cap 2016 of the cylinder 2006 and into the body (not shown) of the poppet valve 2004. Within the poppet valve 2004, the stem 2014 is attached to a disc 2018. The valve 2004 comprises a beveled seat 2020 of a suitable material recessed into an annular groove or channel surrounding an opening 2021 in a cylinder end-cap 2022 (shown in part). The valve 2004 is closed when the disc 2018 is in contact with the seat 2020, and fully open when the disc 2018 is distance h from the seat 2020. When valve 2004 is open, fluid may move through the opening 2021 and the gap between the disc 2018 and seat 2020. The piston 2008, stem 2014, and disc 2018 move in unison; movement of the disc 2018 through distance h is driven by movement of the piston 2008 through distance h.

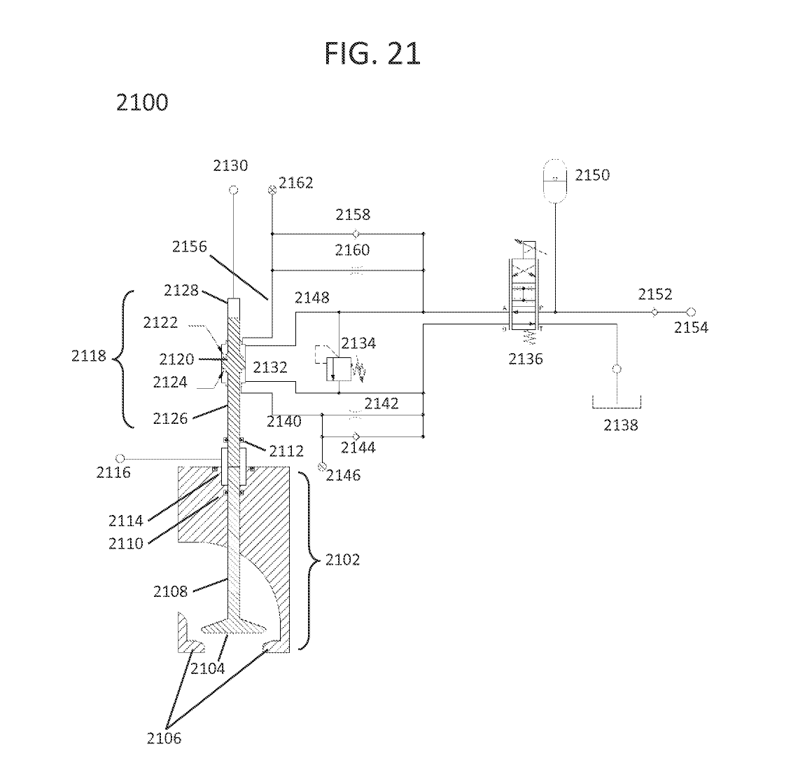

FIG. 21 is a schematic drawing of various components of an illustrative assembly 2100 embodying aspects of the invention. Assembly 2100 is depicted in a vertical orientation in FIG. 21 but may be oriented otherwise (e.g., horizontally) in various other embodiments. Assembly 2100 includes a high-side poppet valve 2102 that controls fluid communication between the interior of a pneumatic cylinder (not shown) and some source or destination for gas (not shown) exterior to the pneumatic cylinder. Valve 2102 features a disc 2104; when the disc 2104 is in contact with the seat 2106, valve 2102 is closed. Disc 2104 is connected to a stem 2108, which passes through two gaskets 2110, 2112. Between gaskets 2110 and 2112 is a catchment chamber 2114 whose function shall be explained below. The catchment chamber 2114 communicates with a connection 2116, e.g., a connection to a source of fluid at high pressure, low pressure, or variable pressure.

The poppet valve 2102 is actuated by an actuation mechanism 2118. The actuation mechanism 2118 includes a piston 2120 that divides its interior into two chambers, an upper chamber 2122 and a lower chamber 2124. A stem 2126 is connected to the piston 2120 and also to the stem 2108 of the poppet valve 2102 (as shown in FIG. 21, in some embodiments stems 2126, 2108 are portions of a single stem extending through actuation mechanism 2118 and valve 2102). The stem 2126 is extended upward into an equalization chamber 2128 in order that the effective area of piston 2120 presented to hydraulic pressure in the upper chamber 2122 may be approximately equal to the effective area of piston 2120 presented to hydraulic pressure in the lower chamber 2124. Equalization chamber 2128 communicates with a connection 2130 to a body of fluid whose pressure may either be constant or may vary according to the state of operation of assembly 2100. For example, connection 2130 may communicate with a fluid at atmospheric pressure or a fluid set to (1) a pressure that balances some balance pressure acting on the disc 2104 and stem 2108 of the poppet valve 2102, or (2) a high pressure in order to assist in accelerating the piston 2120 of the actuation mechanism 2118 downward.

By means of a connection 2116 to a relatively low-pressure body of fluid (not shown), the pressure within the catchment chamber 2114 is typically near atmospheric pressure and is preferably kept less than or (at most) approximately equal to both (a) the pressure within the poppet valve 2102 and (b) the pressure within the lower chamber 2124 of the actuation cylinder 2118. Fluids (e.g., gas, hydraulic fluid, heat-transfer liquid) that manage to bypass the gaskets 2110 and 2112 therefore do not pass from the poppet valve 2102 to the actuator cylinder 2118 or vice versa (and hence causing undesired mixing of different bodies of fluids and/or fluid types within assembly 2100 and any system including assembly 2100), and instead accumulate in the catchment chamber 2114 and may be removed therefrom through the connection 2116.

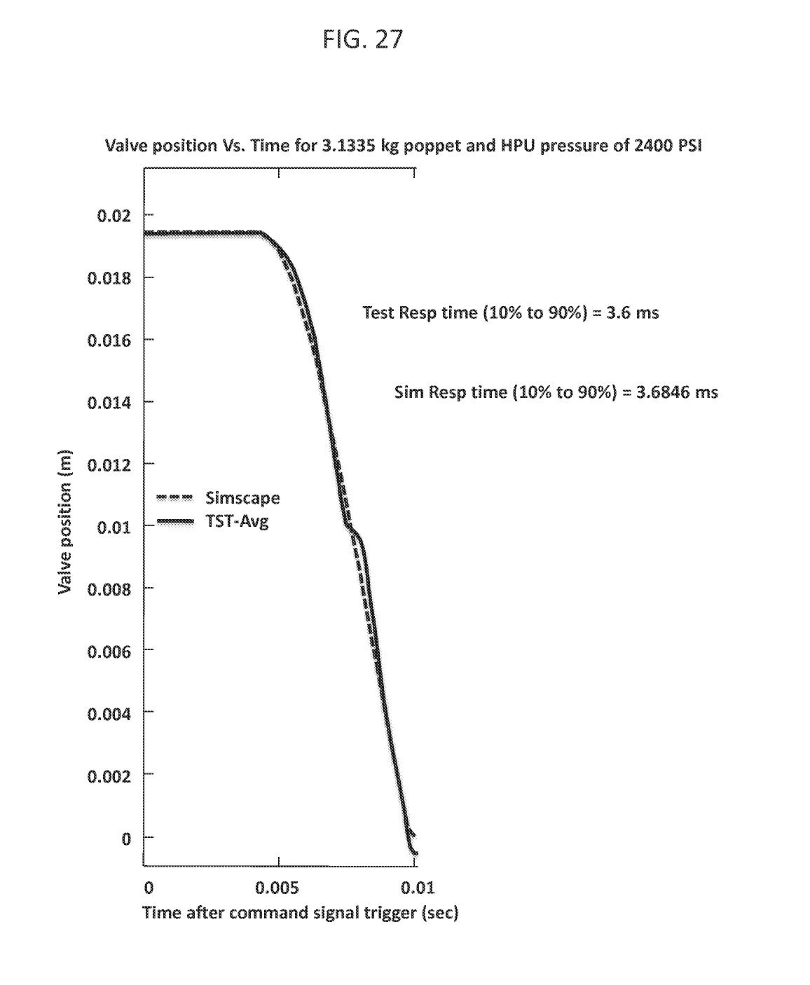

In the illustrative embodiment depicted in FIG. 21, the areas A₁-A₅ on the lower face of the poppet-valve disc 2104 (A₁), the upper face of the disc 2104 (A₂), the lower face of the actuator piston 2120 (A₃), the upper face of the actuator piston 2120 (A₄), and the upper end of the actuator stem 2126 (A₅, exposed to fluid in chamber 2128), upon which pressure is exerted by fluid, are chosen to allow for efficient actuation of the poppet valve 2102 through appropriate sizing and balancing of forces acting along the stem 2126 in various states of operation. In general, the lower face of the poppet-valve disc area, A₁, will be equivalent to the valve opening area. For a valve opening diameter of 7.5 cm, the poppet valve disc area would be approximately A₁=4.42×10⁻³ m². The actuator stem area, A₅, is typically large enough to withstand actuation, impact, and other forces, typically 5% to 10% of the poppet-valve disc area, A₁. The area A₂ is equal to the difference between the poppet-valve disc area and the poppet-valve stem area, or A₁−A₅ in the case where the poppet-valve stem area is equal to the actuator stem area. The actuator piston areas, A₃ and A₄, are sized (considering actuator hydraulic fluid pressure) to provide sufficient force, and thus acceleration, of the poppet-valve in order to achieve the desired poppet-valve actuation time; the actuator piston areas are typically on the order to 5% to 15% of the area of poppet-valve disc area, A₁. In the examples shown in FIGS. 27-29, A₃=0.095A₁ and A₅=0.064A₁.

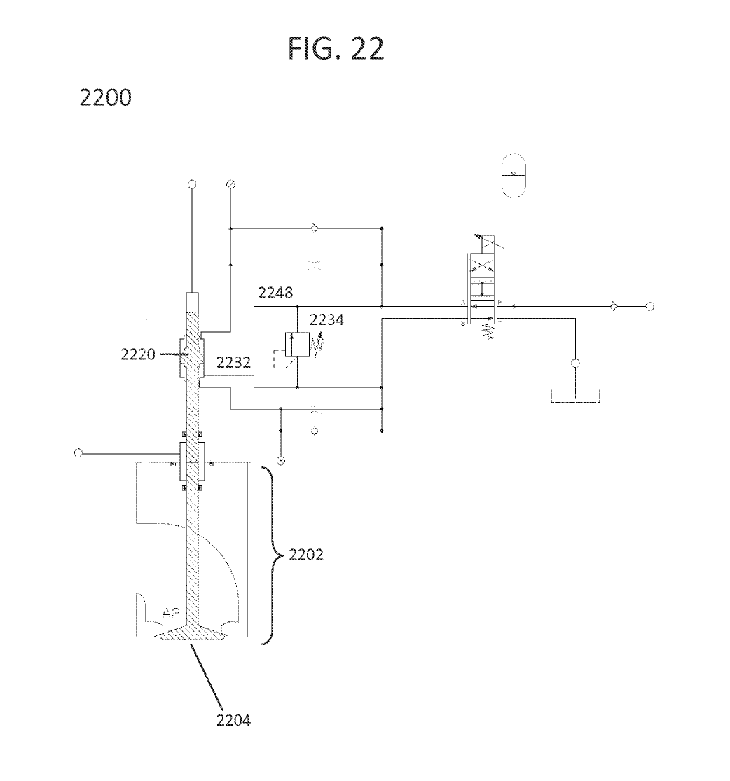

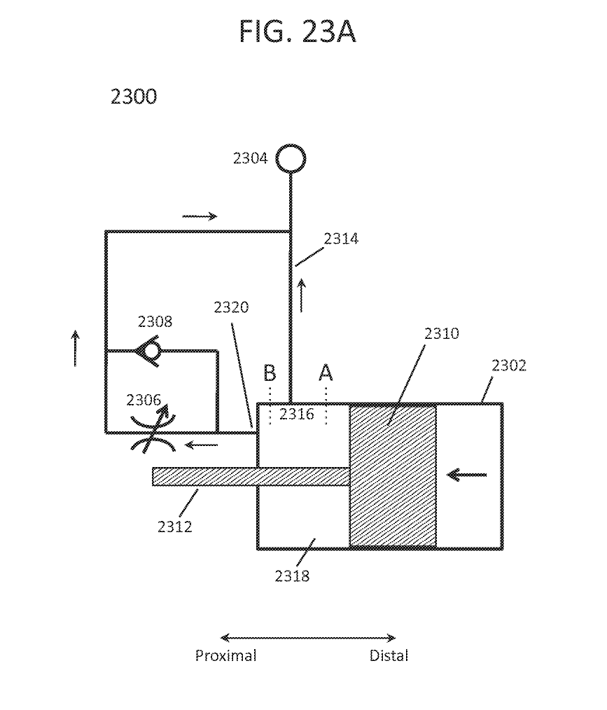

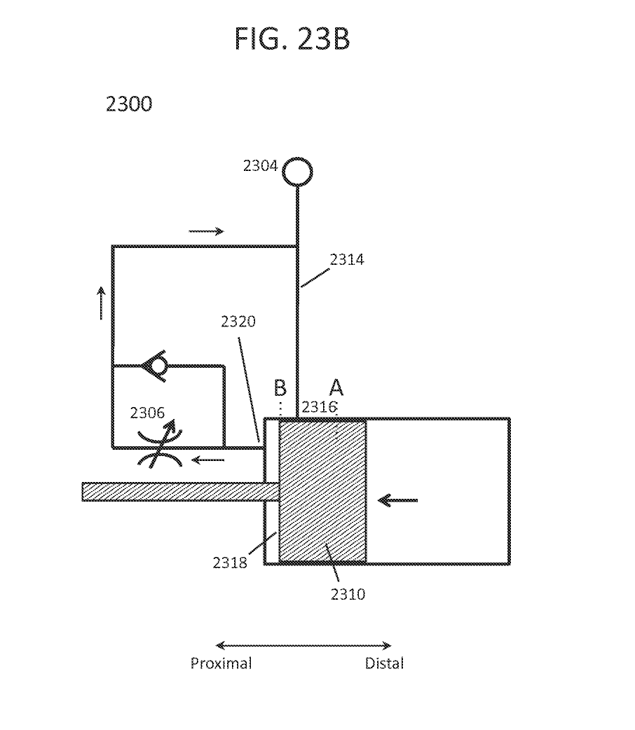

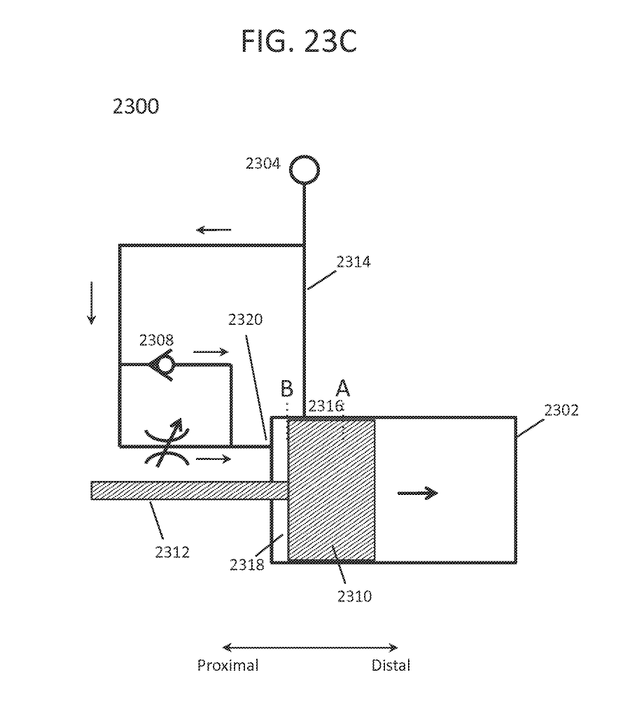

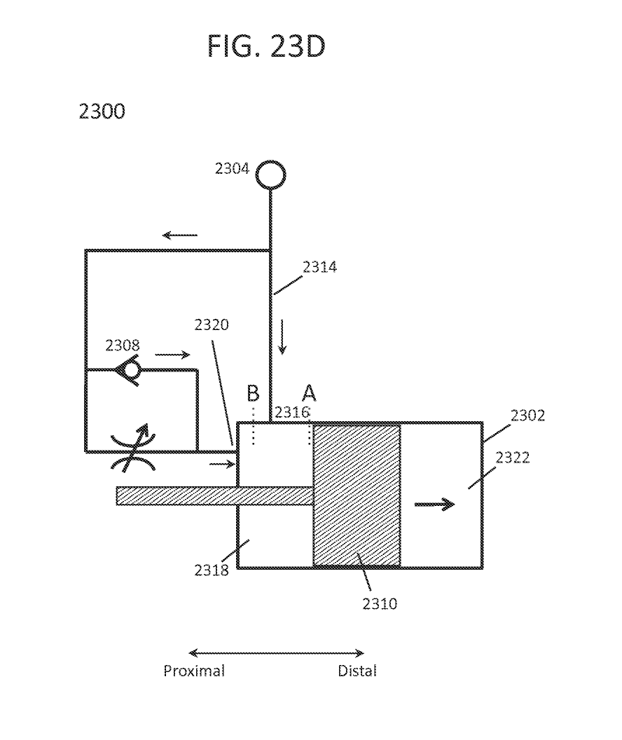

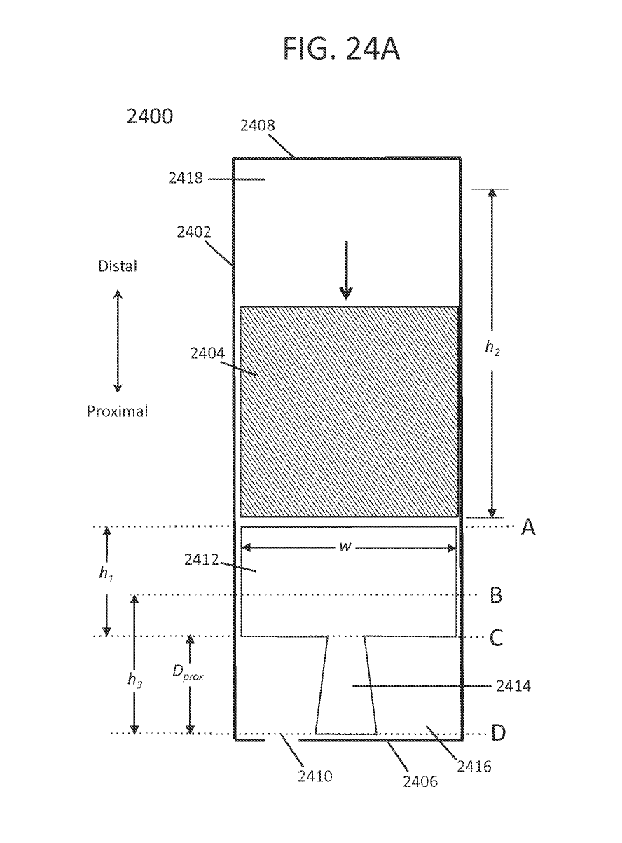

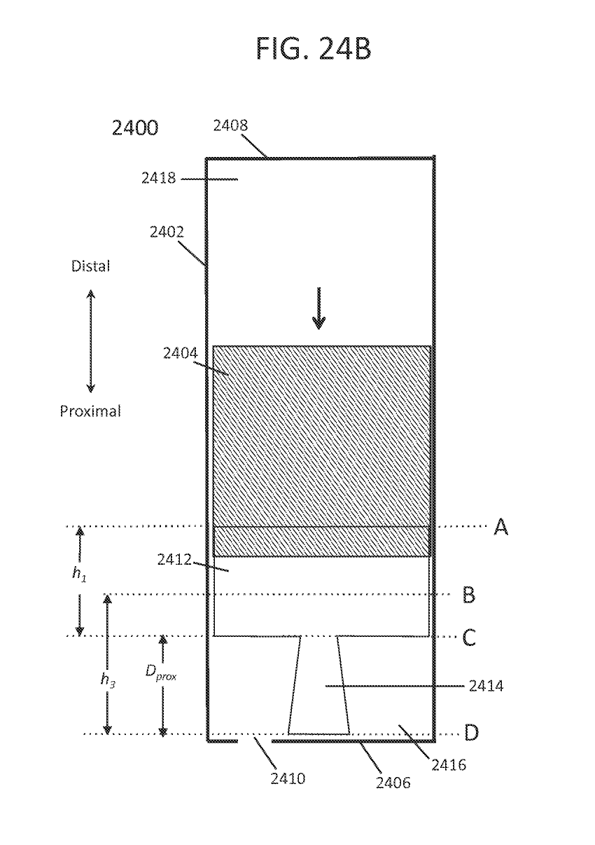

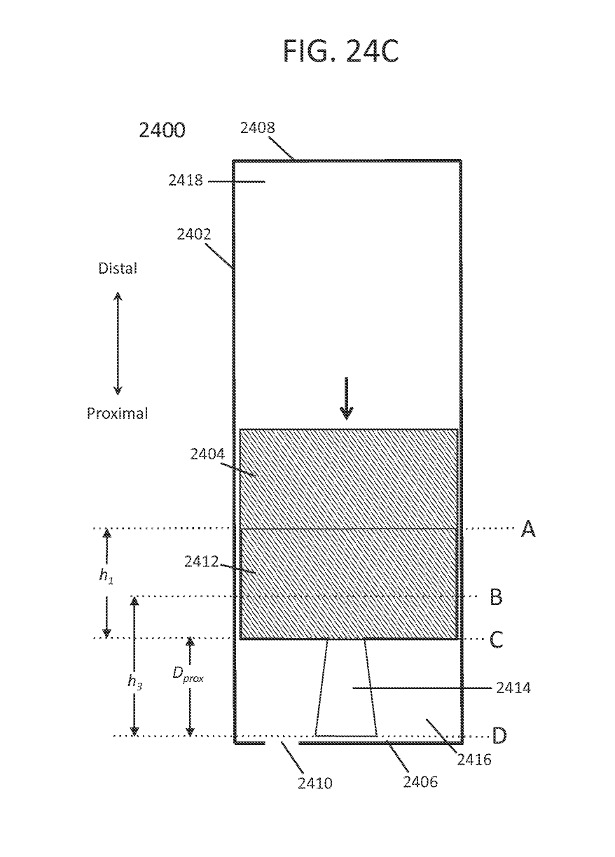

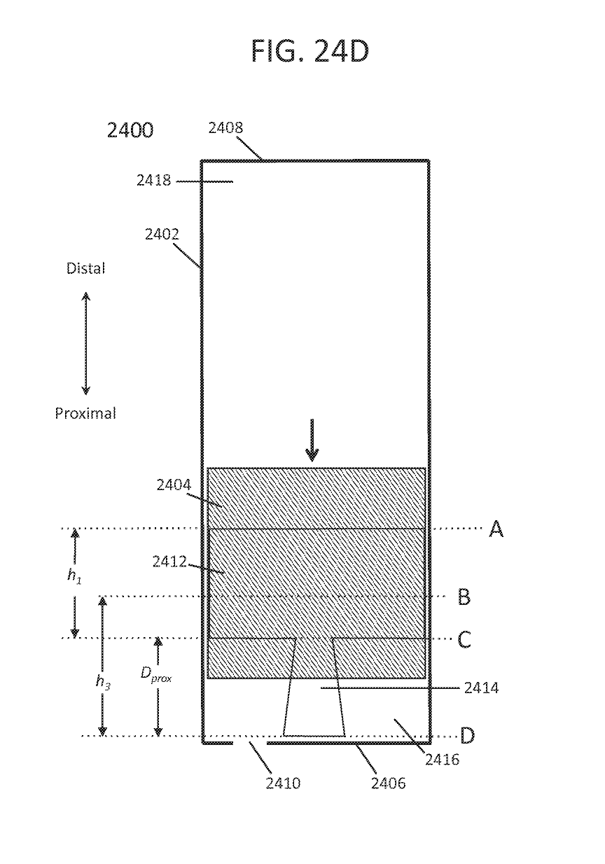

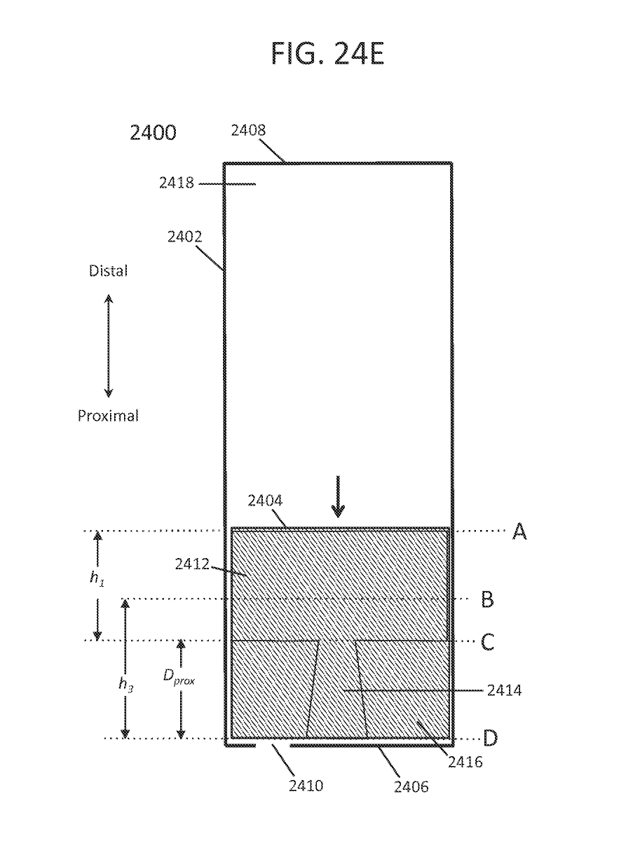

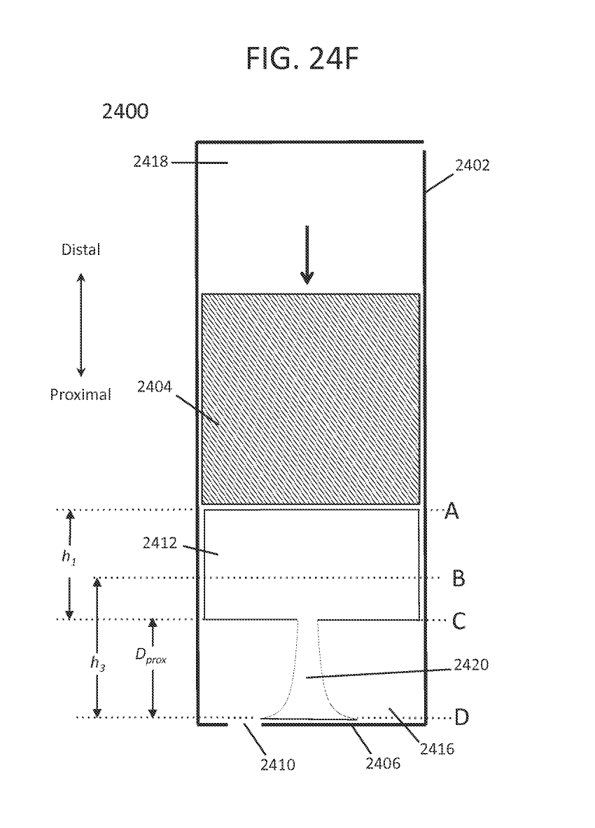

Assembly 2100 features contrivances for closing poppet valve 2102 rapidly while not allowing the disc 2104 to impact the seat 2106 at unacceptably high velocity, as well as for opening poppet valve 2102 rapidly while not allowing actuator piston 2120 to impact the end-cap of upper chamber 2122 at unacceptably high velocity. Below, the state of operation of assembly 2100 depicted in FIG. 21 is described in detail. In FIG. 22, an assembly 2200 similar to assembly 2100 but featuring a low-side poppet valve is depicted. In FIGS. 23A-23D and 24A-24E, the principles of operation of contrivances for achieving rapid valve operation with controlled impact velocities within assemblies 2100 and 2200, as well as within various other embodiments, are elucidated.

Piping 2132 conducts fluid between the lower actuation chamber 2124 and the outflow side of a pressure-relief valve 2134, which remains closed in ordinary states of operation of the assembly 2100. Piping 2132 also conducts fluid to and from a master valve 2136, which governs the direction of operation of the actuator 2118, i.e., opening (upward motion) or closing (downward motion). In the position of valve 2136 depicted in FIG. 21, actuator 2118 is closing, and fluid may be directed from lower chamber 2124 through piping 2132 and valve 2136 to a reservoir of low-pressure fluid 2138.

Lower chamber 2124 is also connected to piping 2140, which conducts fluid between lower chamber 2124 and piping 2132 through (a) a variable or fixed flow resistance 2142 and (b) an optional connection 2146, e.g., a connection to a source of fluid at high pressure, low pressure, or variable pressure. Fluid may flow from piping 2132 to piping 2140 and chamber 2124 via check valve 2144.

Piping 2132 communicates with lower actuator chamber 2124 through an opening in the side surface (lateral interior surface) of chamber 2124. This opening is sized, shaped, and located in the side of chamber 2124 in such a manner that when piston 2120 has reached its downward limit of motion, the opening is occluded, and fluid essentially cannot enter or leave the lower chamber 2124 through piping 2132. Moreover, the sizing, shaping, and location of the occludable opening in chamber 2124 may be such as to contribute to controlled deceleration of piston 2120 when the piston 2120 approaches the lower end cap of chamber 2124. The manner in which the character of an occludable opening may contribute to controlled deceleration of piston 2120 will be elucidated in reference to FIGS. 23A-23D and 24A-24E.

Piping 2140 typically communicates with chamber 2124 through an opening in the end cap (lower surface) of chamber 2124; thus, fluid may typically enter or leave the lower chamber 2124 regardless of the position of piston 2120.

Components of assembly 2100 associated with operation of the upper actuator chamber 2122 are similar to those just described in association with operation of the lower actuator chamber 2124. For example, piping 2148 conducts fluid between the upper actuation chamber 2122 and the inflow side of the pressure-relief valve 2134. When the pressure at the inflow side of valve 2134 exceeds that at the outflow side of valve 2134 by some specified opening difference, valve 2134 opens and remains open until the difference in pressure between its two sides drops below some specified closing difference. Relief valve 2134 allows poppet valve 2102 to open without damage to components of assembly 2100 when pressure within the pneumatic cylinder (not shown), i.e., pressure exerted upward on the disc 2104, exceeds some predetermined threshold. For example, an attempt to compress a relatively incompressible liquid in the upper chamber of the pneumatic cylinder, i.e., a possible hydrolock condition, may produce a pressure difference between the two chambers of the actuator cylinder 2118 sufficient to cause relief valve 2134 to open. Valve 2134 prevents hydrolock in the pneumatic cylinder and other conditions of overpressure in the pneumatic cylinder.

Piping 2148 also conducts fluid between upper actuator chamber 2122 and the master valve 2136. In the position of valve 2136 depicted in FIG. 21, actuator 2118 is closing, and fluid at high pressure may be directed to upper chamber 2122 through check valve 2152, master valve 2136, and piping 2148 from a source of high-pressure fluid 2154. The source of high-pressure fluid 2154 (e.g., a hydraulic pump) may be located distant from valve 2136, thus, a hydraulic accumulator 2150 may be located closer to valve 2136 in order to maintain high pressure during fluid flow through valve 2136.

Upper chamber 2122 is also connected to piping 2156, which conducts fluid between upper chamber 2122 and piping 2148 through (a) a variable or fixed flow resistance 2160 and (b) an optional connection 2162, e.g., a connection to a source of fluid at high pressure, low pressure, or variable pressure. Fluid may flow from piping 2148 to piping 2156 and chamber 2122 via check valve 2158 and through flow resistance 2160.

Piping 2148 communicates with upper actuator chamber 2122 through an opening (not depicted) in the side surface (lateral interior surface) of chamber 2122. This opening is sized, shaped, and located in the side of chamber 2122 in such a manner that when piston 2120 has reached its upward limit of motion, the opening is occluded, and fluid essentially cannot enter or leave the upper chamber 2122 through piping 2148. Moreover, the sizing, shaping, and location of the occludable opening in chamber 2122 may be such as to contribute to controlled deceleration of piston 2120 when the piston 2120 approaches the upper end cap of chamber 2122. The manner in which the character of an occludable opening may contribute to controlled deceleration of piston 2120 will be elucidated in FIGS. 23A-23D and 24A-24E.

Piping 2156 communicates with chamber 2122 through a non-occludable opening in the end cap (upper surface) of chamber 2122; thus, fluid may typically enter or leave the upper chamber 2122 regardless of the position of piston 2120.

In the state of operation depicted in FIG. 21, the high-side poppet valve 2102 is being closed. High-pressure fluid from the source 2154 flows through check valve 2152, master valve 2136, and piping 2148 into the upper actuator chamber 2122. Fluid at high pressure also flows from piping 2148 through check valve 2158 and piping 2156 into the upper chamber 2122. Simultaneously, fluid at relatively low pressure exits the lower actuator chamber 2124 through piping 2132 and master valve 2136. Fluid at relatively low pressure also exits the lower chamber 2124 through piping 2140 to piping 2132 through flow resistance 2142. A net downward force is being applied on the actuator piston 2120, and the stem 2108 and disc 2104 are moving downward.

FIG. 22 is a schematic drawing of various components of an illustrative assembly 2200 embodying aspects of the invention. Assembly 2200 differs from assembly 2100 in FIG. 21 primarily in comprising a low-side poppet valve 2202 rather than a high-side poppet valve (e.g., valve 2102 in FIG. 21). Assembly 2200 also differs from assembly 2100 in the orientation of the relief valve 2234. That is, the inflow side of valve 2234 is connected to piping 2232 (which corresponds to piping 2132 in FIG. 21) and the outflow side of valve 2234 is connected to piping 2248 (which corresponds to piping 2148 in FIG. 21). Relief valve 2234 remains closed in ordinary states of operation of the assembly 2200. When the pressure at the inflow side of valve 2234 exceeds that at the outflow side of valve 2234 by some specified opening difference, valve 2234 opens and remains open until the difference in pressure between its two sides drops below some specified closing difference. Relief valve 2234 allows poppet valve 2202 to open without damage to components of assembly 2200 when pressure within poppet valve 2202, i.e., pressure exerted downward on the disc 2204, exceeds some predetermined threshold.

In the state of operation depicted in FIG. 22, opening of the high-side poppet valve 2202 has just commenced. Much as in FIG. 21, a net downward force is being applied on the actuator piston 2220 and the disc 2204 is moving downward.

FIG. 23A is a schematic drawing of various components of an illustrative two-chamber hydraulic activation cylinder assembly 2300 whose components correspond functionally to certain components of assembly 2100 in FIG. 21 and assembly 2200 in FIG. 22, as shall be made clear hereinbelow. Assembly 2300 includes an activation cylinder 2302, a hydraulic connection 2304 selectably connected to either a low-pressure fluid reservoir or a high-pressure fluid source, an adjustable flow resistance 2306, and a check valve 2308, all interconnected by piping as shown. Activation cylinder 2302 includes a piston 2310 and a stem 2312. Stem 2312 is connected to the disc of a poppet valve (not shown), which is opened and closed by the assembly 2300 in an arrangement similar to that depicted in FIGS. 20-22. References herein to the movements of the piston 2310 describe the movements in unison of the piston 2310, stem 2312, and poppet disc. Piping 2314 connects the connection 2304 to an occludable orifice 2316 in the wall of the proximal chamber 2318 of the cylinder 2302. The shape of the occludable orifice 2316 is not depicted in FIG. 23A, but its distal (rightward) and proximal (leftward) limits are indicated by dotted lines A and B. A fixed orifice 2320 allows fluid to enter or leave chamber 2318 whether or not the occludable orifice 2316 is occluded. The orifices 2316, 2320 and other characteristics of assembly 2300 are chosen so that the piston 2310 decelerates from a high velocity Vₘₐₓ achieved before the piston 2310 reaches position A, to an acceptably low final velocity V_{end}, achieved by the time the piston 2310 reaches position B. Assembly 2300 is shown in a horizontal orientation for illustrative purposes in FIGS. 23A-23D but other orientations (e.g., vertical) may be employed in various embodiments.

Functionally, cylinder 2302 corresponds to activation cylinder 2118 in FIG. 21; piston 2310 to piston 2120; stem 2312 to stem 2108; chamber 2318 to chamber 2124; piping 2320 to piping 2140; flow resistance 2306 to flow resistance 2142; check valve 2308 to check valve 2144; piping 2314 to 2132; and connection 2304 to either high-pressure source 2154 or low-pressure reservoir 2138 (selectable by master valve 2136).

In the state of operation depicted in FIG. 23A, the activation cylinder 2302 is performing a closing stroke, i.e., the piston 2310 and stem 2312 are moving to the left. The piston 2310 has not yet begun to occlude orifice 2316 (i.e., the proximal surface of piston 2310 has not yet reached position A). It is preferable, during this portion of the closing stroke, that the fluid pressure in the proximal chamber 2318 be as low as possible, in order to minimize the work that must be performed to moving the piston 2310. During this portion of the closing stroke, therefore, the connection 2304 is connected to a low-pressure fluid reservoir and the total orifice area presented to fluid in chamber 2318 is maximal: e.g., fluid undergoes a relatively small pressure drop in flowing through orifice 2316 and piping 2314 to connection 2304. Some fluid also flows through the adjustable flow resistance 2306 and thence to connection 2304.

FIG. 23B depicts the system 2300 of FIG. 23A in a state of operation subsequent to that shown in FIG. 23A. Piston 2310 has occluded all of orifice 2316 and has been decelerated to V_{end}. Fluid has ceased to flow through piping 2314 but continues to flow through the adjustable flow resistance 2306 and thence to connection 2304. As piston 2310 subsequently reaches and/or overshoots position B (due to, e.g., compression or spring-cushioning of the seat of the activated poppet valve), the pressure in chamber 2318 and therefore the decelerating force acting on piston 2310 is determined by the size of fixed orifice 2320 and by the setting of the adjustable flow resistance 2306. (It is here assumed, for simplicity, that the piping in system 2300 presents negligible resistance to fluid flow.) If orifice 2320 were not present, when piston 2310 completely occluded orifice 2316 fluid would be unable to exit chamber 2318 and pressure in chamber 2318 would spike to some relatively very high value (i.e., a hydrolock condition would occur). With an appropriately sized orifice 2320 and appropriately adjusted resistance 2306, at no time in the closing stroke (e.g., even during overshoot of position B) does the pressure in chamber 2318 exceed the design pressure limit Pₘₐₓ (i.e., the maximum pressure tolerable without mechanical damage or failure).

FIG. 23C depicts the system 2300 of FIG. 23A in a different state of operation. In the state of operation depicted in FIG. 23C, the activation cylinder 2302 is commencing an opening stroke, i.e., the piston 2310 and stem 2312 are moving to the right. The piston 2310 has not yet begun to un-occlude orifice 2316 (i.e., the proximal surface of the piston 2310 has not yet passed position B). It is preferable, during this portion of the opening stroke, that the fluid pressure in the proximal chamber 2318 be as high as possible (e.g., Pₘₐₓ) in order to accelerate the piston 2310 rapidly in the distal direction and so open the poppet valve rapidly, minimizing disc-proximity losses. During this operating state, therefore, the connection 2304 is connected to a fluid source at high pressure (e.g., Pₘₐₓ). No fluid can yet flow through piping 2314 to occludable orifice 2316. However, fluid flows freely through the low-resistance check valve 2308 to fixed orifice 2320, enabling rapid acceleration of the piston 2310.

FIG. 23D shows the system 2300 of FIG. 23C in a state of operation subsequent to that depicted in FIG. 23C. Piston 2310 has passed position A and the occludable orifice 2316 is completely unoccluded. Fluid now passes relatively freely from connection 2304 into chamber 2318 through the check valve 2308 (and orifice 2320) and piping 2314 (and occludable orifice 2316).

The arrangement of orifices, valves, and piping depicted in FIGS. 23A-23D are advantageous because they provide automatically, i.e., without the operation of active valves or other complex or energy-consuming devices, for modulated resistance to fluid flow out of chamber 2318 during states of operation of system 2300 when modulated resistance is desirable, and for relatively low resistance to fluid flow into chamber 2318 during states of operation when low resistance is desirable.

It will be clear to persons familiar with the principles of hydraulic devices that an arrangement (not depicted) of orifices, valves, and piping similar to that depicted in FIGS. 23A-23D may be connected to the distal chamber 2322 of the cylinder 2302 in order to control the deceleration of the piston 2310 during the latter portion of an opening stroke.

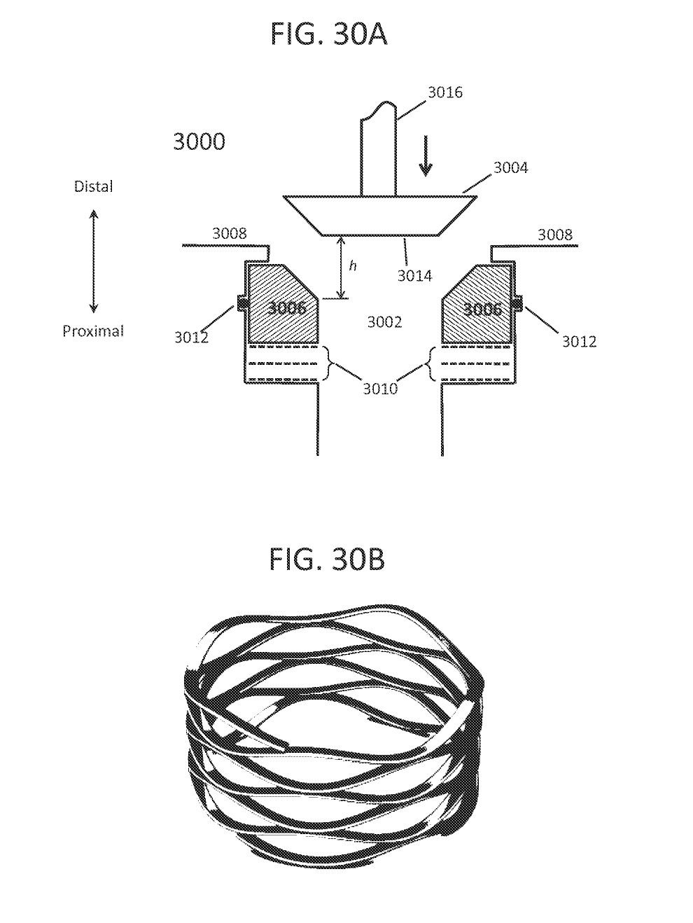

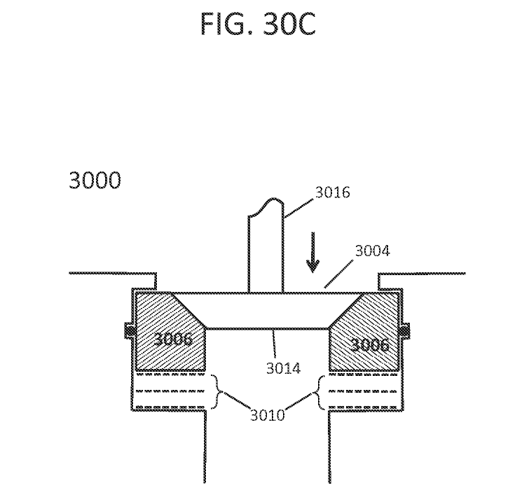

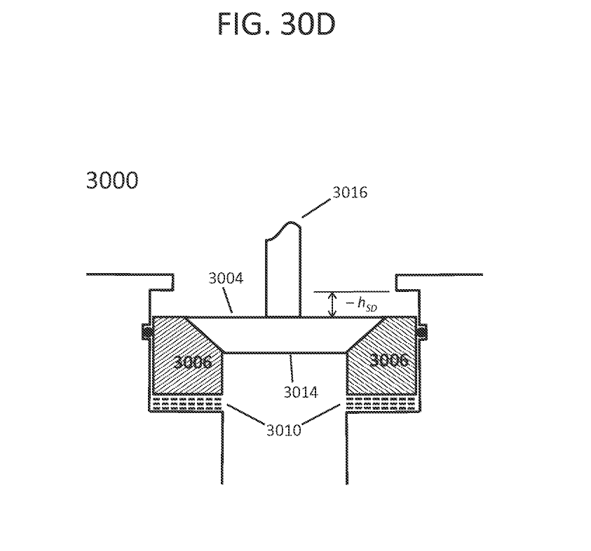

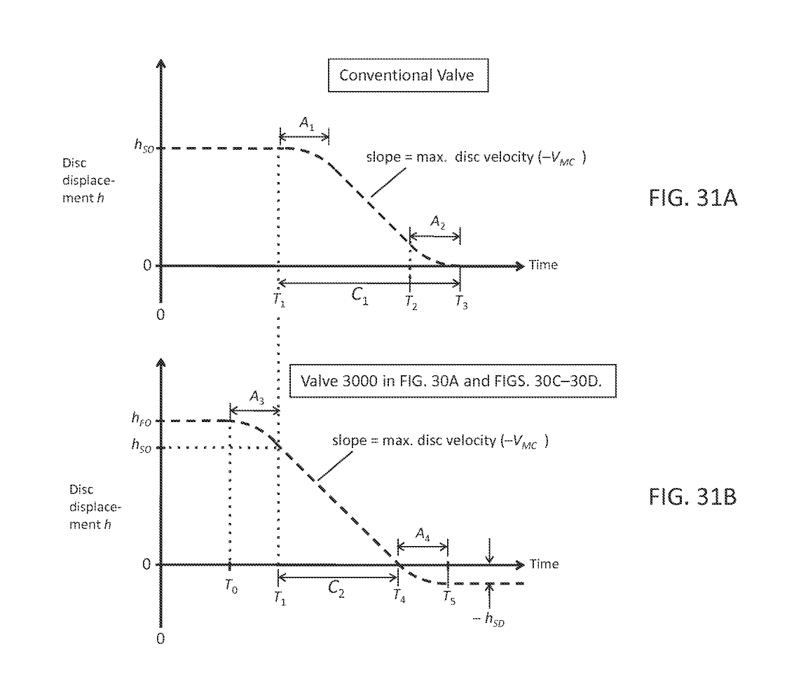

FIG. 24A is a schematic drawing of components of an illustrative activation cylinder 2400 that may be part of a larger system, not otherwise depicted, for the storage and release of energy, and that incorporates aspects of certain embodiments of the invention. The cylinder 2400, which is connected to and activates a poppet valve (not shown) in an arrangement similar to those depicted in FIG. 20 or FIG. 30A, features arrangements for rapid, controlled deceleration of the piston of the activation cylinder 2400 during valve closure in order to enable rapid, efficient closure of the poppet valve (with lessened throttling losses during the final phase of closure) while avoiding high disc-to-seat impact velocity in the poppet valve.

The downward direction in FIG. 24A is also herein termed the proximal direction, and the upward direction in FIG. 24A is also herein termed the distal direction. The activation cylinder 2400 includes a tubular cylinder body 2402 (not necessarily circular in cross section), a piston 2404, a proximal end-cap 2406, a distal end-cap 2408, an orifice of fixed cross-section (i.e., a fixed orifice) 2410 in the proximal end-cap 2406, and occludable lateral orifices 2412, 2414 (e.g., perforations in the wall of the cylinder body 2402). (The two orifices 2412, 2414 may alternatively be described as, and may be equivalent to, two portions of a single orifice, i.e., the upper and lower portions of a single orifice.) Herein, the upper orifice 2412 is also termed the “free flow zone” or “fixed orifice” and the lower orifice 2414 is also termed the “cushion zone” or “shaped orifice.” In various embodiments, the lower orifice 2414 will tend to be significantly smaller than the upper orifice 2412.

The volume between the proximal face of the piston 2404 and the inside surface of the proximal end-cap 2406 constitutes the proximal chamber 2416 of the activation cylinder 2400. The volume between the distal face of the piston 2404 and the distal end cap 2408 constitutes the distal chamber 2418 of the activation cylinder 2400. The proximal chamber 2416 and distal chamber 2416 are both filled with a substantially incompressible fluid.

The activation cylinder 2400 also includes a stem (not shown, for clarity) that connects the proximal portion of the piston 2404 to the disc of a poppet valve (not shown) that is located proximally to and is aligned with cylinder 2400, in an arrangement similar to that depicted in a horizontal orientation in FIG. 23. The stem and the poppet-valve disc move in unison with the piston 2404. Until the piston 2404 (i.e., the proximal surface of piston 2404) reaches position B, the poppet valve (not depicted) is deemed fully open. When the piston 2404 reaches position D, the poppet valve is closed (i.e., the disc touches the seat; see FIG. 20). The distance between position B and position D is h₃.

In the state of operation depicted in FIG. 24A, the activation valve 2400 is closing the poppet valve; that is, the piston 2404 is moving downward, and so, impelled by the stem, is the disc of the poppet valve (not shown). As piston 2404 moves downward, fluid is expelled from the proximal chamber 2416 through the fixed orifice 2410 and the occludable orifices 2412, 2414.

The upper occludable orifice 2412 is rectangular in the embodiment depicted in FIG. 24A, with height h₁ and width w. The shaped orifice 2414 has height Dₚᵣₒₓ and a variable width. The trapezoidal form of the shaped orifice 2414 in FIG. 24A is illustrative only; other forms for the shaped orifice 2414 are contemplated and within the scope of the invention. An exemplary calculation of a form for the shaped orifice 2414 that is optimal under certain assumptions will be provided hereinbelow.

For ease of illustration, the transverse cross-sectional shape of cylinder body 2402 in FIG. 24A is presumed to be rectangular; thus, the shapes of the orifices 2412, 2414 as depicted in FIG. 24A are undistorted by projection on the page. However, other cross-sectional forms for cylinder body 2402 (e.g., circular) are contemplated and within the scope of the invention.

Until the proximal or lower surface of the piston 2404 reaches position C (marked by a dotted horizontal line in FIG. 24A), whereupon the piston 2404 begins to occlude the shaped orifice 2414, it is desirable that minimal force be required to move the piston 2404. Minimal force exerted on piston 2404 entails the expenditure of minimal work. The purpose of upper orifice 2412 is to minimize hydraulic resistance to the downward movement of the piston 2404 until position C is reached. Therefore, upper orifice 2412 is generally made as large as is feasible. This implies that orifice 2412 will preferably be made as large as possible while still allowing the piston 2404 to simultaneously completely occlude both orifices 2412, 2414. This entails that, given a piston of height h₂ and a shaped orifice 2414 of height Dₚᵣₒₓ, we have h₁+Dₚᵣₒₓ≦h₂. This restriction on height h₁ of upper orifice 2412 may be restated as h₁≦h₂−Dₚᵣₒₓ. Likewise, the width w of orifice 2412 is preferably substantially large given the dimensions of cylinder body 2402 to prevent restriction of fluid entering or exiting orifice 2412. For a cylinder body 2402 having internal circumference c, the width w of orifice 2412 can be no greater than c (i.e., w≦c). In FIG. 24A, the width w of orifice 2412 is illustratively depicted as substantially equal to the projected diameter of the cylinder body 2402; however, this is illustrative only and typically orifice 2412 would be circular in cross-section and sized large enough (e.g., only large enough) to prevent restriction of entering or exiting fluid.

In an ideal case, resistance to the downward movement of piston 2404 would be zero until the proximal surface of piston 2404 reached position C, the top of the shaped orifice, whereupon the piston 2404 would begin to occlude the shaped orifice 2414 and deceleration of the piston 2404 would proceed as shall be described in detail hereinbelow. The provision of the large vent or orifice 2412 is a viable contrivance for minimizing resistance to the downward movement of piston 2404 until the piston 2404 reaches position C and begins to occlude the shaped orifice 2414. The use of other contrivances to this end is contemplated and within the scope of the invention. For example, in some alternative embodiments (not depicted), shaped orifice 2414 is retained but upper orifice 2412 is omitted. In these alternative embodiments, a channel passes longitudinally through the body of piston 2404, of sufficient width to allow fluid to pass with minimal (e.g., near-zero) resistance from proximal chamber 2416 to distal chamber 2418 as the piston 2404 moves downward. This internal piston channel may be closed off when the proximal surface of piston 2404 approaches or reaches position C (the top of the shaped orifice): e.g., a butterfly valve or other valve mechanism within the body of the piston 2404 may close off the internal channel; or, a plug cylinder may be positioned within the proximal chamber 2416, of diameter approximately equal to the internal piston channel and as tall as the shaped orifice 2414, so that the plug's upper end enters the lower end of the internal piston channel as the proximal surface of piston 2404 passes position C. These and other viable alternative arrangements would allow rapid transition from low resistance to downward movement of piston 2404 to resistance governed by expulsion of fluid from proximal chamber 2416 through the shaped orifice 2414 and fixed orifice 2410. By contrast, the arrangement depicted in FIG. 24A entails a substantially linear decrease in total orifice area from the time piston 2404 reaches position A until it reaches position C, with a concomitant increase in decelerating force on piston 2404.

In a physical realization of the system of which portions are depicted in FIG. 24A, some deceleration of piston 2404 due to progressive occlusion of upper orifice 2412 and to throttling losses as the poppet disc (not shown) approaches the seat would occur by the time the proximal surface of the piston 2404 reaches position C (the top of the shaped orifice 2414.) As explained above, alternative mechanisms could approximate the assumption of negligible resistance to movement of piston 2404 until piston 2404 reaches the top of shaped orifice 2414. In this discussion, it is presumed that some deceleration of the piston 2404 from its maximum velocity Vₘₐₓ to some slightly lesser velocity V′ₘₐₓ occurs as the piston passes from position A to position C. At the moment depicted in FIG. 24A, the piston 2404 is moving at a maximum velocity Vₘₐₓ and has not yet reached position A.

At the moment depicted in FIG. 24B, the piston 2404 has passed position A. The upper orifice 2412 is partly occluded by the piston 2404. The disc of the poppet valve (not shown) is still so far from the seat that the poppet valve is effectively fully open (i.e., throttling losses around the poppet disc are still negligible). When the piston 2404 passes position B, functional closure of the poppet valve begins. That is, the poppet valve is no longer presenting minimal resistance to flow; throttling losses begin to be significant and increase until valve closure is complete (i.e., when piston 2404 reaches position D, whereupon the poppet valve disc contacts the seat). Preferred embodiments of the present invention are designed to traverse the distance from position B to position D as quickly as possible, thus minimizing total energy losses from throttling, while (a) maintaining the fluid pressure within chamber 2416 at or below some specified limit Pₘₐₓ and (b) having the piston 2404 arrive at position D at an acceptably low final velocity V_{end}. This is also the impact velocity of the activated poppet valve's disc upon the poppet valve's seat.

At the moment depicted in FIG. 24C, the piston 2404 has reached position C; that is, it has completely occluded the upper orifice 2412 and has not yet begun to occlude the shaped orifice 2414. The piston 2404 has decelerated to V′ₘₐₓ.

As piston 2404 moves downward from position C to position D, the fluid within chamber 2416 is pressurized to some pressure P(t) that may vary with time, the volume of proximal chamber 2416 is decreased, and a volumetric flow of incompressible fluid Q(t) that is equal to the decrease in volume of chamber 2416 is expelled from chamber 2416 through the fixed orifice 2410 and shaped orifice 2414. Herein, it is assumed for simplicity that the fluid exiting chamber 2416 encounters negligible flow resistance (e.g., in piping or valves) other than that presented by passage through the orifices 2410, 2414. In this case, the pressure within chamber 2416 is determined entirely by the rate of flow Q(t) (which is determined by the velocity of the piston 2404) and by the total opening area O(t) of the orifices 2410, 2414. Total opening area O(t) is the sum of the areas of the unoccluded portions of the two orifices 2410, 2414. Slower motion of the piston 2404 entails lower Q(t), which tends to entail lower P(t); smaller orifice area O(t) tends to entail higher P(t). Since the velocity of piston 2404 tends to decrease as the piston 2404 moves proximally, and the opening area O(t) also tends to decrease as the piston 2404 moves proximally, there tends to be a balance or offsetting between the effects on P(t) of changing velocity and O(t).

Fluid pressure in chamber 2416 produces an upward-acting force on the proximal face of piston 2404. If that pressure exceeds the closing force and there no other forces are acting on piston 2404 (as is assumed here for simplicity), piston 2404 will thus decelerate as it moves downward. Also, when piston 2404 passes position C, piston 2404 begins to occlude the shaped orifice 2414, decreasing the total opening area O(t). Thus, as the piston 2404 moves downward past position C, the piston 2404 will decelerate, tending to entail lower P(t), while the unoccluded area of the orifice 2414 will decrease, tending to entail higher P(t). If the occludable orifice 2414 and fixed orifice 2410 are appropriately sized and shaped, these two effects (piston deceleration and orifice narrowing) will offset each other in such a manner that P(t) retains a constant value, preferably close (or even equal) to the maximum cushioning pressure, P(t)=Pₘₐₓ, as the piston 2404 decelerates from position C to position D. At position D, the piston 2404 will preferably be moving with velocity V_{end} (i.e., an acceptably slow disc-to-seat impact velocity).

As previously noted, the orifice 2414 is Dₚᵣₒₓ in height. The transverse profile of the orifice 2414 as depicted in FIG. 24A (i.e., linear widening as one proceeds in the proximal direction) is illustrative only, and does not necessarily correspond to the shape that orifice 2414 would have in various physical realizations of system 2400 or various other embodiments. In various other embodiments, not depicted, more than one occludable orifice and more than one fixed orifice are employed, where the various orifices may differ from one another in shape and size, and contrivances external to the activation valve (e.g., valves with time-variable flow resistance) may also be employed, alternatively or additionally, to modulate the resistance encountered by fluid exiting chamber 2416 during piston deceleration and thus the relationship between piston velocity and pressure within the chamber 2416 during deceleration. In various other embodiments, contrivances internal to the activation valve may be employed additionally or alternatively to those depicted in FIGS. 24A-24E in order to modulate the resistance encountered by fluid exiting chamber 2416 during piston deceleration: e.g., one or more channels within the body of piston 2404 may permit fluid flow (possibly modulated by valves or other devices) from the proximal surface of the piston 2404 to one or more orifices on the lateral surface of the piston 2404 that may communicate with occludable orifice 2414 in some positions or states of motion of the piston 2404. All such alternative or additional contrivances for modulating the relationship between piston velocity and pressure within the proximal chamber 2416, though not depicted, are contemplated and within the scope of the invention.

FIG. 24D shows the activation cylinder 2400 of FIG. 24A in a state of operation subsequent to that depicted in FIG. 24C. In FIG. 24D, the piston 2404 has passed position C and is partly occluding the shaped orifice 2414. The piston 2404 is decelerating at an approximately constant rate A, the rate of fluid outflow Q(t) from chamber 2416 is decreasing, total opening area O(t) is decreasing, and pressure P(t) in chamber 2418 is at a constant Pₘₐₓ.

FIG. 24E shows the activation cylinder 2400 of FIG. 24A in a state of operation subsequent to that depicted in FIG. 24D. In FIG. 24E, the piston 2404 has reached position D and is entirely occluding the shaped orifice 2414. The piston 2404 has decelerated to velocity V_{end} and the disc of the poppet valve (not depicted) is just making contact with the seat.

The shape of occludable orifice 2414 required for optimal closure of the activation cylinder of FIGS. 24A-24E, in accordance with some embodiments of the invention, may be calculated under the following illustrative and idealized assumptions:

1) The piston 2404, the stem (not shown, but see FIG. 4), and the disc of the poppet valve (not shown, but see FIG. 20) move in unison, constituting a rigid mechanical unit herein termed the “piston-disc assembly.”

2) The piston-disc assembly is moving proximally at some maximum feasible velocity V′ₘₐₓ when the piston-disc assembly begins to decelerate (i.e., when the piston 2404 reaches point C in FIG. 24A).

3) The changing gravitational potential energy of the piston-disc assembly may be neglected. (Alternatively, activation cylinder 2400 may be operated in a horizontal position, in which case the gravitational potential energy of the piston-disc assembly is constant.)

4) The changing gravitational potential energy and momentum of fluid in the distal chamber of the cylinder 2402 may be neglected.

5) Turbulence and other complicating fluid-mechanical effects may be neglected.

6) Cylinder 2400 is contrived so that the piston-disc assembly decelerates with constant deceleration of magnitude A to a final impact velocity V_{end}. Pressure in the proximal chamber 2412 is a constant Pₘₐₓ during deceleration.

7) The only force acting on the piston-disc assembly during deceleration is the hydraulic force F_{decel} exerted in the distal direction on the piston 2404 by the fluid in the proximal chamber 2416: i.e., F_{decel}=PₘₐₓSₚᵢₛₜ, where Sₚᵢₛₜ is the area of the proximal surface of piston 2404. F_{decel} is a constant because Pₘₐₓ and Sₚᵢₛₜ are both constant by definition. By Newton's Second Law, A=F_{decel}/M_{PD}, where M_{PD} is the total mass of the piston-disc assembly. Pressure in the distal chamber 2418 is assumed to be zero during deceleration. (Alternatively, one may assume constant nonzero pressure in the distal chamber 2418 during deceleration, which merely scales the transverse width of the occludable shaped orifice 2414 by a constant factor.)

7) The square root of the pressure P(t) within the proximal chamber 2416 is proportional to the time-varying volumetric flow Q(t) of fluid out of the chamber 2416 through the orifices 2410, 2414 divided by the total area O(t) of the orifices: P(t)^{1/2} ∝KQ(t)/O(t), where K is some constant. This is a simplification of the relationship that would actually hold between P(t), Q(t), and O(t) in non-ideal valve. During deceleration, since P(t)=Pₘₐₓ, it follows that Pₘₐₓ^{1/2}∝KQ(t)/O(t).

8) Below position C, the proximal chamber includes a single occludable orifice 2414 in the side-wall of the chamber 2416 and a single fixed orifice 2410 in the proximal end-cap 2406 of the chamber 2416.

9) The height of the occludable orifice 2414 is Dₚᵣₒₓ. Its distal end is at position C and its proximal end is at position D.

10) The portion of the wall of cylinder 2402 that is perforated by the occludable orifice 2414 is planar (flat) or so nearly planar that its non-planarity may be neglected.

As will be clear to persons familiar with the calculus, the foregoing ten conditions allow the calculation of a unique solution for the transverse profile of the occludable orifice 2414. Labeling the vertical direction in FIGS. 24A-24E as x, where x equals 0 at position C and increases in the proximal direction, the transverse profile y(x) of one side of the orifice 2414 is described by the function y(x)=C(V′ₘₐₓ²−2Ax)^{1/2}, where C is a constant. Analysis based on the foregoing ten assumptions shows that if a final velocity V_{end} of 0 is specified, y(x) goes to infinity at x=Dₚᵣₒₓ that is, the solution is nonphysical (i.e., orifice 2414 cannot become infinitely wide in a real cylinder). However, the solution is physical if V_{end}>0 (i.e., the width of orifice 2414 is finite everywhere).

Under assumptions differing from those listed above, including more realistic fluid-mechanical assumptions, the optimal shape of the occludable orifice 2414 will differ from that specified by y(x). Additionally, the foregoing result is not altered by assuming that V′ₘₐₓ=Vₘₐₓ (i.e., no deceleration of the piston prior to reaching position C).

The height of the occludable orifice 2414 is not limited to Dₚᵣₒₓ in all embodiments; some portion of the occludable orifice may, for example, extend all the way to the proximal end cap 2406 of the cylinder 2400. The shape of any such extended occludable orifice 2414 may be adjusted to tune pressure and flow within the proximal chamber 2416 during any overshoot of position D during a closing stroke (e.g., during compression of the seat 2020 in FIG. 20, or of a helical spring supporting the seat 2020, after impact of the disc 2018).

FIG. 24F shows the activation cylinder 2400 of FIGS. 24A-24E with the illustrative trapezoidal orifice 2414 of FIGS. 24A-24E replaced by an occludable orifice 2420 having a transverse profile (for each side of the symmetrical orifice) described by the function y(x)=C(Vₘₐₓ²−2Ax)^{1/2}. As shown hereinabove, this profile is optimal under certain assumptions. A symmetrical orifice 2420 is preferred in order to eliminate unbalanced transverse forces due to asymmetric fluid flow through the orifice 2420. The scale of all aspects of FIG. 24F is arbitrary and illustrative only, including the scaling of the transverse profile of the orifice 2420.

The benefits of an idealized system (e.g., that in FIG. 24F) may be realized to some degree by systems not possessing optimally shaped occludable orifices. FIG. 24F is a drawing of an occludable orifice in the wall of the proximal chamber 2416 in one realization of the activation cylinder 2400. This orifice form has the advantage of being manufacturable by two simple drillings.

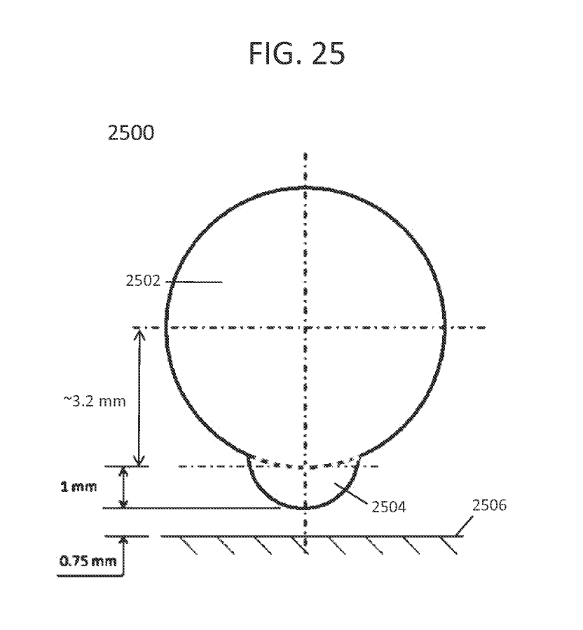

FIG. 25 is a drawing of portions of one illustrative realization of aspects of the invention. Specifically, FIG. 25 shows the outline of two orifices 2502, 2504 (which may also be considered as two portions of a single orifice). Functionally, orifice 2502 corresponds to the free-flow zone or upper orifice 2412 of FIGS. 24A-24F and orifice 2504 corresponds to the cushion zones, lower orifices, or shaped orifices 2414, 2420 of FIGS. 24A-24F. The outlines of upper orifice 2502 and lower orifice 2504 correspond approximately to the non-straight portion of a circle segment perimeter: each may be manufactured as a circular drilling through the wall of the lower actuator chamber 2124 in FIG. 21A. The circle whose perimeter corresponds in part to the outline of upper orifice 2502 has a radius of approximately 3.2 mm; the circle whose perimeter corresponds in part to the outline of lower orifice 2504 has a radius of approximately 1 mm. The lowermost edge of the lower orifice 2504 is approximately 0.75 mm from the inner surface of the lower end cap 2506 of the actuator cylinder (not otherwise depicted in FIG. 25). In general, the lower orifice 2504 is substantially smaller than the upper orifice 2502; the area of orifice 2504 is, in some embodiments, 5% to 15% of the area of the upper orifice 2502. The upper orifice 2504 is sized to provide nearly free-flow, i.e., flow with a low pressure drop (e.g., <20% of actuation pressure), of the exiting fluid during valve actuation. The orifices 2502, 2504 of FIG. 25 exemplify the non-uniqueness of the free-flow-zone and cushion-zone orifice shapes depicted herein, e.g., in FIGS. 24A-24F.

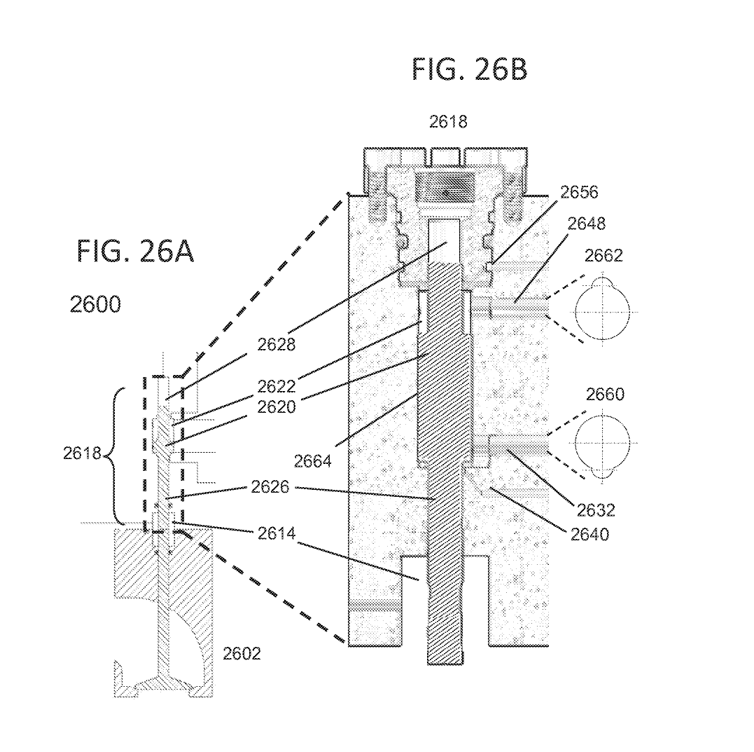

FIGS. 26A and 26B are drawings of portions of one illustrative realization of aspects of the invention. Assembly 2600 includes a high-side poppet valve 2602 (corresponding to poppet valve 2102 in FIG. 21) and actuator piston 2618 (corresponding to actuator 2118 in FIG. 21). For clarity, the actuator 2618 has also been represented in FIG. 26B in an expanded view, as indicated by thick dashed lines. Chamber 2628 corresponds to equalization chamber 2128 in FIG. 21, upper actuator chamber 2622 to chamber 2122, piston 2620 to piston 2120, stem 2626 to stem 2126, catchment chamber 2614 to catchment chamber 2114, piping 2640 to piping 2140, piping 2632 to piping 2132, piping 2648 to piping 2148, and piping 2656 to piping 2156. Pipings or channels 2640, 2632, 2648, and 2656 are only partially represented in FIG. 26B. For clarity, as indicated by thin dashed lines, the cross-section of piping 2632 has been represented in FIG. 26B in an expanded view 2660 and the cross-section of piping 2648 has been represented in FIG. 26B in an expanded view 2662. The cross-sections of pipings 2632 and 2648 correspond, in this exemplary realization, to the cross-section of the combined orifices 2502, 2504 in FIG. 25. Thus, the realization partly depicted in FIGS. 26A and 26B incorporates aspects of the invention to allow for rapid, cushioned opening and closure of the poppet valve 2602. In FIG. 26B, the actuator 2618 at its lower limit of motion and the poppet valve 2602 is closed.

FIG. 27 is a plot of data acquired from a physical realization of aspects of the invention closely resembling that partly depicted in FIGS. 21, 26A, and 26B. FIG. 27 plots the position of the actuator piston 2620 in FIG. 26B as a function of time (solid line), time averaged for a closing actuation. Also plotted in FIG. 27 is the position-vs.-time function for the assembly 2600 in FIG. 26B as predicted using the software tool Simscape™ (dashed line). Simulated and observed piston velocity closely agree.

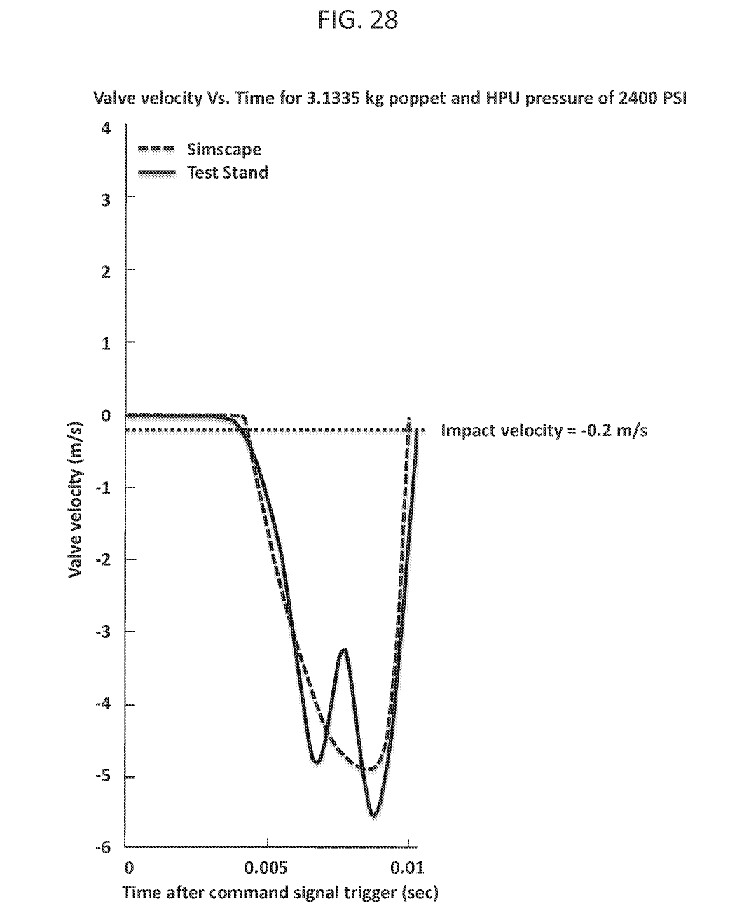

FIG. 28 is a plot of data acquired from a physical realization of aspects of the invention closely resembling that partly depicted in FIGS. 21, 26A, and 26B. FIG. 28 plots the velocity of the actuator piston 2620 in FIG. 26B as a function of time (solid line) for a single closing actuation. Also plotted in FIG. 27 is the position-vs.-time function for the assembly 2600 in FIG. 26B as predicted using the software tool Simscape (dashed line). Simulated and observed piston velocity agree except for a “bounce” in the actual device before closure. Impact velocities of simulation and measurement closely agree at ˜0.2 msec.

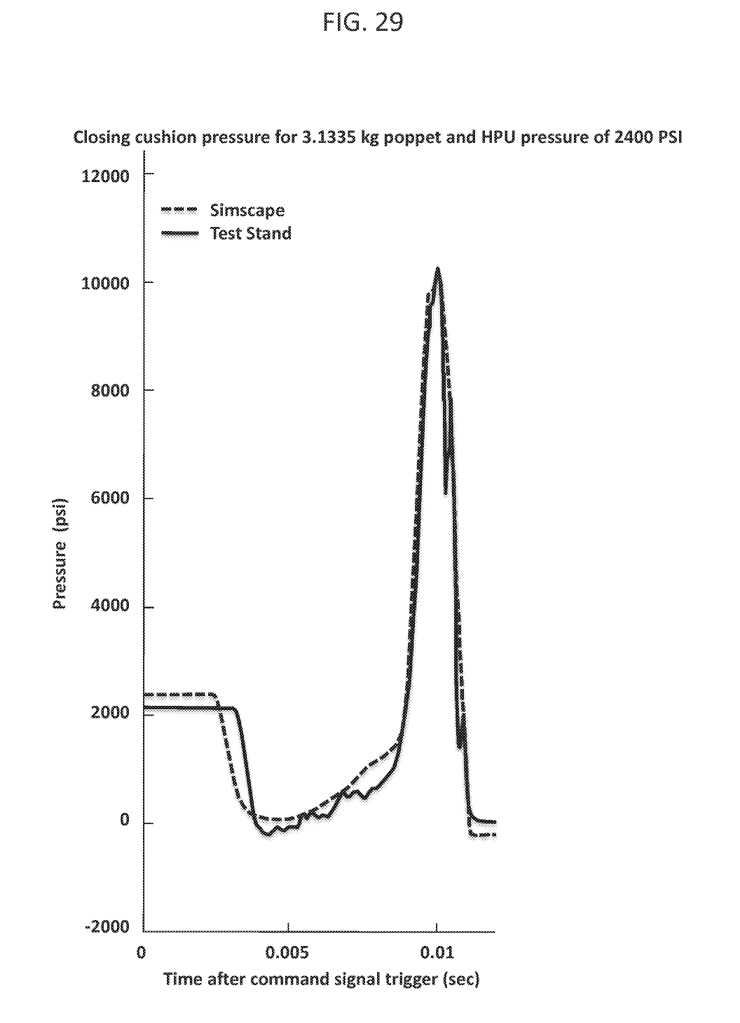

FIG. 29 is a plot of data acquired from a physical realization of aspects of the invention closely resembling that partly depicted in FIGS. 21, 26A, and 26B. FIG. 29 plots the fluid pressure within the lower chamber of the actuator piston 2620 in FIG. 26B as a function of time (solid line) for a single closing actuation. Also plotted in FIG. 27 is the pressure-vs.-time function for lower actuator chamber of the assembly 2600 in FIG. 26B as predicted using the software tool Simscape (dashed line). Notably, pressure peaks during the latter portion of the closing interval, e.g., during deceleration of the piston-disc assembly.

FIG. 30A is a schematic cross-sectional drawing of an illustrative poppet valve 3000, in accordance with various embodiments of the present invention, that employs a hydraulic or other type of actuation mechanism (not shown) to open and close a port 3002 by moving a disc 3004. The valve 3000 shown in FIG. 30A is a high-side valve. Valve 3000 is depicted in a vertical orientation for illustrative purposes; other orientations (e.g., horizontal) may be employed in various embodiments.

The valve 3000 includes a beveled contact ring 3006 of a suitable material (e.g., polyether ether ketone [PEEK]), recessed into an annular groove or channel in a cylinder end-cap 3008 (shown in part). In FIG. 30A, the beveling of the disc 3004 complements that of the contact ring 3006, so that when the disc 3004 is in contact with the ring 3006, the beveled surfaces of the disc 3004 and ring 3006 are in flush contact with each other, completely occluding port the 3002.

The contact ring 3006 rests upon an annular (ring-shaped) wave spring 3010. The upper surface of the wave spring presses against the contact ring 3006, and the lower surface of the wave spring presses against the lower surface of the annular groove in the end cap 3008 into which the ring 3006 is recessed. To clarify the schematic cross-sectional view of the wave spring 3010 in FIG. 30A, an illustrative wave spring is shown in FIG. 30B. Wave springs of designs other than that shown in FIG. 30B may be employed in the mechanism of FIG. 30A. Non-wave-spring mechanisms (e.g., coil spring, pneumatic spring) may be employed, additionally or alternatively, in the mechanism of FIG. 30A or in other valves embodying the present invention; the use of a wave spring in FIG. 30A is illustrative only. Fluid flow between the contact ring 3006 and the end cap 3008 is prevented by one or more gaskets 3012.

The vertical distance between the lower surface of the valve disc 3004 and the contact ring 3006 is herein termed the disc displacement h and is indicated by a two-headed arrow with letter h in FIG. 30A. In FIG. 30A, a vertical coordinate of 0 (zero) is defined by the plane of the lower surface 3014 of the disc 3004 when the disc 3004 is in contact with the ring 3006 and the ring 3006 is in the most distal (i.e., upward, in FIG. 30A) position it can attain. Herein, this most-distal position of the ring 3006 is termed the neutral position of the ring 3006. Proximal (i.e., downward, in FIG. 30A) displacements from the h=0 plane are denoted by negative numbers. Herein, wave spring 3010 is said to be “neutrally compressed” when the ring 3006 is in its neutral position. The lower surface 3014 of the illustrative disc 3004 has radius R. The port 3002 also has radius R.

FIG. 30A depicts valve 3000 in a state of operation that occurs during closure of the valve 3000. In phases of valve closure prior to that depicted in FIG. 30A, the disc 3004, originally at rest at full-open displacement h_{FO} (substantially greater than the sufficiently-open distance h_{SO}), has accelerated proximally to maximum closing velocity V_{MC}. Maximum closing velocity V_{MC} was attained by disc 3004 before disc displacement h was reduced to the sufficiently-open distance h_{SO}. Effectual valve closure—i.e., significant reduction of capacity for flow through valve 3000—may be said to begin at the moment (not depicted) that valve displacement h becomes less than h_{SO}.

In the state of operation depicted in FIG. 30A, the wave spring 3010 is in its state of neutral compression, the ring 3006 is in its neutral position, and the disc 3004 is moving downward at the maximum closing velocity (V_{MC}) attained during operation of the valve mechanism. (A constant V_{MC} is assumed illustratively in discussion of FIG. 30A and elsewhere herein, but non-constant disc velocities may occur in other embodiments of the invention.) At the moment depicted in FIG. 30A, h is less than h_{SO}. Thus, at the moment depicted in FIG. 30A, valve 3000 is no longer sufficiently open, but is in the process of closing.

FIG. 30C depicts valve 3000 in later phase of closure of valve 3000. The disc 3004 is still moving downward at velocity V_{MC}. The disc 3004 has made contact with the ring 3006, occluding the port 3002, but the ring 3006 is still in its neutral position and the wave spring 3010 is still in its state of neutral compression. FIG. 30C thus depicts valve 3000 at the instant when sufficient closure is attained. The lower surface 3014 of the disc 3004 is at h=0.

Subsequent to the moment of sufficient closure depicted in FIG. 30C, the ring 3006 moves downward from its neutral position, impelled by the momentum of disc 3004, stem 3016, and possibly other components connected thereto (herein collectively referred to as the “traveling mass of closure”), as well as by any net downward fluid pressure acting on disc 3004 or forces exerted on the stem 3016 by the actuation mechanism (not shown). Downward displacement of the ring 3006 compresses the wave spring 3010, which exerts an upward, decelerating force on the disc 3004 and thus the whole traveling mass of closure. The spring constant and dimensions of the wave spring 3010 are chosen so that the velocity of the traveling mass of closure is reduced to an acceptably low final closing velocity V_{CV} (e.g., 0) by the time the spring 3010 has been maximally compressed.

FIG. 30D depicts the valve 3000 of FIGS. 30A and 30C at the moment when the wave spring 3010 has been maximally compressed and the velocity of the traveling mass of closure has been reduced to V_{CV}. At the moment depicted in FIG. 30D, the ring 3006 has been displaced by −h_{SD} from its neutral position to its substantially-depressed position.

Subsequently to the moment depicted in FIG. 30D, the spring 3010 will tend to restore ring 3006 to its neutral position. Herein, the time interval between the moment depicted in FIG. 30D and the stable restoration of ring 3006 to its neutral position is termed the settling interval. Any oscillations or other motions of the ring 3006, disc 3004, and other components of valve 3000 that may occur during the settling interval depend on the details of construction of valve 3000 and/or other embodiments, and are not discussed further herein. Valve 3000 and other embodiments may be designed so that from the moment of sufficient closure depicted in FIG. 30C and throughout the settling interval, the disc 3004 and ring 3006 remain in flush contact with each other (i.e., the valve does not bounce, but remains closed from the moment of sufficient closure until the commencement of an opening cycle).

In some embodiments, sufficient downward force is maintained upon the disc 3004 after the ring 3006 achieves its substantially depressed position at −h_{SD} (as depicted in FIG. 30D) to maintain the ring 3006 in its substantially-depressed position. In such embodiments, the disc 3004 and disc 3006 may be kept in substantially-depressed position until opening of the valve 3000 is initiated at some later time. In embodiments where the disc 3004 and ring 3006 are maintained in substantially depressed position after closure, work performed upon the spring 3010 during deceleration of the traveling mass of closure is stored in the spring 3010 as elastic potential energy and is available for acceleration of the ring 3006, disc 3004, and possibly other components during the early phases of an opening cycle.

The components and openings depicted in FIG. 30A and FIGS. 30C-30D are circular in cross-axial cross-section; however, other cross-sectional shapes are contemplated and within the scope of the invention.

The closure of valve 3000, as described hereinabove and partly depicted in FIG. 30A and FIGS. 30C-30D, is more rapid and efficient than closure of an otherwise similar poppet valve (herein termed a “conventional valve”) in which (a) during closure, the valve disc begins at rest at an approximate displacement of h_{SO}, (b) downward acceleration of the valve and stem by the actuation mechanism is approximately equal to that of disc 3004 in valve 3000, and (c) the maximum velocity of closure V_{MC} is approximately the same as that of valve 3000.

In embodiments where the disc 3004 and ring 3006 remain in a fully depressed position after closure, FIG. 30D also depicts the state of valve 3000 at the initiation of an opening cycle. In this state, the spring 3010 is exerting an upward force on the disc 3004, stem 3016, and any components attached thereto (herein termed the “traveling mass of opening”). At a moment early in the opening cycle (e.g., the moment depicted in FIG. 30D or shortly thereafter), the downward force that has held the disc 3004 and ring 3006 in fully depressed position during the closed state of valve 3000 is reversed or significantly reduced. Thereupon, ring 3006 is accelerated upward by the spring 3010. If an upward force is exerted on the disc 3004 by the actuation mechanism during this period of upward acceleration, and if that upward force is not large enough to accelerate the disc 3004 faster than the spring 3010 accelerates, the ring 3006 and disc 3004 will remain in contact with each other during this interval of upward acceleration, i.e., the valve 3000 will remain sufficiently closed during this interval of upward acceleration. During upward acceleration, the spring 3010 performs work upon the ring 3006 and disc 3004, restoring to the disc 3006 in the form of kinetic energy a portion of the energy stored in the spring 3010, during the deceleration phase of the previous valve closure, as elastic potential energy. Thus, some energy typically dissipated in the actuation mechanism during closure of a conventional poppet valve is restored during valve opening in these and other embodiments of the invention, reducing valve actuation energy and increasing overall system efficiency.

Reference is now made to FIGS. 31A and 31B, in which the rapidity of effective closure of valve 3000 as compared to closure of a conventional valve is made clear. The plot in FIG. 31A, “Conventional Valve,” is an illustrative, schematic plot of the position over time of the disc of a conventional valve during closure. The plot in FIG. 31B, “Valve 3000,” is an illustrative, schematic plot of the position over time of the disc 3004 of valve 3000 during closure.

In FIG. 31A, valve closure commences at time T₁. Disc displacement h is equal to h_{SO} (e.g., approximately equal to R/2) prior to time T₁: that is, the disc is stationary at h=h_{SO}. Over interval A₁, the disc is accelerated downward until it reaches its maximum closure velocity V_{MC}. At time T₂, deceleration of the disc begins. Deceleration of the disc to an acceptable final closing velocity V_{CV} occurs over interval A₂. At time T₃, the disc and seat of the conventional valve are in contact with each other and the conventional valve is sufficiently closed. The interval from time T₁ (after which time the valve ceases to be sufficiently open) to time T₃ (at which time the valve achieves sufficient closure) is the effective closing time C₁ of the conventional valve.

In FIG. 31B, valve closure commences at time T₀. Disc displacement h is equal to h_{FO} (full-open position) prior to T₀: that is, the disc 3004 is stationary at h=h_{FO}. Over interval A₃ (approximately equal in duration to interval A₁ in FIG. 31A), the disc 3004 is accelerated downward until it reaches its maximum closure velocity V_{MC}. At time T₁, the disc has reached the maximum closure velocity V_{MC}. At time T₄, the disc 3004, still moving at V_{MC}, makes contact with the ring 3006 and the valve 3000 is sufficiently closed. Deceleration of the disc to an acceptable final closing velocity V_{CV} occurs over interval A₄ (approximately equal in duration to interval A₂ in FIG. 31A). By time T₅, the disc has been decelerated to V_{CV}. The interval from time T₁ (after which the valve ceases to be sufficiently open) to time T₄ (when the valve achieves sufficient closure) is the effective closing time C₂ of valve 3000. FIGS. 31A and 31B make clear that the effective closing time C₂ of valve 3000 is less than the effective closing time C₁ of the conventional valve.

Moreover, it is apparent from FIGS. 31A and 31B that, because the disc 3004 of valve 3000 moves at higher average velocity between the point of sufficient openness (e.g., h approximately equal to R/2) and the point of sufficient closure (h=0), the curtain area A_{curtain} of valve 3000 is restricted (e.g., 0<A_{curtain}<πR²) for a shorter period of time during closure of valve 3000 than during closure of the conventional valve. Restriction of A_{curtain} entails heightened throttling losses (i.e., dissipation of pressure potential energy as heat in turbulent fluid) as fluid passes through the valve opening 3002. Therefore, shortening the time interval during which heightened throttling losses occur (i.e., shortening the effective closure time), as the design of valve 3000 does, increases the overall efficiency of the energy conversion system that includes valve 3000.

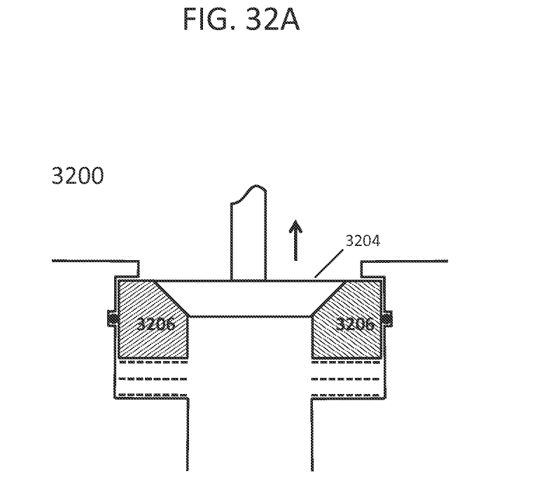

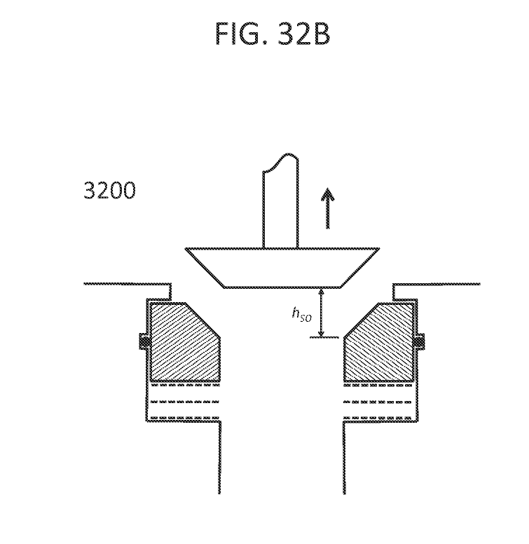

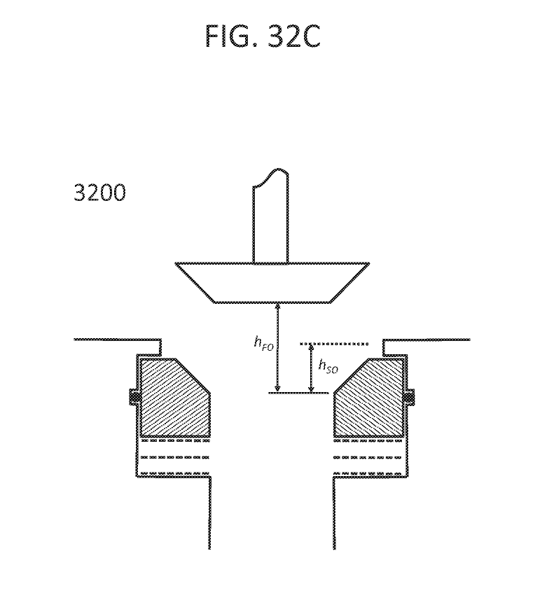

Reference is now made to FIG. 32A, which depicts a state of the valve 3000 in FIG. 30D. (Part numbers in FIGS. 32A-32C correspond in their last two digits to numbers of identical parts in FIG. 30A and FIGS. 30C-30D.) The state depicted in FIG. 32A occurs during an opening cycle that begins with the ring 3206 in fully depressed position (as depicted in FIG. 30D) and continues with upward acceleration of the ring 3206 and disc 3204. Valve 3200 is arranged so that by the time the ring 3206 has reached its neutral position (i.e., can travel no farther upward), and the disc 3204 is at displacement h=0, the disc 3204 has attained its maximum opening velocity, V_{MO}. FIG. 32A depicts the moment at which ring 3206 reaches its neutral position, and the disc 3204 is at displacement h=0 and is traveling at V_{MO}. Up to this moment, the valve 3200 has remained sufficiently closed during the opening cycle (i.e., the disc 3204 and ring 3206 have remained in flush contact). After the disc 3204 ceases to be in contact with the ring 3206, the valve 3200 is no longer sufficiently closed; however, it is not sufficiently open until the displacement h of the disc 3204 is approximately equal to or greater than the sufficiently open distance h_{SO}.

FIG. 32B depicts a moment in the opening stroke subsequent to that depicted in FIG. 32A. The displacement of the disc 3204 is approximately h_{SO} and the velocity of the disc 3204 remains V_{MO}, as in FIG. 32A. At or after the moment depicted in FIG. 32B, deceleration of the disc 3204 begins. By the time the disc 3204 has reached the full-open displacement h_{FO}, the disc 3204 will have been decelerated to an acceptable final opening velocity, V_{OV} (e.g., 0).

FIG. 32C depicts the final position, at the end of an opening stroke, of selected components of valve 3200. The disc is at rest at the full-open displacement h_{FO}.

The advantages of an opening cycle of the illustrative embodiment partially depicted in FIGS. 32A-32C, as compared to the opening cycle of a conventional poppet valve (i.e., a poppet valve constructed according to the prior art), are comparable to those described hereinabove for a closing cycle of valve 3200 as compared to the closing cycle of a conventional poppet valve, as partially depicted in FIG. 30A and FIGS. 30C-30D. That is, accelerating the disc 3200 to its maximum transit speed (i.e., maximum opening velocity V_{MO}) before breaking contact between the disc and ring, and decelerating the disc 3200 after passing the displacement h_{SO} at which the valve becomes sufficiently open, shortens effective valve-opening time as compared to an otherwise similar conventional valve and decreases throttling losses during opening. The plots of FIGS. 31A and 31B, with their time axes reversed, would approximately represent the sequence of events for opening valve 3200 as compared to the sequence of events for opening a conventional valve.

In other embodiments, an opening cycle of valve assembly 3200 begins at a point comparable to the state depicted in FIG. 32A (i.e., with the ring 3206 in its neutral position), except that the disc 3204 is at rest. In such embodiments, restoration of kinetic energy from the closure phase by the spring 3210 to the disc 3204 does not occur. However, the advantages already described for valve 3200 still accrue to such embodiments: i.e., the effective closure time of valve 3200 is shorter, and throttling losses are lower, than for an otherwise similar conventional valve.

In yet other embodiments, disc 3204 and ring 3206 may be moved from the neutral position to the fully depressed position in the early phase of an opening cycle, before commencement of upward acceleration.

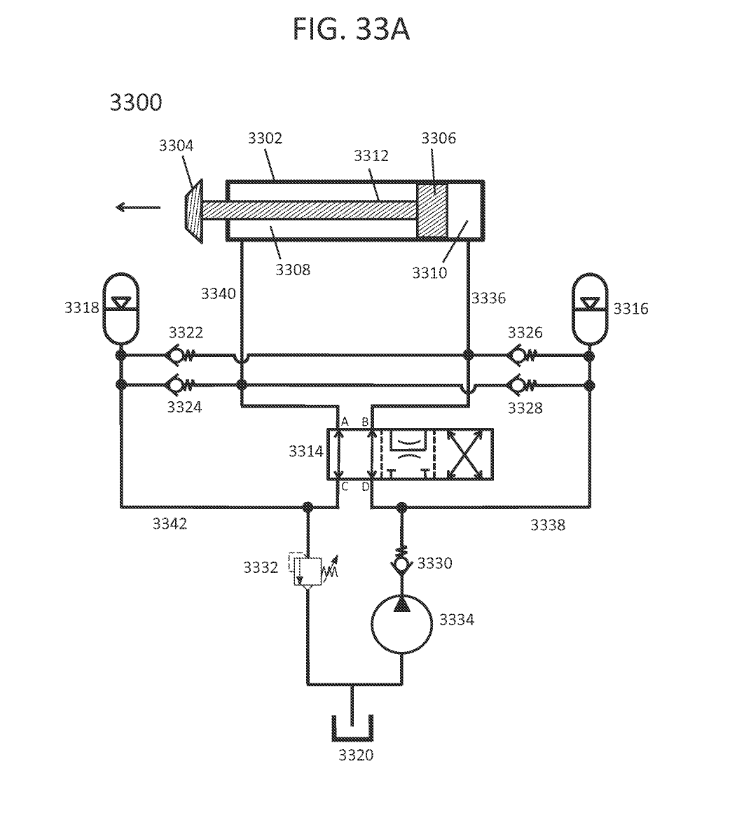

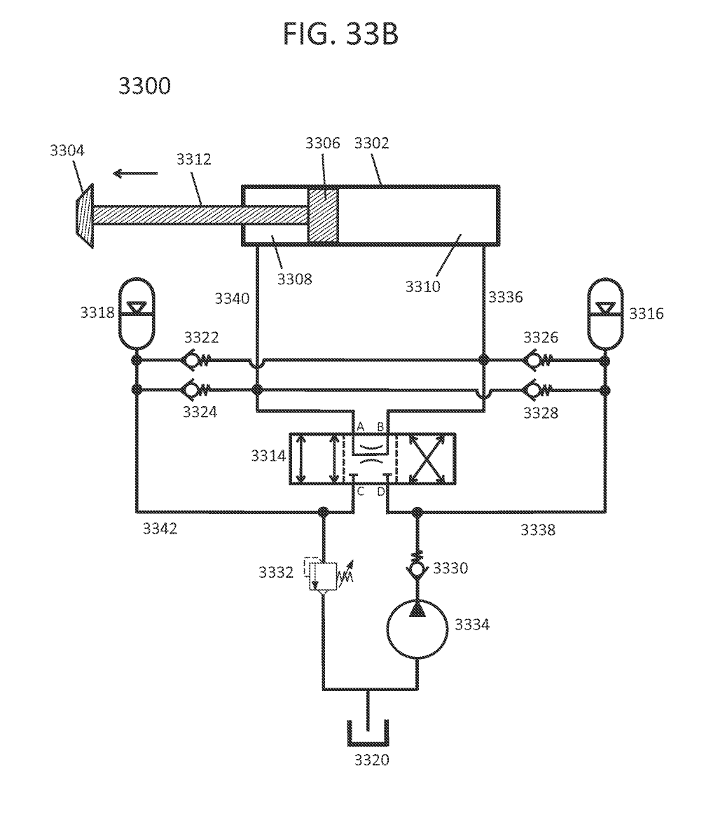

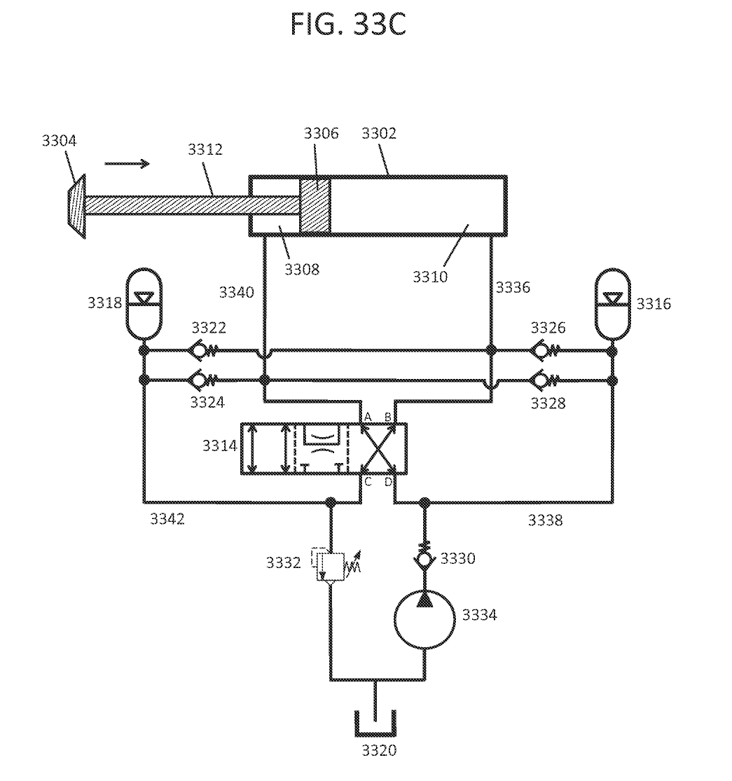

FIGS. 33A-33C refer to embodiments of a high-side valve. It will be apparent to persons reasonably familiar with the mechanics of valves that similar arrangements, realizing similar advantages, may be contrived for low-side valves. Such arrangements are contemplated and within the scope of the invention.

FIG. 33A is a schematic drawing of components of an illustrative hydraulic actuation assembly 3300, in accordance with various embodiments of the present invention. The actuator employs a hydraulic cylinder 3302 to open and close the port (not shown) of a poppet valve (e.g., that depicted in FIG. 20 or FIG. 30A) by moving a disc 3304. As depicted in FIG. 33A, the hydraulic cylinder 3302 contains a piston 3306 that divides the interior of the cylinder 3302 into two chambers 3308, 3310, both of which are typically filled with an approximately incompressible liquid (herein termed “hydraulic fluid” or simply “fluid”). The piston 3306 is connected to a stem 3312 that passes out of the cylinder 3302 and into the body of the poppet valve (not shown) that is actuated by assembly 3300. The disc 3304 is comparable to that depicted in FIG. 20 and other figures discussed above. In an alternative embodiment, stem 3312 may extend out of the cylinder 3302 to maintain substantially equal piston areas in chambers 3308 and 3310.

Assembly 3300 features a three-way directional control valve (DCV) 3314 having two output ports (A, B) and two input ports (C, D). The three possible settings of DCV 3314 are as follows: (1) Closure setting, in which port C is connected to (i.e., placed in fluid communication with) port A and port D is connected to port B, (2) Deceleration setting, in which port A is connected to port B and ports C and D are closed off, and (3) Opening setting, in which port D is connected to port A and port C is connected to port B.

Assembly 3300 also features a high-pressure fluid accumulator 3316, a lower-pressure fluid accumulator 3318, a low-pressure tank or fluid reservoir 3320, check valves 3322, 3324, 3326, 3328, 3330, a pressure relief valve 3332, and a pump 3334 that produces fluid at a relatively high pressure (e.g., 3000 psig). Pipes enable various of the components of assembly 3300 to exchange hydraulic fluid. As shall be made clear below, the arrangements of assembly 3300 enable the storage of energy from the deceleration of the piston 3306, stem 3312, and disc 3304 during opening or closing of the poppet valve (not shown) by assembly 3300, and the application of a portion of that stored energy to the acceleration of the piston 3306, stem 3312, and disc 3304 during the next closing or opening cycle. Such recuperation or regeneration of actuation energy which would typically (e.g., in a conventional valve actuation mechanism) be dissipated increases the overall efficiency of the energy conversion system including actuation assembly 3300.

In the state of operation of assembly 3300 depicted in FIG. 33A, DCV 3314 is in the Closure setting. Hydraulic fluid at a baseline high pressure p₁ from the output of pump 3334 passes through check valve 3330, into port D of DCV 3314, out port B of DCV 3314, through piping 3336, and into chamber 3310 of the cylinder 3302. The fluid in chamber 3310 will exert a force on piston 3306, pushing the piston 3306, stem 3312, and disc 3304 to the left (i.e., toward closure).

Fluid at p₁ may also pass through piping 3338 into the high-pressure accumulator 3316 (e.g., if the pressure in the high-pressure accumulator 3316 is at a pressure p₁₋ slightly lower than p₁). The pressure of the fluid within the high-pressure accumulator typically never falls significantly below p₁, since fluid at pressure p₁ may always pass through check valve 3330 into the high-pressure accumulator 3316. Alternatively, if the pressure of the fluid within the high-pressure accumulator 3316 is at a pressure p₁₊ higher than p₁, some of the fluid within the high-pressure accumulator will also pass through DCV 3314 into chamber 3310 of the cylinder 3302, contributing to the force accelerating the piston 3306, stem 3312, and disc 3304 to the left.

As the piston 3306 moves leftward, fluid in chamber 3308 exits chamber 3308 through piping 3340, passes through ports A and C of the DCV 3314, and is conveyed by piping 3342 to the low-pressure accumulator 3318. If the pressure in the low-pressure accumulator 3318 and/or cylinder chamber 3308 exceeds a predetermined threshold, fluid from the low-pressure accumulator 3318 and/or cylinder chamber 3308 is released to the low-pressure reservoir 3320 (via pressure relief valve 3332) until the pressure in the low-pressure accumulator 3318 and/or cylinder chamber 3308 no longer exceeds the threshold.

FIG. 33B depicts assembly 3300 in a state of operation later in the closure stroke of actuation cylinder 3302. At a certain fraction of the stroke length of actuation cylinder 3302 (e.g., 80% of stroke length), the DCV 3314 is moved to the Deceleration position, in which chamber 3310 is placed in fluid communication with chamber 3308 through piping 3336, DCV 3314, and piping 3340. This state of operation is depicted in FIG. 33B. In this state of operation, fluid from chamber 3310 (initially approximately at pressure p₁) tends to move through the restricted passage offered by piping 3336, DCV 3314, and piping 3340 to chamber 3308. The pressure in chamber 3310 thus tends to fall and the pressure in chamber 3308 tends to rise. Moreover, the momentum of the piston 3306, stem 3312, and disc 3304 (moving leftward at the maximum closure velocity V_{MC} of the valve) tends to exert force on the fluid in chamber 3308, raising the pressure of the fluid in chamber 3308 to some peak value. The peak pressure in chamber 3310, chamber 3308, and piping connected thereto will depend in part on the total mass of the piston 3306, stem 3312, and disc 3304, as well as V_{MC}. Typically, the peak pressure in peak pressure in chamber 3310, chamber 3308, and piping connected thereto, including pipe 3340, is a pressure p₁₊ higher than pressure p₁. When fluid in pipe 3340 is at p₁₊ and the pressure in the high-pressure accumulator 3316 is less than p₁₊, check valve 3328 permits the passage of some of the fluid in pipe 3340 into the high-pressure accumulator 3316, raising the pressure of the fluid within the high-pressure accumulator 3316. Thus, in effect, placing DCV 3314 in Deceleration position causes some of the kinetic energy imparted to the piston 3306, stem 3312, and disc 3304 during valve closure to be recovered and stored as pressure potential energy in the high-pressure accumulator 3316.

Assembly 3300 may be operated (e.g., by placing the DCV 3314 in Deceleration position at an appropriate point in a closing stroke of the actuation cylinder 3302) so that by the end of the stroke, the piston 3306, stem 3312, and disc 3304 are moving at an acceptably low final closing velocity V_{CV}.

Similarly, to initiate an opening stroke of the actuation cylinder 3302, the DCV 3314 is placed in Opening position. FIG. 33C depicts assembly 3300 in a state of operation early in an opening stroke of actuation cylinder 3302. In the state of operation of assembly 3300 depicted in FIG. 33C, DCV 3314 is in the Opening setting. Hydraulic fluid at a baseline high pressure p₁ from the output of pump 3334 passes through check valve 3330, into port D of DCV 3314, out port A of DCV 3314, through piping 3340, and into chamber 3308 of the cylinder 3302. The fluid in chamber 3308 exerts a force on piston 3306, pushing the piston 3306, stem 3312, and disc 3304 to the right (i.e., opening the valve).

As during a closure stroke, fluid at p₁ may also pass through piping 3338 into the high-pressure accumulator 3316. Alternatively, if the pressure of the fluid within the high-pressure accumulator 3316 is at a pressure p₁₊ higher than p₁ (e.g., as a result of the storage in high-pressure accumulator 3316 of pressure potential energy collected during the deceleration phase of a closure stroke), some of the fluid within the high-pressure accumulator 3316 will also pass into chamber 3308 of the cylinder 3302 when the DCV 3314 is first placed in Opening position, contributing to the force accelerating the piston 3306, stem 3312, and disc 3304 to the right.

As the piston 3306 moves rightward, fluid in chamber 3310 exits chamber 3310 through piping 3336, passes through ports B and C of the DCV 3314, and is conveyed by piping 3342 to the low-pressure accumulator 3318.

At a certain fraction of the stroke length of actuation cylinder 3302 (e.g., 80% of stroke length), the DCV 3314 is moved to the Deceleration position, in which chamber 3310 is placed in fluid communication with chamber 3308 through piping 3336, DCV 3314, and piping 3340. Deceleration of the piston 3306, stem 3312, and disc 3304 occurs as described above for deceleration during a closing stroke, with the roles of chamber 3310 and chamber 3308 reversed (i.e., during open-stroke deceleration, pressure drops in chamber 3308 and rises in chamber 3310). Similarly to deceleration during a closing stroke, deceleration during an opening stroke causes some of the kinetic energy imparted to the piston 3306, stem 3312, and disc 3304 during valve opening to be recovered and stored as pressure potential energy in the high-pressure accumulator 3316.

Thus, the illustrative embodiment depicted in FIGS. 33A-33C permits the storage and re-use of a portion of the energy required to operate the actuation assembly 3300 during valve opening or closure. Consequently, an energy conversion system featuring poppet-valve actuators similar to assembly 3300 may operate at higher overall efficiency than an energy conversion system featuring conventional poppet-valve actuators.

FIGS. 33A-33C refer to embodiments of a high-side valve. It will be apparent to persons reasonably familiar with the science of hydraulics that similar arrangements, realizing similar advantages, can be contrived for low-side valves. Such arrangements are contemplated and within the scope of the invention. Moreover, the horizontal orientation of the actuation cylinder 3302 in FIGS. 33A-33C is illustrative only; other orientations (e.g., vertical) are contemplated and within the scope of the invention.

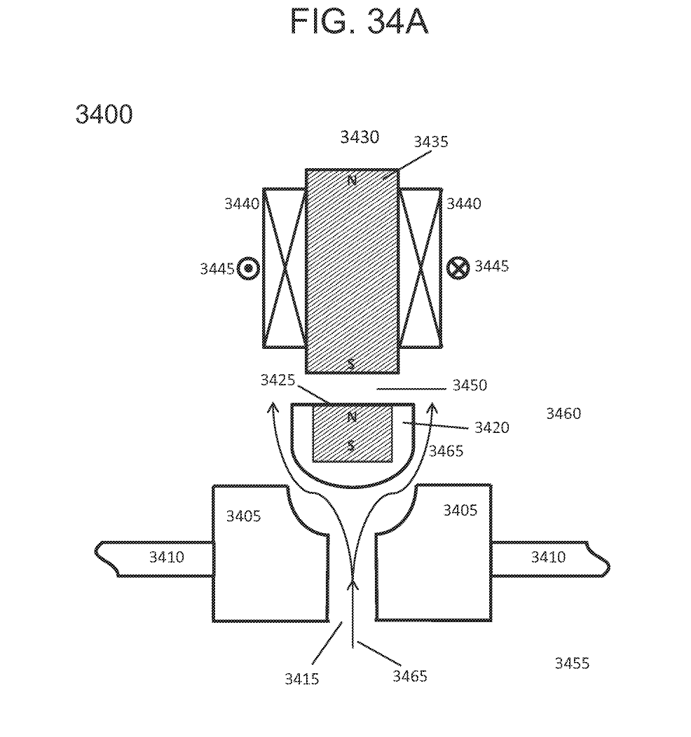

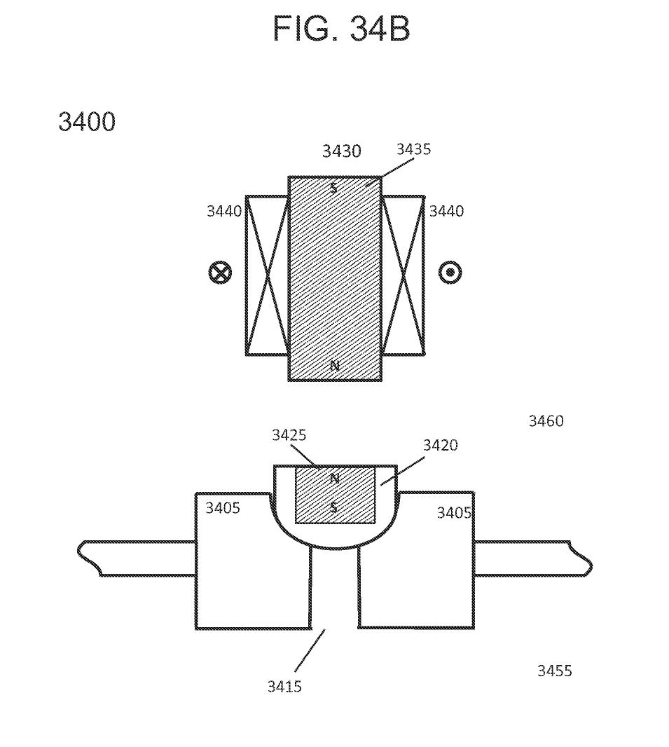

FIG. 34A is a schematic cross-sectional drawing of major components of an illustrative electromagnetic valve 3400 in accordance with embodiments of the present invention. For clarity, components of the valve 3400, including an outside port and the walls of the valve body, are not depicted in FIG. 34A.

Valve 3400 may be actuated by differential pressure and by electromagnetic force. In other embodiments, the valve 3400 may be actuated by differential pressure, electromagnetic forces, and mechanical forces in various states of operation. The valve 3400 may include a mechanical or pneumatic spring (not shown) to bias the valve towards closing, cushion opening forces, and/or replace or supplement the closing actuation mechanism. The valve 3400 shown in FIG. 34A is a high-side valve, as defined above, and in various embodiments may be substituted for the poppet-style high-side valves depicted in previously described figures, thereby realizing various additional advantages.

Valve 3400 features a seat 3405 that may pass through or be integral with the end-cap 3410 of a cylinder assembly. The opening 3415 in the seat 3405 constitutes the gated port 3415 of the valve 3400. Valve 3400 also includes a valve member 3420, a permanent magnet 3425 attached to or integral with the valve member 3420, and an actuation mechanism 3430. The actuation mechanism 3430 may include or consist essentially of a ferromagnetic core 3435 and a winding 3440 through which an electric current may be made to flow. In FIG. 34A, the seat 3405 and winding 3440 are depicted as aligned tubular or ring-shaped structures viewed in cross-section. As depicted in FIG. 34A, current is flowing around the winding 3440 clockwise as viewed from the gated port 3415. In the portion of the winding 3440 depicted in cross-section to the left of the ferromagnetic core 3435, current is moving directly out of the page, while in the portion of the winding 3440 depicted in cross-section to the right of the ferromagnetic core 3435, current is moving directly into of the page, as indicated by conventional symbols 3445. This direction of flow is herein termed the “clockwise” direction. When current flows clockwise in the winding 3440, the ferromagnetic core 3435 is magnetized so that the end of the core 3435 distal to the gated port 3415 is a north magnetic pole and the end of the core 3435 proximal to the gated port 3415 is a south magnetic pole. The permanent magnet 3425 is fixed so that its north pole is distal to the gated port 3415 and its south pole is proximal to the gated port 3415.

In FIG. 34A, the valve 3400 is depicted in a partly open state. The sense of magnetization of the core 3435 causes a south magnetic pole to face the north pole of the permanent magnet 3425 across a gap 3450. When valve 3400 is in a fully open state, the gap 3450 is minimal or absent (e.g., the permanent magnet 3425 and core 3435 may be in contact). An attractive magnetic force proportional to the inverse square of the effective distance x between the north pole of the permanent magnet 3425 and the south pole of the core 3435, where x is approximately proportional to the width of the gap 3450 plus a nonzero constant, acts on both the actuation mechanism 3430 and the valve member 3420. The actuation mechanism 3430 is connected to the body (not shown) of the valve 3400 and is not free to move towards or away from the gated port 3415, whereas the valve member 3420 is free to move towards or away from the gated port 3415. The magnetic upward force (magnetic opening force) Fₒₘ tends to cause the valve member 3420 to move toward the actuation mechanism 3430. The magnetic opening force Fₒₘ may vary as a function of time, depending on the width of the gap 3450 and the direction and magnitude of the current in the winding 3440. In FIG. 34A, the core 3435 is depicted as a solid cylinder of ferromagnetic material; in other embodiments, the core 3435 has other shapes, and may be constructed so that its reluctance may be altered by an operator or control system, in which case the reluctance of the core 3435 may vary with time. Where the reluctance of the core 3435 may vary with time, the magnetic force may depend in a time-varying way on the reluctance of the core 3435 as well as on the width of gap 3450 and the current in the winding 3440.

The direction and magnitude of the current in the winding 3440 may be deliberately varied during operation of the valve 3400 to achieve various operational advantages. For example, when the valve member 3420 is in contact with the seat 3405 (i.e., when the valve 3400 is closed), and opening of the valve 3400 is initiated, a relatively large current in the winding 3440 may be employed to accelerate the valve member 3420 away from the seat 3405. This current may be decreased (or even removed entirely) as the valve member 3420 moves toward the actuation mechanism 3430.

Differential pressure in the cylinder chamber 3455 and flow chamber 3460 may, in some states of operation, provide an additional hydraulic opening force Fₒₕ that acts in the same sense as the magnetic opening force Fₒₘ. For example, the pressure in the cylinder chamber 3455 may be greater than the pressure in the flow chamber 3460. In this case, after opening of the valve 3400 has been initiated and the valve member 3420 is no longer in contact with the seat 3405, fluid flow 3465 will generally occur through the gated port 3415. The fluid flow 3465 will tend to continue to exert a hydraulic opening force Fₒₕ on the valve member 3420 throughout the opening process, though Fₒₕ may diminish as the valve member 3420 moves away from the gated port 3415. The hydraulic opening force Fₒₕ may suffice to initiate, assist, and/or complete the opening of valve 3400.

As the valve member 3420 moves toward the actuation mechanism 3430, the current in the winding 3440 (and thus the magnetic opening force Fₒₘ) may be varied in such a manner as to increase, maintain, decrease, or reverse the acceleration of the valve member 3420 toward the actuation mechanism 3430. Through suitable variation of the winding current and thus of Fₒₘ, rapid opening of the valve 3400 and reduction of collision forces may be achieved with minimal expenditure of energy.

In another state of operation, not depicted in FIG. 34A, the direction of the current in the winding 3440 is counterclockwise. In this state of operation, the north and south poles of the ferromagnetic element 3435 will be reversed, and a north magnetic pole will be presented by the actuation mechanism 3430 to the north magnetic pole of the permanent magnet 3425. The proximity of the two north magnetic poles will cause a repulsive force (magnetic closing force F_{cm}) to act upon the valve member 3420. Depending on the differential pressure in the flow chamber 3460 and the cylinder chamber 3455, a hydraulic force may act on the valve member 3420 either in concordance with or in opposition to the magnetic closing force F_{cm}. The valve member 3420 will accelerate in the direction of the net or sum force upon it. Thus, regardless of differential pressure in the flow chamber 3460 and cylinder chamber 3455, the valve member 3420 will move toward the gated port 3415 if a sufficiently large magnetic closing force F_{cm} is exerted upon the valve member 3420 by the actuation mechanism 3430. In short, the valve 3400 may be closed, regardless of differential pressure across the valve 3400, by passage of a sufficiently large counterclockwise current through the winding 3440.

During closing of valve 3400, as the valve member 3420 moves away from the actuation mechanism 3430, the current in the winding 3440 (and thus the magnetic closing force F_{cm}) may be varied in such a manner as to increase, maintain, decrease, or reverse the acceleration of the valve member 3420 away from the actuation mechanism 3430. Through suitable variation of the current and thus of F_{cm}, rapid closing of the valve 3400 and reduction of collision forces may be achieved with minimal expenditure of energy. Additionally, a ferromagnetic material (e.g. flux intensifier, not shown) may be positioned in the return flux path (at least in part above or surrounding actuation mechanism 3430) to maximize or otherwise optimize the flux density at the valve seat.

FIG. 34B is a schematic cross-sectional drawing of the valve of FIG. 34A in a different state of operation. As depicted in FIG. 34B, the valve 3400 is closed, i.e., the valve member 3420 is in contact with the seat 3405, occluding the gated port 3415. Differential pressure in the flow chamber 3460 and cylinder chamber 3455 may provide a force that either tends to hold the valve member 3420 in contact with the seat 3405 (i.e., to the hold the valve 3400 closed) or that tends to move the valve member 3420 away from the seat 3405 (i.e., to open the valve 3400).

In FIG. 34B, the current in the winding 3440 is depicted as moving in a counterclockwise direction. Consequently, the ferromagnetic element 3430 presents a north magnetic pole to the north magnetic pole of the permanent magnet 3425, and a magnetic closing force F_{cm} tending to hold the valve 3400 closed will act upon the valve member 3420. If the differential pressure in the flow chamber 3460 and cylinder chamber 3455 is such as to hold the valve 3400 closed, the valve 3400 will remain closed even if the current in the winding 3440 is zero; if the differential pressure in the flow chamber 3460 and cylinder chamber 3455 is such as to open the valve 3400, the current in the winding 3435 may be set to a value that produces a countervailing magnetic closing force F_{cm} sufficient to keep the valve closed (i.e., an F_{cm} larger than the hydraulic opening force exerted by the differential pressure).

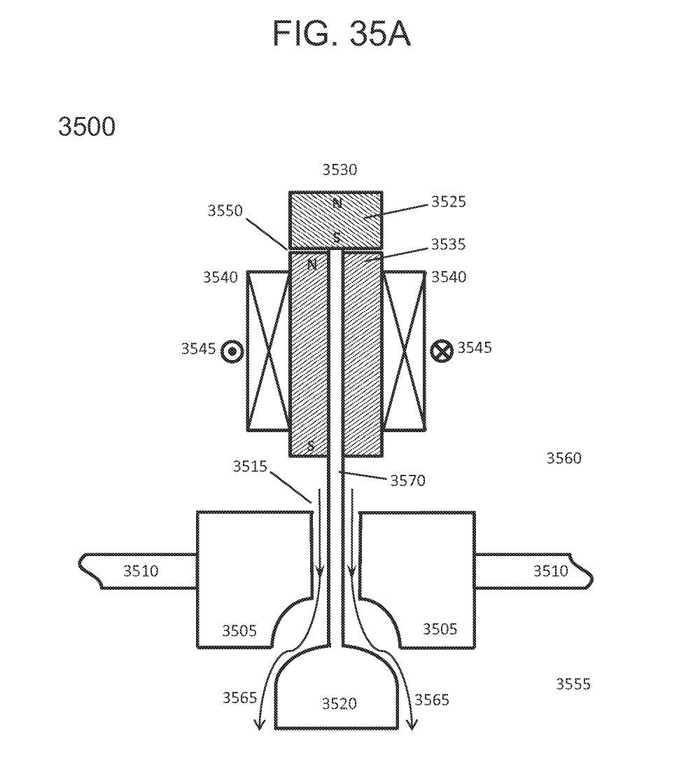

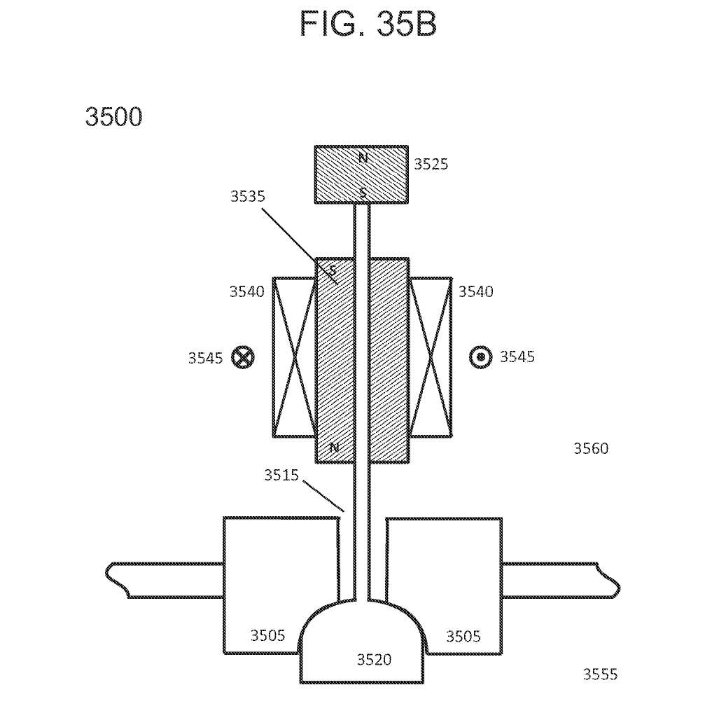

FIG. 35A is a schematic cross-sectional drawing of major components of an illustrative electromagnetic valve 3500 in accordance with embodiments of the present invention. For clarity, components of the valve 3500, including an outside port and the walls of the flow chamber, are not depicted in FIG. 35A. Valve 3500 is actuated by differential pressure and by electromagnetic force. In other embodiments, the valve 3500 may be actuated by differential pressure, electromagnetic forces, and/or mechanical forces in various states of operation. The valve 3500 may include a mechanical or pneumatic spring (not shown) to bias the valve towards closing, cushion opening forces, and/or replace or supplement the closing actuation mechanism. The valve 3500 shown in FIG. 35A is a low-side valve, as defined above, and in various embodiments may be substituted for the poppet-style low-side valves depicted in previously described figures, thereby realizing additional advantages.

Valve 3500 features a seat 3505 that may pass through or be integral with the end cap 3510 of a cylinder assembly (not otherwise shown). The opening 3515 in the seat constitutes the gated port 3515 of the valve 3500. Valve 3500 also includes a valve member 3520, a rod 3570 attached to the valve member 3520, a permanent magnet 3525 attached to or integral with the rod 3570, and an actuation mechanism 3530. The actuation mechanism 3530 may include or consist essentially of a ferromagnetic core 3535 and a winding 3540 through which an electric current may be made to flow. In FIG. 35A, the seat 3505, core 3535, and winding 3540 are depicted as aligned, tubular or ring-shaped structures viewed in cross-section. As depicted in FIG. 35A, the current in the winding 3535 is moving in a clockwise direction as defined above. When current flows clockwise in the winding 3540, the ferromagnetic core 3535 is magnetized so that the end of the core 3535 distal to the gated port 3515 is a north magnetic pole and the end of the core 3535 proximal to the gated port 3515 is a south magnetic pole. The permanent magnet 3525 is fixed so that its south pole is proximal to the gated port 3515 and its north pole is distal to the gated port 3515.

In FIG. 35A, the valve 3500 is depicted in an fully open state. The magnetization of the core 3535 causes a north magnetic pole to face the south pole of the permanent magnet 3525 across a gap 3550. When valve 3500 is in a fully open state, gap 3550 is minimal or absent (e.g., the permanent magnet 3525 and core 3535 may be in contact). An attractive magnetic force proportional to the inverse square of the effective distance x between the south pole of the permanent magnet 3525 and the north pole of the core 3535, where x is approximately proportional to the width of the gap 3550 plus a nonzero constant, acts on both the actuation mechanism 3530 and the permanent magnet 3525. The magnetic force acting on the permanent magnet 3525 is communicated to the rod 3570 and valve member 3520. The actuation mechanism 3530 is connected to the body (not shown) of the valve 3500 and is not free to move towards or away from the gated port 3515, whereas the permanent magnet 3525, rod 3570, and valve member 3520 are free to move towards or away from the gated port 3515. The magnetic downward force (magnetic opening force) Fₒₘ acting on the permanent magnet 3525 tends to cause the valve member 3520 to move downward (i.e., away from the gated port 3515). The magnetic opening force Fₒₘ may vary as a function of time, depending on the width of the gap 3550 and the direction and magnitude of the current in the winding 3540. In FIG. 35A, the core 3535 is depicted as a tube of solid ferromagnetic material; in other embodiments, the core 3535 is constructed so that its reluctance may be altered by an operator or control system, in which case the reluctance of the core 3535 may vary with time. If the reluctance of the core 3535 may vary with time, the magnetic force may depend in a time-varying way on the reluctance of the core 3535 as well as on the width of the gap 3550 and the current in the winding 3540.

The direction and magnitude of the current in the winding 3540 may be deliberately varied during operation of the valve 3500 to achieve various operational advantages. For example, when the valve member 3520 is in contact with the seat 3505 (i.e., when the valve 3500 is closed), and opening of the valve 3500 is initiated, a relatively large current in the winding 3540 may be employed to accelerate the valve member 3520 away from the seat 3505, speeding opening of the valve 3500. This current may be decreased as the permanent magnet 3525 moves toward the actuation mechanism 3530.

Differential pressure in the cylinder chamber 3555 and flow chamber 3560 may, in some states of operation, provide an additional hydraulic opening force Fₒₕ that acts in the same sense as the magnetic opening force Fₒₘ. For example, the pressure in the cylinder chamber 3555 may be less than the pressure in the flow chamber 3560. In this case, after opening of the valve 3500 has been initiated and the valve member 3520 is no longer in complete contact with the seat 3505, fluid flow 3565 will generally occur through the gated port 3515. The fluid flow 3565 will tend to continue to exert a hydraulic opening (downward) force Fₒₕ on the valve member 3520 throughout the opening process. Fₒₕ may diminish as the valve member 3520 moves away from the gated port 3515. The hydraulic opening force Fₒₕ may suffice to initiate, assist, and/or complete the opening of valve 3500.

During opening of valve 3500, as the permanent magnet 3525 moves downward (toward the actuation mechanism 3530), the current in the winding 3540 (and thus the magnetic opening force Fₒₘ) may be varied in such a manner as to increase, maintain, decrease, or reverse the acceleration of the valve member 3520 away from the seat 3505. Through suitable variation of the current and thus of Fₒₘ, rapid opening of the valve 3500 and reduction of collision forces may be achieved with minimal expenditure of energy.

In another state of operation, not depicted in FIG. 35A, the direction of the current in the winding 3540 may be made counterclockwise. In this state of operation, the north and south poles of the ferromagnetic element 3535 will be reversed, and a south magnetic pole will be presented by the actuation mechanism 3530 to the south magnetic pole of the permanent magnet 3525. The proximity of the two south magnetic poles will cause an upward (closing) force F_{cm} to act upon the permanent magnet 3525, rod 3570, and valve member 3520. The valve member 3520 will thus tend to move upward, i.e., in the direction of the gated port 3515. Depending on the differential pressure in the flow chamber 3560 and the cylinder chamber 3555, a hydraulic force may act in concordance with, or in opposition to, the magnetic closing force F_{cm}. The valve member 3520 will accelerate in the direction of the net or sum force upon it. Thus, regardless of differential pressure in the flow chamber 3560 and cylinder chamber 3555, the valve member 3520 will tend to move toward the gated port 3515 if a sufficiently large magnetic closing force F_{cm} is exerted upon the valve member 3520 by the actuation mechanism 3530. In short, the valve 3500 may be closed, regardless of differential pressure across the valve 3500, by passage of a sufficiently large counterclockwise current through the winding 3540.

During closing of valve 3500, as the valve member 3520 moves toward the actuation mechanism 3530, the current in the winding 3540 (and thus the magnetic closing force F_{cm}) may be varied in such a manner as to increase, maintain, decrease, or reverse the acceleration of the valve member 3520 toward the actuation mechanism 3530. Through suitable variation of the current and thus of F_{cm}, rapid closing of the valve 3500 and reduction of collision forces may be achieved with minimal expenditure of energy. Additionally, a ferromagnetic material (e.g., a flux intensifier, not shown) may be positioned in the return flux path (at least in part below or surrounding actuation mechanism 3530) to maximize or otherwise optimize the flux density at the valve seat.

FIG. 35B is a schematic cross-sectional drawing of the valve of FIG. 35A in a different state of operation. As depicted in FIG. 35B, the valve 3500 is closed, i.e., the valve member 3520 is in contact with the seat 3505, occluding the gated port 3515. Differential pressure in the flow chamber 3560 and cylinder chamber 3555 may provide a force that either tends to hold the valve member 3520 in contact with the seat 3505 (i.e., to the hold the valve 3500 closed) or that tends to move the valve member 3520 away from the seat 3505 (i.e., to open the valve 3500).

In FIG. 35B, the current in the winding 3540 is depicted as moving in a counterclockwise direction. Consequently, the ferromagnetic element 3535 presents a south magnetic pole to the south magnetic pole of the permanent magnet 3525, and a magnetic force tending to hold the valve 3500 closed will be produced. If the differential pressure in the flow chamber 3560 and cylinder chamber 3555 is such as to hold the valve 3500 closed, the valve 3500 will remain closed even if the current in the winding 3540 is zero; if the differential pressure in the flow chamber 3560 and cylinder chamber 3555 is such as to open the valve 3500, the current in the winding 3540 may be set to a value that produces a magnetic closing force F_{cm}, sufficient to keep the valve closed (i.e., F_{cm} larger than the hydraulic opening force exerted by the differential pressure).

Generally, the systems described herein may be operated in both an expansion mode and in the reverse compression mode as part of a full-cycle energy storage system with high efficiency. For example, the systems may be operated as both compressor and expander, storing electricity in the form of the potential energy of compressed gas and producing electricity from the potential energy of compressed gas. Alternatively, the systems may be operated independently as compressors or expanders.

Embodiments of the invention may, during operation, convert energy stored in the form of compressed gas and/or recovered from the expansion of compressed gas into gravitational potential energy, e.g., of a raised mass, as described in U.S. patent application Ser. No. 13/221,563, filed Aug. 30, 2011, the entire disclosure of which is incorporated herein by reference.

The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. An energy storage and recovery system comprising:
a cylinder assembly (i) for, therewithin, at least one of compression of gas to store energy or expansion of gas to recover energy and (ii) having an interior compartment;
a valve for at least one of admitting fluid into the interior compartment or exhausting fluid from the interior compartment through a gated port, the valve comprising a valve member for occluding the gated port; and
for actuating the valve, an actuation mechanism comprising (i) an actuation cylinder having a lateral surface and two opposing end surfaces, (ii) a piston disposed within and dividing the actuation cylinder into two chambers, the valve being configured for actuation by a difference in fluid pressure between the two chambers, and (iii) an occludable orifice defined by the lateral surface and configured to be at least partially occluded by the piston during movement of the piston within the actuation cylinder.

2. The system of claim 1, wherein the occludable orifice is configured to be completely occluded by the piston when the piston is disposed proximate an end surface of the actuation cylinder.

3. The system of claim 1, wherein a portion of the occludable orifice is configured to not be occluded by the piston when the piston is disposed proximate an end surface of the actuation cylinder.

4. The system of claim 1, wherein a lateral dimension of at least a portion of the occludable orifice varies as a function of distance from one of the end surfaces of the actuation cylinder.

5. The system of claim 1, wherein (i) a lateral dimension of a first portion of the occludable orifice does not vary as a function of distance from one of the end surfaces of the actuation cylinder and (ii) a lateral dimension of a second portion of the occludable orifice varies as a function of distance from one of the end surfaces of the actuation cylinder.

6. The system of claim 1, wherein a lateral boundary of at least a portion of the occludable orifice has a shape defined by a function y(x)=C(Vₘₐₓ²−2Ax)^{1/2}, where C is a constant, Vₘₐₓ is a velocity of the piston in the actuation cylinder when the occludable orifice is not occluded, and A is a magnitude of deceleration of the piston in the actuation cylinder when the occludable orifice is partially occluded.

7. The system of claim 1, wherein the actuation mechanism comprises a fixed orifice defined by one of the end surfaces of the actuation cylinder

8. The system of claim 7, further comprising a high-pressure fluid source selectively connectable to both the occludable orifice and the fixed orifice.

9. The system of claim 8, further comprising, disposed within a connection between the high-pressure fluid source and the fixed orifice, a check valve configured to enable substantially unrestricted flow of fluid to the fixed orifice when the occludable orifice is at least partially occluded by the piston.

10. The system of claim 8, further comprising a low-pressure fluid reservoir selectively connectable to both the occludable orifice and the fixed orifice.

11. The system of claim 10, further comprising a valve having different settings for connecting the occludable orifice and the fixed orifice to (i) the high-pressure fluid source, (ii) the low-pressure fluid reservoir, or (iii) a chamber of the actuation cylinder opposite a chamber of the actuation cylinder in which the occludable orifice and fixed orifice are defined.

12. The system of claim 7, wherein (i) the occludable orifice and fixed orifice are defined in one of the chambers of the actuation cylinder, and (ii) in the other chamber of the actuation cylinder, an end surface defines a second fixed orifice, and the lateral surface of the actuation cylinder defines a second occludable orifice configured to be at least partially occluded by the piston during movement of the piston within the actuation cylinder.

13. The system of claim 1, further comprising a stem to which the valve member and the piston are mechanically connected.

14. The system of claim 1, wherein the cylinder assembly is configured to compress gas from an initial pressure to a final pressure, and further comprising a control system configured to:
pre-expand gas in the cylinder assembly to approximately the initial pressure;
following the pre-expansion, admit gas at the initial pressure into the cylinder assembly, the pre-expansion reducing coupling loss during the admission of gas;
compress the gas in the cylinder assembly to the final pressure;
complete a compression cycle by exhausting only a portion of the compressed gas out of the cylinder assembly; and
repeat the foregoing steps at least once, thereby performing at least one additional compression cycle,
wherein at least one of the gas admission or the gas exhaustion occurs through the gated port of the valve.

15. The system of claim 1, wherein the cylinder assembly is configured to expand gas from an initial pressure to a final pressure, and further comprising a control system configured to:
pre-compress gas in the cylinder assembly to approximately the initial pressure;
following the pre-compression, admit compressed gas at the initial pressure into the cylinder assembly, the pre-compression reducing coupling loss during the admission of compressed gas;
expand the gas in the cylinder assembly to the final pressure;
complete an expansion cycle by exhausting only a portion of the expanded gas out of the cylinder assembly; and
repeat the foregoing steps at least once, thereby performing at least one additional expansion cycle,
wherein at least one of the gas admission or the gas exhaustion occurs through the gated port of the valve.

16. The system of claim 1, further comprising:
a high-side component, selectively fluidly connected to the cylinder assembly, for at least one of (i) supplying gas to the cylinder assembly for expansion therein or (ii) accepting gas from the cylinder assembly after compression therein;
a low-side component, selectively fluidly connected to the cylinder assembly, for at least one of (i) supplying gas to the cylinder assembly for compression therein or (ii) accepting gas from the cylinder assembly after expansion therein; and
a control system for operating the cylinder assembly to perform at least one of (i) a pre-compression of gas therewithin prior to admission therein of gas for expansion, thereby reducing coupling loss between the cylinder assembly and the high-side component, or (ii) a pre-expansion of gas therewithin prior to admission therein of gas for compression, thereby reducing coupling loss between the cylinder assembly and the low-side component.

17. The system of claim 16, further comprising a sensor for sensing at least one of a temperature, a pressure, or a position of a boundary mechanism within the cylinder assembly to generate control information, the control system being responsive to the control information.

18. The system of claim 17, wherein the control system is configured to operate the cylinder assembly, during at least one of (i) pre-compression of gas therewithin or (ii) expansion of gas therewithin, based at least in part on control information generated during at least one of (i) a previous gas expansion within the cylinder assembly or (ii) a previous pre-compression of gas within the cylinder assembly.

19. The system of claim 17, wherein the control system is configured to operate the cylinder assembly, during at least one of (i) pre-expansion of gas therewithin or (ii) compression of gas therewithin, based at least in part on control information generated during at least one of (i) a previous gas compression within the cylinder assembly or (ii) a previous pre-expansion of gas within the cylinder assembly.

20. The system of claim 16, wherein the high-side component comprises a compressed-gas storage reservoir.

21. The system of claim 16, wherein the high-side component comprises a second cylinder assembly for at least one of compressing gas or expanding gas within a pressure range higher than a pressure range of operation of the cylinder assembly.

22. The system of claim 16, further comprising a second cylinder assembly for at least one of compressing gas or expanding gas within a pressure range higher than a pressure range of operation of the cylinder assembly, wherein the high-side component comprises a mid-pressure vessel for containing gas at a pressure within both of or between pressure ranges of operation of the cylinder assembly and the second cylinder assembly.

23. The system of claim 16, wherein the low-side component comprises a vent to atmosphere.

24. The system of claim 16, wherein the low-side component comprises a second cylinder assembly for at least one of compressing gas or expanding gas within a pressure range lower than a pressure range of operation of the cylinder assembly.

25. The system of claim 16, further comprising a second cylinder assembly for at least one of compressing gas or expanding gas within a pressure range lower than a pressure range of operation of the cylinder assembly, wherein the low-side component comprises a mid-pressure vessel for containing gas at a pressure within both of or between pressure ranges of operation of the cylinder assembly and the second cylinder assembly.
